(19) United States
(12) Patent Application Publication
(10) Pub. No.: US 2022/0358240 A1
(43) Pub. Date: Nov. 10, 2022

(54) ADAPTIVE DATA PRIVACY PLATFORM

(71) Applicant: Sentinel, LLC, Bellevue, WA (US)

(72) Inventors: Ryan Neal, Bellevue, WA (US); Aaron Weller, Redmond, WA (US); Emily Leach, Rollinsford, NH (US); Kevin Michael Donahue, Seattle, WA (US); Jonathan A. Sterling, Seattle, WA (US); Parinati Sarnot, Kirkland, WA (US); Claudiu Barbura, Bellevue, WA (US)

(21) Appl. No.: 17/737,286

(22) Filed: May 5, 2022

Related U.S. Application Data
(60) Provisional application No. 63/185,947, filed on May 7, 2021.

(51) Int. Cl. G06F 21/62; H04L 9/40; H04L 41/14

(52) U.S. Cl. CPC G06F 21/6245; H04L 63/205; H04L 41/145

(57) ABSTRACT

The present disclosure describes an adaptive data privacy platform that facilitates compliance with privacy laws and regulations, and compliance with organizational requirements within an organizational context. Other embodiments and implementations may be described and/or claimed.

### RELATED APPLICATIONS

The present application claims priority to U.S. Provisional App. No. 63/185,947, filed on May 7, 2021, the contents of which are hereby incorporated by reference in their entirety.

### FIELD

The present disclosure generally relates to the fields of digital data processing, information security, data security, data protection, privacy industry scope, and in particular, to adaptive privacy compliance platforms for enabling Governance, Risk and Compliance (“GRC”) for data privacy.

### BACKGROUND

Information privacy (also referred to as “data privacy”) is the relationship between the collection and dissemination of data, technology, the public expectation of privacy, and the legal and political issues surrounding them. Maintaining data privacy can be challenging since it attempts to use data while protecting an individual's privacy preferences and personal information (PI).

Many jurisdictions include legislation and/or regulations, and sometimes regulator bodies, to address issues related to data privacy and data protection. These regulations attempt to give individuals control over their personal data and to simplify the regulatory environment for national and international business within the subject jurisdiction. These legislative/regulatory frameworks can be somewhat convoluted, vague and difficult to understand by laymen. Consequently, it is often difficult for organizations (orgs) to determine whether specific regulations are applicable to their organizational practices, and to determine how to comply with such regulations. Furthermore, these legislative/regulatory frameworks are often designed to cover the broadest number of use cases. Consequently, there is almost no guidance for a particular org for how the framework may or may not apply to their specific org use case.

### BRIEF DESCRIPTION OF THE DRAWINGS

Embodiments will be readily understood by the following detailed description in conjunction with the accompanying drawings. To facilitate this description, like reference numerals designate like structural elements. Embodiments are illustrated by way of example, and not by way of limitation, in the figures of the accompanying drawings.

FIG. 1 illustrates an example system architecture including an adaptive data privacy platform (ADPP).

FIG. 2 illustrates an example privacy framework and its components.

FIG. 3 illustrates an example ADPP reporting model.

FIG. 4 illustrates an example of future scenario predictions.

FIGS. 5, 6, 7, 8, 9, 10, 11, 12, 13, 14, 15, 16, 17, 18, 19 show example user interfaces of an ADPP client application.

FIG. 20 illustrates an example computing system suitable for practicing various aspects of the present disclosure.

FIG. 21 depicts an example neural network (NN).

### DETAILED DESCRIPTION

The present disclosure provides an adaptive data privacy platform (ADPP) and describes technologies for compliance with various privacy regulations, policies, requirements, and the like. In particular, a data privacy model is provided, which takes multiple categorized privacy frameworks (PFs) and converts them into organizational (org) requirements that address various data privacy projects and programs across an org. This is accomplished, in part, through a combination of metadata tagging schemas and filtering based on a conceptual model of an org. The ADPP helps orgs build privacy confidence by building a culture of privacy throughout the org. The ADPP helps orgs accelerate their privacy programs while at the same time preserving value from any existing investments in privacy technology that these orgs may have made.

Today, many orgs collect various amounts and types of data, and use this data a lot of different ways. Regulations and laws are very dynamic, but not as dynamic as customer or subscriber expectations. Also, many orgs remain focused on tactical, compliance focused, technology solutions. However, there is a gap in technological solutions that help orgs decide on the best privacy protection strategy for their particular needs and/or goals.

Many orgs want to make sure that their privacy program is delivering value to their customers/subscribers, shareholders, and employees, and allows the org to leverage their data effectively. However, using this data effectively is difficult because the number of privacy laws that have changed and continue to change. It is also difficult for orgs to understand how these changing considerations apply to their org practices, particularly when the org has different locations that use different data types in different ways.

Most orgs have a reactive approach to privacy protection rather than having a proactive approach to adapting to changing privacy regulations, which makes implementing a privacy program very difficult. Implementing a proactive privacy program is made even more complicated when an org has a complex hierarchy of stakeholders and personnel, from executive management to personnel implementing controls and working with new technologies and systems. The ADPP solves such issues by creating “privacy confidence,” which is the confidence that org personnel know that their org is handling personal information in a specific way, that this handling is consistent with how they are portrayed externally, and is compliant with various privacy protection regulations.

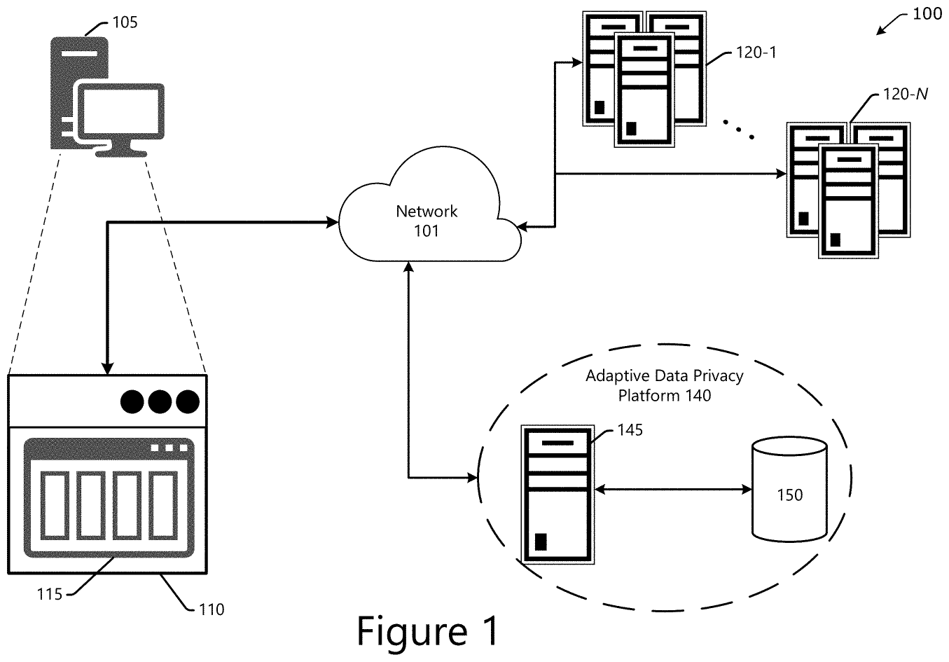

The present disclosure discusses various implementations of an adaptive data privacy platform (ADPP) (see e.g., ADPP 140 of FIG. 1). The ADPP (also referred to as a “privacy confidence platform” or the like) can be used by orgs to better understand their privacy obligations to customers, subscribers, and other data subjects throughout a plethora of regulatory regimes and geopolitical jurisdictions, and to build privacy compliance strategies to proactively manage those obligations. For example, various legal obligations may affect an org's personal information lifecycle, contractual obligations may restrict what an org can and cannot do with personal information, the org's strategic goals may rely on processing personal information, ethical constraints may affect how personal information may be used and/or transparency and fairness in the processing of personal information, and customer satisfaction considerations, perspectives, and expectations may also affect how an org handles personal information. The ADPP is tuned to include content related to legal and regulatory compliance in jurisdictions around the world, and also allows orgs to ingest their existing rulebooks, policies, and standards to operationalize and manage privacy programs and information processing mechanisms in a dynamic way.

Existing privacy technologies focus on specific pieces of operational privacy. By contrast, the ADPP provides strategic management of data (e.g., personal, sensitive, and/or confidential data) processing and/or profiling by data processors, controllers, and/or third-party processors or controllers (e.g., as defined by the GDPR). Rather than seeking to replace existing privacy protection tools, the ADPP provides orgs with answers to questions like: “What are our privacy obligations in specific jurisdictions”, “how far along are we in meeting them?”, and “what are the privacy impacts of expanding into new regions or adding new processing activities?” While modern privacy laws like the CCPA and GDPR receive substantial amounts of media coverage, privacy professionals know that there are many other sources of privacy obligations, such as contracts, business goals, and ethical considerations. The ADPP represents these privacy obligations as PFs in a similar manner to privacy laws. This means that no matter the source of a privacy obligation, the org can be confident that they will be represented consistently within the ADPP.

The ADPP includes tools (e.g., graphical user interfaces (GUIs) and the like) that allows developers and/or privacy officers to model various aspects of an org, including the types of data the org processes, the geographic or political regions in which the org operates (or where different computing devices and/or data storage devices are located), obligations dictated by contracts, service level agreements (SLAs), and the like (if any), and the types of processing activities provided or performed by the org. The org modeling tools can also allow the developers/privacy officers to mix and match different privacy policies together, and the ADPP may predict or simulate how the different policies operate and interact with one another. This allows the developers/privacy officers to see the impact of different changes to the org or to legal frameworks before they are deployed to different systems.

Once the org is modelled, the ADPP identifies the applicable PFs and associated requirements and tasks for implementing the identified PFs. The developers/privacy officers can also customize the PFs, requirements, and/or tasks to better conform to existing operating procedures of the org.

After the org model has been created and privacy obligations have been identified, the ADPP can determine how best to deploy the PFs to different systems and/or individuals within the org. For example, the ADPP can determine or identify the specific steps required to meet all of the org's privacy obligations in a particular jurisdiction (e.g., the obligations on those parts of an enterprise that operate in Brazil or some other geopolitical entity). The ADPP also keeps track of when laws come into effect, and when existing laws are changed or modified, allowing the org to plan future work for laws that may have been passed but are not yet operational. In some implementations, the ADPP includes a content model that normalizes similar requirements with full traceability back to their source PFs. In this way, the ADPP identifies where an org can maximize investments in common privacy solutions, allowing for targeted customization of such tools where necessary. Furthermore, the ADPP makes privacy/information processing tasks manageable, and provides assurance that the org is managing the risks of regulatory enforcement, consumer-focused brand damage, and/or supply chain disruptions.

The ADPP can also identify differences in defined terms or terminology between different regulatory regimes or regions, as some specific terms may vary between jurisdictions. In one example, the definition of a “personal information” in a first jurisdiction may be different than the definition of “personal information” in a second jurisdiction. Continuing with this example, the first jurisdiction may be California operating under the CCPA and the second jurisdiction may be the European Union (EU) operating under the GDPR. Here, the CCPA defines “personal information” as information that identifies, relates to, describes, is capable of being associated with, or could reasonably be linked, directly or indirectly, with a particular consumer or household, whereas the GDPR defines “personal information” as information relating to an identified or identifiable natural person. In this example, the ADPP may identify the difference in that the CCPA requires monitoring and processing personal information that can be linked to a particular household, and can adjust the PFs for org operational units and computing systems/services operating in California or systems/services that are otherwise subject to the CCPA (e.g., when collecting information from California residents).

In some implementations, the ADPP can integrate with various privacy program management solutions, including those developed by third parties, via suitable APIs, web services, and/or other mechanisms. This allows the ADPP to share data and/or PFs with those tools so that the org can continue to use them while developing their privacy programs using the ADPP. In some implementations, the integration can involve provisioning or deploying PFs and/or adjusting the existing privacy tools to operate according to the developed PFs/tools.

In some implementations, the ADPP includes tracking and reporting mechanisms that can monitor how well an org is complying with their privacy program and report that progress to relevant parties (e.g., org leadership, regulatory bodies, other orgs/enterprises for SLA obligations, and the like). From strategic decision making to tactical issues, the ADPP tracking mechanisms provide developers and privacy officers with global view of the org's privacy program, which allows the org to eliminate guesswork, gain insights, execute and scale PFs efficiently. The present disclosure also discusses (1) processes involving the connection points between use case descriptions created by an org (e.g., developers or privacy compliance officers), and returning results to the org; and (2) processes for turning use cases involving the use of data subject personal information in accordance with data privacy regulations into a set of actionable requirements. Examples of these use cases include representations or models of an org process or an org condition such as implementing a marketing campaign, developing a recommendation engine, launching a new product line, and the like. These processes are executed or otherwise performed by a requirements engine. The requirements engine takes in an org use case(s), data type(s), and geographic jurisdiction(s), and identifies and/or determines an org context associated with personal information, and automates the process of identifying and/or determining which data privacy regulations and/or org constraints apply to that particular org use case. Then, the requirements engine automatically creates actionable projects, tasks, and/or work items based on the identified requirements. In some implementations, the actionable projects, tasks, and/or work items can include assigning specific tasks to individuals, working groups, or other entities, and/or can be configurations to be implemented or executed by the orgs' data processing systems through connectors, APIs, web services, and/or the like. Additionally or alternatively, the actionable projects, tasks, and/or work items can include updating or otherwise altering an org's public-facing privacy notice to reflect the relevant PFs. The ADPP allows an org to create a context specific to its particular org use case and manage tasks associated with implementing the components of its privacy program, notice, internal policies and the like, necessary to address applicable regulatory requirements.

Existing solutions to managing data privacy with respect to specific jurisdictions and/or regulatory bodies involve using individual expert knowledge, consulting, and roles and responsibilities. Typically, data privacy regulation compliance is performed in a highly manual manner by lawyers or consultants, and the interpretation of what needs to be done to comply can vary significantly between similar companies because of a lack of standardization. Even large orgs typically use spreadsheets or largely manual processes to move from understanding that a new law or regulation exists to determining its exact applicability to their org. With the explosion of new data privacy regulation since 2016, there has been a significant increase in the need for a solution to manage data privacy programs due to the increase in volume and velocity of changes in requirements that affect multi-national orgs.

This problem has been addressed within the information security space through “cross-walks” between different standards to show overlaps and differences, as well as through the development of frameworks like the HITRUST Alliance®, which combine several frameworks into a unified set of requirements. For example, some existing solutions attempt to use Governance, Risk, and Compliance (“GRC”) tools for data privacy compliance. GRC tools are designed for information security, which are considerably more structured and defined than their privacy counterparts, and do not have the same level of nuance in their legal applicability that necessitates a different approach for privacy protection and compliance.

One difference between the embodiments discussed herein and these existing approaches is that embodiments discussed herein are dynamic and adapt to each org uniquely vs. providing a one-size-mostly-fits-all solution for every org. No existing solution discloses systems that use a conceptual model of an org that assists with complying with privacy-related regulations and/or allow orgs to define rules for handling personal data.

The embodiments discussed herein allow orgs to unlock the ability to not only comply with external regulatory compliance scenarios, but also allows orgs to comply with all applicable privacy laws and combine them with their own preferences and/or customer/subscriber preferences within those requirements. In this way, the embodiments discussed herein bridge the gap between what was promulgated within the framework and how the particular org goes about utilizing data that is subject to those frameworks. The embodiments discussed herein also allow orgs to create a unified set of data management requirements that is/are de-duplicated and implement the org processes behind the unified set of data management requirements. The unified set of data management requirements represent a single source of truth that org personnel can rely on for implementing the various privacy program components. The embodiments discussed herein resolve the ambiguity and lack of knowledge in an org regarding compliance with regulatory and org privacy requirements. Privacy requirements may include regulatory compliance, internal contractual requirements, and/or ethical decisions. The embodiments discussed herein provide a means of creating organizational compliance requirements and measure the performance of the org against those requirements ensuring a culture of privacy across the org.

### 1. ADAPTIVE DATA PRIVACY PLATFORM EMBODIMENTS

FIG. 1 depicts an example system architecture 100 for providing adaptive data privacy platform. In this example, the system architecture 100 includes a network 101, a user system 105, organization (org) platforms 120-1 to 120-N (where N is a number), and adaptive data privacy platform (ADPP) 140. The ADPP 140 includes one or more ADPP servers 145 (also referred to herein simply as “servers 145” or “server 145”) and one or more databases (DBs) 150.

The user system 105 includes physical hardware devices and software components capable of accessing content and/or services provided by the org platforms 120-1 to 120-N (collectively referred to as “org platforms 120”, “org platform 120”, “org 120”, or the like) and/or ADPP 140. Users and/or user devices 105 that utilize services provided by individual org platforms 120 and/or ADPP 14 may be referred to as “subscribers” or the like. In one example, a user of user system 105 is a subscriber of one or more org platforms 120. In another example, a user of user system 105 is an employee or agent of an org platform 120, and the user and/or the org is/are subscribers of the ADPP 140.

The ADPP 140 includes one or more ADPP servers 145 and a ADPP database (DB) 150. The ADPP servers 145 may be virtual or physical systems that provide adaptive privacy management services to individual orgs and/or users (e.g., using a user system(s) 105) and/or for customer platforms 120. The virtual and/or physical systems may include application (app) servers, web servers, DB servers, and/or other like computing systems/devices. The servers 145 may be located in one or more data centers, at the network's “edge”, or in some other arrangement or configuration. In some embodiments, one or more of the servers 145 may be virtual machines (VMs) or other isolated user-space instances provided by a cloud computing service or the like. Furthermore, the ADPP servers 145 may also provide various administration capabilities to support the various aspects discussed herein.

The servers 145 operate distributed applications to provide the ADPP services to user systems 105 and org platforms 120. According to various embodiments, the ADPP servers 145 operate and/or execute respective requirements engines, which are discussed in more detail infra. In one example, one or more ADPP servers 145 may operate as an app server and may provide a respective ADPP services (e.g., registration, policy template intake, requirements/policy generation, report generation, and the like) as separate processes, or by implementing autonomous software agents. In another example, individual ADPP servers 145 may be dedicated to perform separate ADPP services, and app servers may be used to obtain requests from user systems 105 and provide information/data to the ADPP servers 145 to perform their respective ADPP services.

The ADPP 140 is a computing and/or network architecture that works in conjunction with various data privacy and information security tools/systems. The ADPP 140 provides a data privacy model (also referred to as a “privacy framework”, “org model”, and/or the like) for how to take multiple categorized PFs and turn them into org (business) requirements (e.g., binding corporate rules (BCRs), environmental, social, and governance policies (ESGs), master service agreements (MSAs), service level agreements (SLAs), service level objectives (SLOs), service level expectations (SLEs), and the like) that address various data privacy projects and programs across the org 120 through a combination of metadata tagging schemas and filtering based on a conceptual model of the org 120. The ADPP servers 145 operate or execute a requirements engine that is the connection point between use case descriptions created by an org 120, which then returns various privacy requirements and/or results. The requirements engine(s) also convert use cases involving the use of data subject to data privacy regulations into a set of actionable requirements. The use cases are representations of an org process or an org condition such as implementing a marketing campaign, developing a recommendation engine, launching a new product line, and/or the like.

One issue is that privacy policies and practice/implementations can be very disconnected and misaligned. For example, an org's 120 public facing statements may not actually reflect the reality of how that org 120 handles their data, for example, where an org 120 uses data or collects more data than is publicly declared. It is also difficult for orgs 120 to know how a change in laws or regulations will affect their privacy program and how it operates. The ADPP 140 resolves these issues by modeling an org's 120 privacy program, which is then adapted or adjusted as the org 120 adapts and changes to different circumstances.

The data privacy model may include or describe an org's 120 legal obligations affecting the personal information lifecycle, contractual obligations that restrict what an org 120 can do with personal information, the org's 120 strategic goals to the extent they are reliant on personal information, the org's 120 standard of ethical usage of personal information including transparency and fairness, and customer (or subscriber) satisfaction considerations, perspectives, and expectations. Data privacy models begin with the premise that legal obligations are not equivalent to privacy protections. In addition, contractual obligations may restrict what an org 120 can do with personal information. Ethical considerations are increasingly being considered as part of a good privacy program, but ethical considerations are rarely formally incorporated into a privacy controls framework or model. Also customer/subscriber standards, perspectives, expectations, and/or preferences are included in the data model, which often go above and beyond what the law may require for a particular jurisdiction. Further, the org's 120 strategic goals are incorporated into the model, and each of these factors is treated as a set of rules for generating a privacy program.

The ADPP 140 also allows the org 120 to determine what tasks have been completed and need to be completed to implement their privacy program. The privacy data model can age all of an org's 120 requirements to determine if new or updated practices need to be implemented. For example, an org's 120 data handling training from a year ago may have updates and the ADPP 140 may alert the org platform 120 that the updates have been made and that certain individuals or working groups need to go through the updated training. This aging can be configured by each org to meet their specific requirements and resourcing.

The ADPP 140 also allows an org 120 to execute and scale their privacy program effectively by integrating with existing privacy tools such as JIRA, ServiceNow, and other ticketing systems. In this way, the ADPP 140 can push requirements into these existing applications used by the org 120, pull in statuses and other data from those existing applications, and then report up at a program level. API integration brings operational findings to different audiences as part of a joined-up view of program status.

Additionally, the ADPP servers 145 operate or execute respective de-duplication components, allowing for the execution of tasks or requirements with related tasks or requirements thereby resulting in an “overlap” of work in other privacy-related tools and/or frameworks to satisfy those related tasks or requirements. This reduces duplicative efforts for completing task or requirements. Furthermore, the ADPP servers 145 that provides real-time updates regarding new or updated regulations, requirements, and/or task/requirement completion by specific individuals. The ADPP servers 145 are also configurable or operable to generate reports and statistics to authorized recipients upon request.

The ADPP app 115 allows customer platforms 120 to identify and/or represent an org use case associated with personal data, sensitive data, confidential data, and/or other types of data. The ADPP 140 automates the process of identifying which data privacy regulations and company policies/regulations apply, and creates actionable items for the org 120, different departments or sub-orgs of the org 120, and/or individual org personnel and/or agents of the org 120. The ADPP 140 facilitates this process by automatically determining the applicability of privacy requirements within different use cases defined by the org platform 120. The ADPP 140 improves the process of understanding and implementing compliance requirements within the privacy industry and improves that process with automation via cataloging and taxonomy that allows such automation. This creates the ability for end users 105 to self-serve and create their own guidance for understanding and implementing compliance requirements within the privacy industry. The ADPP 140 also provides automatic content merging and deduplication that exists within the system (within the org 120). The ADPP 140 also utilizes various machine learning (ML) techniques that to provide textual combination (merging) and deduplication. Further details and examples of the ADPP services are discussed in more detail infra.

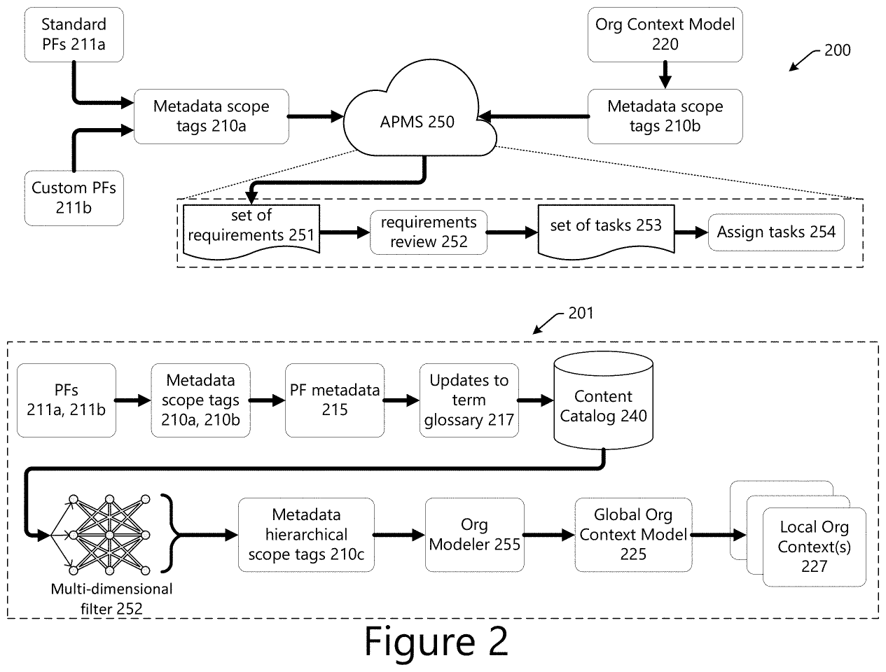

For example, the servers 145 receive data privacy information (e.g., conceptual model of the org 120 such as org context model 220 in FIG. 2, tags, metadata, and the like) from user systems 105 via a front-end ADPP app 115 (e.g., website, web app, mobile app, and the like) that is operated within a client app 110. The user system 105 is configured to operate the client app 110 to obtain and render graphical objects 115 (or simply “objects 115”) within the app 110, wherein the app 110 interacts with the ADPP 140 to obtain the ADPP services. In one example, the app 110 is an HTTP client, such as a web browser (or simply a “browser”) used for sending and receiving HTTP messages to and from a web server and/or app server of the org platforms 120 and/or ADPP 140. Additionally or alternatively, the app 110 may be a browser extension or plug-in configured to allow the client app to render and display ADPP portal/dashboard 115. Examples of such browsers include WebKit-based browsers, Microsoft's Internet Explorer browser, Microsoft's Edge browser, Apple's Safari, Google's Chrome, Opera's browser, Mozilla's Firefox browser, and/or the like. In another example, the app 110 may be a desktop or mobile (e.g., stand-alone) application that runs directly on the user system 105 without a browser, and communicates (sends and receives) suitable messages with the org platforms 120 and/or ADPP 140.

The user system 105 operates the app 110 to access dynamic content provided by the org platforms 120 and/or ADPP 140, for example, by sending appropriate HTTP messages or the like, and in response, the server-side app (s) may dynamically generate and provide the code, scripts, markup documents, and the like, to the app 110 to render and display objects 115 within the app 110. A collection of some or all of the objects 115 may be a webpage, web app, mobile app, and the like, comprising a graphical user interface (GUI) including graphical control elements (GCEs) for accessing and/or interacting with the org platforms 120 and/or ADPP 140. This collection of objects 115 may be referred to as “webpage 115,” “app 115,” “ADPP dashboard 115”, “ADPP portal 115”, and/or the like. The server-side applications may be developed with any suitable server-side programming languages or technologies, such as PHP; Java™ based technologies such as Java Servlets, JavaServer Pages (JSP), JavaServer Faces (JSF), and the like; ASP.NET; Ruby or Ruby on Rails; Kotlin; and/or any other like technology such as those discussed herein. Additionally, or alternatively, the server-side apps may be built using a platform-specific and/or proprietary development tool and/or programming languages.

In various embodiments, the data privacy information includes use case descriptions (also referred to as “use case definitions” and/or the like). The org platform 120 creates the use case descriptions/definitions (UCDs) in the ADPP app 110. A UCD comprises one or more information objects and/or data structures that describe org condition(s), rules, parameters, events, and the like, for which the org 120 wants to understand relevant privacy regulations and/or requirements. Additionally or alternatively, a UCD is a configuration or policy that is used to define constraints, conditions, events (e.g., user interaction data, org personnel actions, and/or the like), and/or generalized use case implementations for a particular org use case. The UCD may define various data types, data and/or metadata, constraints/conditions for processing, storing and/or deleting the data and/or metadata.

For example, an individual or working group (WG) within the org 120 is trying to build a new product and the WG wants to use PI within the operation of the product. The user 105 creates the UCD describing the specific types of PI and how the PI will be used in the new product, and the ADPP 140 provides a description of the regulation or regulations that apply to that use case as well as a set of tasks designed to facilitate compliance with those regulations to the WG via the ADPP app 110. In some embodiments, the ADPP 140 includes a content model that has a common taxonomy for use cases, data types, legal jurisdictions, geographies, and/or the like. The ADPP 140 provides the ability to implement and measure applicable requirements within an org 120 and provides traceability of those requirements back to a core set of frameworks that are the source of truth for those particular requirements.

In some implementations, the UCDs may be created using use case templates (UCTs). Here, templates are abstract data types that can be instantiated by users 105, 120 to employ a particular behavior. The users 105, 120 may develop program code, script(s), and the like that instantiate an instance of a particular UCT using a suitable programming language, scripting language, mark-up language, or the like. As examples, the UCTs, UCDs, and the like, may be defined using XML, JSON, markdown, IFTTT (“If This Then That”), PADS markup language (PADS/ML), Nettle, Capirca, and/or some other suitable language and/or data format, such as those discussed herein. The UCTs are templates that allow users 105, 120 to utilize the ADPP services discussed herein without having to know or learn how to implement ADPP aspects, such as specific data privacy and custodial regulations for various jurisdictions, how to create and update privacy policies, and/or how to manage database management systems. In this way, the users 105, 120 can instantiate an instance of a particular UCT for a specific use case, for example, payment processing, location data processing, healthcare/medical data handling, and/or the like. Based on the instance of the particular UCT, the ADPP 140 determines/identifies the applicable regulations, policies, and the like, generates tasks or requirements that specific individuals should follow, and ensures that PI and/or other data is managed in accordance with the tasks/requirements.

As mentioned previously, users 105, 120 can configure the use case definitions using a web based graphical user interface (GUI) (e.g., ADPP app 110). In these implementations, the ADPP 140 may provide a development (“dev”) environment, programming language(s), and/or development tools that allows the users 105, 120 to create/edit use case definitions. Additionally or alternatively, the users 105, 120 can configure the use case definitions through a suitable API and/or web service (WS). Where APIs/WSs are used, the use case definition may be developed using any suitable mark-up or object notation language, and/or some other language such as those discussed herein.

The developed UCDs/UCTs are then pushed or otherwise sent to the ADPP 140 using the API or WS. The API may be implemented as a remote API or a web API, such as a Representational State Transfer (REST or RESTful) API, Simple Object Access Protocol (SOAP) API, Apex API, and/or some other like API. Additionally or alternatively, the API may be implemented as a WS including, for example, Apache® Axi2.4 or Axi3, Apache® CXF, JSON-Remote Procedure Call (RPC), JSON-Web Service Protocol (WSP), Web Services Description Language (WSDL), XML Interface for Network Services (XINS), Web Services Conversation Language (WSCL), Web Services Flow Language (WSFL), RESTful web services, and/or the like.

In some implementations, the UCDs allow users 105, 120 to define events or messages that the org platform 120 (or specific departments or groups within the org 120) may receive or accept from their subscribers, which may include or indicate PI and/or other data. For example, these messages may be generated and sent to the org platform 120 based on detection of various user interactions with the org platform 120 (or a specific application or content provided by the org platform 120). In these implementations, the ADPP 140 may provide tasks or requirements to be performed by the personnel of the org 120, and/or may provide program code, scripts, and the like, to be implemented by the org platform 120. When such an event takes place or is triggered, the ADPP code/script(s) implemented by the org platform 120 causes the org platform 120 to handle the relevant data in a manner that is consistent with various data privacy regulations and the like.

As alluded to previously, the ADPP 140 provides a set of requirements based on the UCDs/UCTs. The set of requirements include information objects or other data structures including a set of rules that govern the behavior of the org platform 120, different departments of the org 120, and/or various subsystems of the org platform 120. For example, the set of requirements may dictate how to handle specific types of data (e.g., medical/healthcare data versus social media data), how to handle data related to different user (e.g., employee vs customer/subscriber), how to handle network traffic for specific network addresses (or address ranges), protocols, services, applications, content types, and the like, based on an organization's information security (infosec) policies, regulatory and/or auditing policies, access control lists (ACLs), and the like. Additionally, the requirements can specify (within various levels of granularity) particular users, and user groups, that are authorized to access particular data types, based on the org's hierarchical structure, and security and regulatory requirements. The information objects or data structures of the requirements may include a “description,” which may include textual descriptions, a collection of software modules, program code, logic blocks, parameters, rules, conditions, and the like, that may be used by the ADPP 140 to generate a policy program for the org platform 120. Any suitable programming languages, markup languages, schema languages, and the like, may be used to define individual requirements and instantiate instances of those requirements.

The ADPP 140 may or may not handle the delivery of data mapping, data discovery, managing data, managing consumer interaction, or the operational pieces (specific org processes behind those) of data subject requests. The ADPP 140 includes and/or stores (e.g., in DB 150) metadata attribute hierarchies that represent an org 120 and/or org process(es), and utilizes the metadata attribute hierarchies to represent frameworks, regulations, and requirements in a way that allows comparison between them. The ADPP 140 aligns and filters org use case(s) and/or org context(s), and the representation of frameworks, regulations, and requirements to provide an output describing what that specific org 120 needs to do to achieve compliance with respect to their usage of personal information. The ADPP 140 includes technology that is used as a filter for what is applicable to an org or org use case from a regulations and requirements perspective. The ADPP 140 includes technology and supporting processes that identify and manage definitions from legal and other frameworks that may vary while the broader requirement stays similar (e.g., the age of a child is defined differently in different jurisdictions) and then presenting just those definitions that are relevant to a particular org 120 based on their use case(s) and/or org context(s)

The ADPP 140 includes technology that treats different types of requirements related to constraints on the collection, usage or management of personal information (e.g. laws, contracts, ethical considerations, customer feedback, and strategic goals) and allows orgs 120 to understand the overlapping set of those requirements and to manage them as a single program. The ADPP 140 includes technology that allows orgs 120 to input their own frameworks of requirements (e.g., a custom privacy controls framework) using a standardized content ingestion process so that these can be managed along with frameworks derived directly from laws, regulations or contracts. The ADPP 140 includes technology that allows for a direct comparison between the current state of a privacy/data protection program and the state after a change to any combination of changes in laws or other frameworks, or changes to the data types, use cases or jurisdictions that the org operates in.

The ADPP 140 bridges the gap between what is promulgated within a legislative, regulatory, and/or contractual frameworks, and put in to practice within the jurisdiction and is specific to an org 120 (e.g., from a legal perspective) and how the specific org 120 goes about making money utilizing private information and those processes.

The ADPP 140 provides a catalogue of frameworks (e.g., content catalog 240 of FIG. 2), and identifies and associates org contexts to applicable frameworks. The ADPP 140 also allows automatic content merging and deduplication that exist within the system (within the org 120). Various ML techniques are used to provide the textual combinations and deduplications. While such an approach could be performed manually using the underlying ADPP data model, one advantage of the ADPP 140 is the ability to compare the current state of a privacy program with potential future states and instantly see the impact on the requirements for their privacy program. The “states” may include, for example, whether an org 120 expands into (or starts operating in) a new jurisdiction, whether an org 120 exits or divests from a particular jurisdiction, the org platform 120 starts collecting new or different types of data (e.g., geolocation data), whether an org 120 stops collecting certain types of data, and/or the like.

The ADPP 140 includes metadata tagging, schemas, and filtering aspects that interact with one another. The metadata tagging, schemas, and filtering mechanisms link various components in the ADPP 140 to provide a user 105, 120 with successful privacy program. Unlike existing approaches where many orgs 120 apply the same “one-size-fits-none” framework to their privacy program, users of the ADPP 140 create a model of their org's 120 structure and use(s) of personal information using metadata tags (e.g., metadata tags 210a, 210b, and 210c of FIG. 2). The ADPP 140 uses the metadata tags as a multi-dimensional filter against an extensive content catalog of privacy laws, regulations, and other requirements (e.g., content catalog 240 of FIG. 2). In this way, an org 120 is defined as a hierarchical set of tags (e.g., metadata hierarchical scope tags 210c of FIG. 2) that are algorithmically compared against the tags associated with each requirement within the content catalog. When a tag in the org hierarchy matches a tag in the content catalog, a requirement associated with the tag in the content catalog is pulled into the org's 120 privacy program. Requirements could have several tags. For example, a tag and/or requirement may be “applies to employees in Belgium” or “applies to sending email in the USA” which allows the ADPP 140 to apply only parts of a law or framework that are applicable—rather than requiring a user to analyze a framework themselves to determine which elements are applicable to their org 120.

The ADPP 140 creates or develops an org context for an org 120 (e.g., org context model 220 of FIG. 2). The ADPP 140 provides a suitable GUI for users 105, 120 (e.g., org modeler 255 of FIG. 2) via ADPP app 115 to define how their org 120 utilizes data, and the particular subsystems and storage mechanisms to ingest, store, and process various types of data. In one example implementation, the GUI may present a series of questions to the users 105, 120, and provide suitable graphical control elements (GCEs) to provide answers to such questions (e.g., text boxes, drop down lists, check boxes, radio buttons, and so forth). Additionally or alternatively, the GUI may include a question wizard experience to guide users 105, 120 (e.g., through a series of dialog steps and the like) to create a representation for their org 120 that the ADPP 140 uses to match requirements with. Additionally or alternatively, various tags may be represented in the GUI as respective graphical objects, and the GUI allows the users 105, 120 to arrange the graphical objects in a way that graphically represents the org. Additional or alternative user experience and user interface (UX/UI) mechanisms may be used to allow users 105, 120 to model an org. The three major dimensions of an org context represent the ways that privacy requirements typically apply—either to a data type, use case, or geography, and/or combinations thereof. The model also looks at some ways that laws may apply to certain types of activity, for example, data processing on behalf of another org, or to employee related information and allows these to be captured as well to build a high-level representation of the ways that an org interacts with personal data.

The ADPP 140 filters the org use cases and/or org contexts. The ADPP 140 applies one or more filters to identify a match between the definition of an org (e.g., the aforementioned hierarchical set of tags) and the tags (e.g., in the data catalog) that show where a particular requirement would be applicable. Anything that does not match (e.g., a requirement specific to children's data when the org does not collect or use any child/minor data) is filtered out of the org's 120 privacy program.

The ADPP 140 aligns org contexts and/or org use cases with frameworks/org requirements, contractual requirements, and ethical considerations to produce specific requirements of the org 120. The ADPP 140 ingests a wide variety of requirement types, so long as they can be associated with one or more of the major dimensions outlined above, and/or others that may be added depending on use case and/or design choices. In addition to legal requirements, other requirement types, such as privacy-related contractual language, can also be ingested as a custom framework. The ADPP 140 determines when requirements will apply to an org. The ADPP 140 is able to expand to related requirement sets, which face a similar challenge of a complex set of requirements that will only apply in certain circumstances.

The ADPP 140 assigns tasks to specific personnel to satisfy the tasks/org requirements. Once a set of requirements has been identified for an org context, the ADPP 140 may require a sign-off from the user org that they have reviewed those requirements and find them appropriate and complete. In these embodiments, once that sign-off has occurred, the ADPP 140 then moves to an operational view of the world vs. a purely compliance view. Once this sign-off is complete, the ADPP 140 assigns tasks to meet the requirements that are applicable to that org context. In some embodiments, the mapping between tasks and requirements is many-to-many rather than many-to-one. A failure of prior approaches has been that, if tasks are associated with a single requirement, significant duplication and overlap will result. The ADPP 140 allows a group of related tasks to meet several requirements simultaneously through a many-to-many mapping. Once tasks have been assigned to the org context, each of those can then be assigned to someone to complete, either within the ADPP 140 or through an API to a workflow tool already in use in the org platform 120, a communications technology (e.g., email client), and/or the like. In some implementations, a default includes assigning all tasks to the owner of a particular org context for further delegation. This is particularly effective if the program is broken up into several parent/children org contexts.

The ADPP 140 translates/converts the Data Privacy Model (DPM) into various Privacy Frameworks (PFs). In some implementations, a suitable data transformation language, interface definition language (IDL), schema, or transcoding engine is used to convert PFs, UCDs, UCTs, and the like, into a consistent format for ingestion into the ADPP 140. This process involves several stages to ensure consistency between different team members, and the creation of relevant metadata to enable the filtering/comparison model mentioned above. Additionally or alternatively, Artificial Intelligence (AI) and/or ML techniques, such as Natural Language Processing (NLP), Natural Language Understanding (NLU), topic classification, and/or the like, may be used to automate or semi-automate the ingestion process to process queries and templates. Such implementations may be useful where, for example, an org 120 wishes to ingest privacy language from third-party contracts, which could number in the hundreds or thousands.

The ADPP 140 catalogs or otherwise stores the PFs, org-defined rules/policies, contractual obligations, BCRs, ESGs, MSAs, SLAs, ethical considerations, customer feedback and/or ratings, strategic goals, and/or other like information. Frameworks are a structural element of the catalog. Each framework is derived from either a legal, contractual, ethical, strategic, or customer focused source. Each framework has metadata associated with it, such as the date range for which it is effective, which allows algorithmic analysis of which frameworks are applicable at a certain point in time as well as an ability to forecast which frameworks and their associated requirements will be applicable at any future date. Each framework includes one or more requirements, which are organized into a multi-component model of a privacy program. In one example implementation the multi-component model is a proprietary 12 component model. Each requirement is tagged as described above as to when they will be applicable to a privacy program. Multiple tags can be assigned to each requirement.

The ADPP 140 stays current with changing laws in various jurisdictions. Changes in different jurisdictions are added to the ADPP 140 content model and then published out to clients (org platforms 120) during content catalog updates. The client instance (org platform 120) evaluates these updates and determines how the changes impact the existing program status, based on the configuration of org contexts within the platform. This functionality is similar to the “what-if” privacy functionality described below and gives each user of the platform a detailed analysis of what has changed in the requirements that are applicable to them.

In some implementations, org requirements are associated with tasks that are assigned and then completed through some human interaction. Additionally or alternatively, the ADPP 140 and/or individual org platforms 120 may execute org requirements with little to no human interaction. This functionality can be extended so that tasks are pushed to other platforms which can then update the status of the task when it is complete, enabling real-time reporting.

In some implementations, org requirements can be connected to one another, wherein these org requirements can be automatically satisfied by executing other org requirements. As described above, org requirements are satisfied by completing one or more tasks. Some tasks, such as completing a data inventory, support the completion of multiple requirements. When all of the tasks associated with an org requirement are marked as complete, the requirement that they relate to will also be marked as complete.

In some implementations, some org requirements can be satisfied by achieving a separate org requirement. In these implementations, sub-categories or sub-tags of org requirements may be connected to one another and/or tags and/or categories of org requirements. As described above, org requirements are satisfied by completing associated tasks. It is common that some broad tasks will partially complete a number of org requirements.

The ADPP 140 aligns varying definitions of terms of the myriad jurisdictions with multiple frameworks, contractual requirements, ethical considerations, and strategic goals. The content model may store or indicate variations in definitions among jurisdictions and/or frameworks, and indicates how to manage them. When content is ingested, the ADPP 140 identifies various defined terms. Different frameworks frequently have different meanings for the same term (e.g. Personal Information, Child/Minor, and the like) or different terms with similar meanings (e.g. Service Provider vs. Processor). When creating a requirement, the ADPP 140 determines which definitions are used for the relevant frameworks. These are captured as variables within the content model associated with that requirement. When multiple variations of a requirement are present within a single org context, the model will provide the user with information about the differences, and allow them to make a choice regarding which definition to use.

The ADPP 140 accounts for overlapping requirements when consolidating the frameworks, contractual requirements of the org, ethical considerations, and strategic goals. The content model is designed to de-duplicate requirements that appear within multiple frameworks. For example, if there was a legal requirement to always describe what you were planning to do with personal data, and an ethical requirement to only collect personal data that you were transparent about collecting, both of those would be associated with the same fundamental requirement, and to the extent that they had nuances in how this would be done, this would be shown to the user that they needed to comply with the super-set of overlapping requirements. Where requirements from separate frameworks have differences where one choice needs to be made, such as the age of a child, or the time taken to respond to a request, the technology will calculate and present a ‘high water mark’ value which represents the most stringent version of that requirement from the applicable frameworks and allow the user to either select the recommended most stringent value, or determine an alternative approach that aligns with their risk appetite. For example, they could create a child org context with the more stringent requirements and just meet those for part of their org, or they could select a less stringent “not fully compliant” value for that requirement, which would then need to be approved and tracked as part of an overall reporting package.

The ADPP 140 maintains separation of overlapping and granular requirements discussed above from the broader strategic goals of the privacy program. The ADPP 140 includes a flexible reporting module that allows orgs 120 to report on a variety of slices through a privacy program. Whether progress towards implementation of a single framework, against a privacy program component such as training awareness, or against either an org context or a set of metadata tags (e.g., training in Brazil), or both. This allows executives or other org personnel to focus in on whether their strategic objectives are being met while at the same time allowing for an operational view of progress towards detailed goals.

The ADPP 140 ingests content to create custom frameworks, and manages such frameworks. The ADPP 140 includes file upload mechanisms for some data sets and can be configured to integrate with APIs to transfer relatively large data sets. Once on the ADPP 140, custom frameworks are managed with the same tools utilized for the licensed ADPP 140 content catalog (e.g., content catalog 240) as described previously.

As alluded to previously, the ADPP 140 allows an org 120 to compare a current state of the org's privacy program to a future state of the privacy program after a change is made to a framework such as addition or deletion of data types/collected data, use case changes, or jurisdiction changes. This allows the org 120 to view different potential requirements before committing to certain changes in their privacy program. In some implementations, the ADPP 140 uses “What If” functionality for these purposes. In one example, there are 4 different variations of the “what-if” or Privacy Scenarios functionality, as described below. Each of these Privacy Scenarios functionality variations starts with an org context and then manipulates it in various ways to show the impact of external or internal changes.

FIG. 2 shows configuration and filtering aspects 200 and 201 of the ADPP 140. Aspect 200 is an example configuration process that is used to model an org 120 (e.g., a representation or data structure of an org 120 describing its hierarchies, countries in which it operates, types of data it collects and/or processes, how it uses that data, and the like), creates a list of relevant PFs 211a and custom PFs 211b (collectively referred to as “PFs 211”), and sets parameters for those PFs 211. Aspect 201 is an example filtering process taking place after the configuration stage, which allows users associated with an org 120 to, for example, view how PFs 211 apply to their org 120 and how they are similar/different to one another, display which PFs apply 211 to individual business unit or components of the org (e.g., local org contexts 227), and the like.

Aspect 200 involves an adaptive privacy matching service (APMS) 250, where standard PFs 211a and custom PFs 211b (collectively referred to as “PFs 211”) are used to generate a set of metadata scope tags 210a. The standard PFs 211a include one or more collections of (standard) requirements such as, for example, existing privacy laws and/or regulations for specified jurisdictions. The custom PFs 211b include one or more collections of org specific requirements such as, for example, BCRs, ESGs, MSAs, SLAs, ethical considerations, customer feedback and/or ratings, strategic goals, and/or other like information. In some implementations, custom PFs 211b can be added by individual orgs 120 who set up their own tags as part of the creation/configuration process. This is where orgs 120 can ingest their playbooks, policies, notices, contracts, rules, and the like—any framework 211b that is part of their privacy program but is unique to that org 120. Custom PFs 211b leverage the same scoping tags 210, and are also able to be applied globally. The metadata scope tags 210a may be the same or similar as the metadata scope tags 210b. Additionally, an org context model 220 is used to generate a set of metadata scope tags 210b. The metadata scope tags 210a and 210b (collectively referred to as “metadata scope tags 210”, “scoping tags 210”, or “scope tags 210”) are provided to the APMS 250. The APMS 250 uses the scope tags 210 to generate or determine a set of requirements 251, which are then used to generate or determine a set of tasks 253. In some implementations, the set of requirements 251 may undergo a review 252 before being converted, translated, or otherwise used to generate the set of tasks 253. The APMS 250 assigns 254 the tasks 253 to individuals, provisions the tasks 253 to the org's 120 computing systems, and/or otherwise takes some action with respect to the tasks 253.

The org context model 220 is a model or other data structure used to determine which PFs 211 and elements of individual PFs 211 (e.g., “requirements 251”) apply based on the org's 120 circumstances. The org context model 220 may be created using the org modeler 255 discussed infra with respect to aspect 201. For example, if during the org modeling process the org 120 selects an EU country/jurisdiction and also consumer data as part of their data handling processes/procedures, the ADPP 140 and/or the APMS 250 to determine things like which PFs 211 exist and/or are relevant to the org 120 (e.g., GDPR because they selected an EU country/jurisdiction), and also some requirements parameters for that PF 211 (e.g., “response time=one month” and/or the like).

The metadata scope tags 210 are programmatic annotations that provide information about the PFs 211 such as identifying particular pieces of a PF 211 (e.g., identifying which component(s) a requirement 251 belongs to or in, adding a variable-value pair such as “response time=45 days”, and/or the like). The scope tags 210 are used to normalize data from multiple PFs 211 so that the PFs 211 can be compared and contrasted consistently. For example, for a given set of PFs 211, the ADPP 140 and/or the APMS 250 can group or filter by scope tags 210 representing components and/or other variables or values (e.g., filter to show only requirements 251 tagged as belonging to a “Notice Component”). Additionally or alternatively, a scope tag 210 is a configuration of one or more privacy scopes. For example, a scope tag 210 can be assigned to a specific privacy law, a specific privacy policy, a BCR, an ESG, an MSA, an SLA, or the like. The APMS 250 is a function or service provided by the ADPP 140. The APMS 250 operates adaptive privacy matching algorithm (or ADPP algorithm) to produce an org-specific set of matched requirements 251 using the scope tags 210. The set of requirements 251 is generated such that the org context model 220 matches the scope of individual requirements 251.

In aspect 201, which is also operated by the ADPP 140, the frameworks 211a, 211b are used to generate metadata scope tags 210 as discussed previously. The metadata scope tags 210 are then used to generate PF metadata 215 (e.g., effective date range, and the like). The PF metadata 215 is used to update term glossary 217, and the terms in the term glossary 217 are stored in a content catalog 240. The term glossary 217 may include various technical terminology, various terminology/definitions in different legal/regulatory frameworks, and/or other privacy-related terminology. The content catalog 240 stores various data/information such as privacy laws, regulations, PFs, org-defined rules/policies, contractual obligations, BCRs, ESGs, MSAs, SLAs, ethical considerations, customer feedback and/or ratings, strategic goals, and/or other like information. A multi-dimensional filter 252 is applied to the various data/information stored in the content catalog 240 to produce a set of hierarchical metadata scope tags 210c. The multi-dimensional filter 252 compares tags 210a and 210b associated with each requirement within the content catalog 240. When a tag 210c in the org hierarchy matches a tag 210a, 210b in the content catalog 240, a requirement associated with the tag 210a, 210b in the content catalog 240 is pulled or otherwise added to a privacy program. The multi-dimensional filter 252 allows the user to specify one or more filtering conditions (e.g., “show me all GDPR Notice Requirements”, “show me all PFs which include a data subject access right, along with the response times for all of them”, and/or the like). The multi-dimensional filter 252 also allows for the filtering and sorting of a superset including PFs 211, requirements 251, tasks 252, and the like, all of which are represented by one or more metadata tags 210.

In some example implementations, the multi-dimensional filter 252 may be implemented as one or more business intelligence technologies such as multidimensional analysis (MDA) systems and/or Online Analytical Processing (OLAP) systems. In these implementations, the MDA/OLAP system(s) include a multidimensional (n-D) cube (also referred to as an “OLAP cube”, an “MDA cube”, or “hypercube” such as when the dataset includes more than three dimensions), which is a database or array of data with multiple dimensions. The n-D cube includes measures that are categorized by dimensions. The measures are placed at the intersections of the OLAP cube, which is spanned by the dimensions as a vector space. Each measure has a set of labels (e.g., metadata) associated with it, and each dimension describes a label (e.g., each dimension provides information about one or more measures). In these ways, data can be viewed from different angles, which gives a broader perspective of a problem (e.g., privacy models, org contexts, and so forth). The MDA/OLAP system(s) also include MDA/OLAP servers (e.g., one or more servers 145 in FIG. 1) that receive and process queries (e.g., multidimensional expressions (MDX) queries, XML for Analysis queries, open Java API for OLAP (olap4j), and the like) on the n-D cube and server query results to the requestor. Additionally or alternatively, the business intelligence technologies can include various techniques for analyzing the data stored in the n-D cube such as, for example, data mining, process mining, text mining, complex event processing, business performance management, benchmarking, predictive analytics, prescriptive analytics, and the like.

In some example implementations, the multi-dimensional filter 252 may be implemented as one or more multi-objective optimization problems such as multi-objective evolutionary algorithms (MOEA), which are evolutionary algorithms that are applied to multi-objective optimization problems, which involve multiple optimization problems and/or multiple objective functions (including many-objective functions) to be optimized simultaneously (see e.g., Huang et al., Survey on Multi-Objective Evolutionary Algorithms, IOP CONF. SERIES: J. OF PHYSICS: CONF. SERIES, vol. 1288, No. 1, p. 012057 (1 Aug. 2019), the contents of which are hereby incorporated by reference in its entirety).

Additionally or alternatively, the multi-dimensional filter 252 can be implemented using one or more AI/ML models such as ML techniques, such as NLP, NLU, topic classification, recommendation engines, recommender systems (e.g., including collaborative filtering, content-based filtering, matrix factorization and/or matrix decomposition, reinforcement learning, Multi-criteria recommender systems (MCRS), and/or the like) and/or other suitable ML techniques such as any of those discussed herein, or combinations thereof.

The set of hierarchical metadata scope tags 210c are used by the org modeler 255 (e.g., question wizard and/or other suitable GUI elements) to allow users related to the org to provide an org model. The org modeler 255 allows users to define or specify various data types, use cases, geographies and/or jurisdictions, and/or other conditions or parameters that are applicable to an org and/or how an org handles data. This org modeler 255 produces a global org context model 225 based on inputs provided to the org modeler 255. In some implementations, the global org context model 225 is the same or similar as the org context model 220. The global org context model 225 can be reduced and/or divided into a set of local org contexts 227 (also referred to as “local org context models 227”, “child org contexts 227”, and/or the like). The global org context model 260 can be broken into an arbitrary number of children org contexts 227 by reducing the number of applicable tags 210. The local org contexts 227 are filtered views of the org context model 220 (or global org context model 225), which is set up during the configuration (aspect 200). The local org contexts 227 represent the org's 120 components or units by one or more parameters and/or characteristic. The set of local org contexts 227 can be further filtered by data type(s), use case(s), geographies, and/or other parameters. Children org contexts 227 cannot extend beyond parent org context 225 boundaries. Each child org contexts 227 can also have one or more child org contexts 227. In some implementations, each child org context 227 has at least one geo (geography tag), one data type, and one use case to be valid.

Each framework 211a, 211b includes a number of requirements (1 to R, where R is a number). There are several classes of scoping tags 210 such as, for example, geolocation, use case, data types, employee/user, controller/processor, and the like. Each requirement is tagged with at least one scoping tag 210 (or at least one type of scope tag 210) that indicates when the requirement is applicable. For example, a requirement from CAN-SPAM, which is a US law regulating sending commercial emails, can be tagged to a data processing/handling activity (e.g., email marketing), geography (e.g., the North American continent), and/or jurisdiction (e.g., the USA and/or individual States of the USA).

An org context 225, 227 is an abstracted representation of how an org 120, or a sub-component of an org 120, uses personal information and/or other types of information/data. Each org context is defined by assigning at least one type of scoping tag 210b. In some implementations, at least one scoping tag 210 of each type of scoping tag 210 is assigned to respective requirements in the set of requirements 251. This combination of tags 210 serves as a multi-dimensional filter against the requirements (content) catalog 240. For example, one or more tags 210 can be assigned to an org 120 (e.g., where the org 120 (or sub-component of the org 120) is located, what data does it use, where and what does it do with that data, and the like). Based on the assigned tags 210, the ADPP 140 determines which PFs 211 apply to the org 120 (e.g., the org 120 (or sub-component of the org 120) is located in the EU and the org 120 (e.g., the org 120 (or sub-component of the org 120) processes personal data, then “PF=GDPR” applies). The ADPP 140 filters out only those PFs 211 that apply to that particular org 120 (or sub-component of the org 120) (e.g., “org=UK division of Acme, Inc.”, would result in GDPR and local UK laws and regulations applying to that sub-component of the org 120, but not local German law.)

Where at least one scoping tag 210 from each tag category (e.g., geolocation, use case, data types, employee/user, controller/processor, and the like) in the org context 220 matches one tag from each tag category in the scoping tags 210 on the requirement, the requirement is added to the Business Context. For example, sending emails in Canada may not trigger the CAN-SPAM requirement mentioned previously, neither would collecting email addresses in the US, but sending emails may trigger CAN-SPAM requirements. For a requirement to be included in the set of requirements 251, at least one tag 210 from each tag category must match. This functionality provides greater flexibility in how frameworks apply to orgs 120. Rather than the traditional “you're in the US, so this framework applies”, the ADPP 140 can exclude requirements within applicable frameworks that do not apply while including the remainder of the framework.

Where requirements are applicable globally, or to all types of data, the system also includes global scoping tags 210 for each dimension. Global scoping tags 210 may be applicable to customer specific frameworks (e.g., custom frameworks 211b) where an org 120 would like to apply a particular requirement (e.g., apply a particular requirement to sending emails in one or more countries). They could also be applicable to frameworks that an org 120 adopts voluntarily such as the NIST Privacy Framework: A Tool for Improving Privacy Through Enterprise Risk Management, Version 1.0, NATIONAL INSTITUTE OF STANDARDS AND TECHNOLOGY (NIST) (16 Jan. 2020), https://doi.org/10.6028/NIST.CSWP. 01162020 (“[NISTPF]”) or an ISO standard such as Information technology—Security techniques—Code of practice for protection of personally identifiable information (PII) in public clouds acting as PII processors, 2^{nd} ed., ISO/IEC 27018:2019 (January 2019) (“[ISO/IEC 27018]”) and the like.

Referring back to aspect 200, the APMS 250 generates a list of requirements applicable to the specific org context (e.g., the org-specific set of matched requirements 251 discussed previously). In some implementations, the set of requirements 251 can be grouped into one or more “components” of a privacy program. The components include areas or modules such as, for example, “Training and Awareness”, “Notice and Collection”, and the like. The combination of components represent all of the activities that the privacy program delivers to the org.

In some implementations, after the set of requirements 251 is generated, a review 252 of the set of requirements 251 can be performed by the org 120 prior to executing or otherwise implementing the requirements 251 to create or measure the privacy program. The review 252 can be a legal review and approval process by individuals and/or using suitable AI/ML models trained on other existing privacy program components and/or other ML features. In some implementations, the APMS 250 can operate the AI/ML models for the review 252 or the set of requirements 251 can be provided to another platform service for the AI/ML review 252 via suitable APIs, web services, and/or the like. During the review 252, some requirements can be de-selected or otherwise removed from the set of requirements 251 and/or additional or alternative requirements 251 can be added to the set of requirements 251 such as, for example, custom requirements 251 created by the org 120.

After the review 252 (if implemented), the APMS 250 identifies or determines a set of tasks 253 that will (within some probability distribution or standard deviation) meet requirements in the set of requirements 251. There can be a many-to-many relationship between tasks 253 and requirements 252 such that one or more tasks 253 can support one or more different requirements 252. Additionally or alternatively, tasks 253 can be modified and/or added to the set of tasks 253 by the org or users associated with the org. After the set of tasks 253 are generated, the APMS 250 assigns 254 individual tasks 253 to different systems or entities. In some implementations, individual tasks 253 to individuals via suitable communication technologies (e.g., email, push notifications, instant messaging, short message service (SMS) messages, and/or the like), an enterprise platform, a workflow tool, and/or the ADPP 140. In some implementations, the tasks 253 are assigned 254 to owners of applicable org context as a default setting. Additionally or alternatively, the APMS 250 can assign 254 individual tasks 253 to different processing systems to handle incoming data according to the set of requirements 251. In these implementations, the APMS 250 generates the set of tasks 253 as suitable information objects (e.g., markup language documents, scripts, and/or the like) that are then distributed 254 to different org (sub)systems of the org platform 120 (e.g., different servers located in different geographic locations and/or different jurisdictions). In some implementations, different information objects can be generated for respective org (sub)systems, or a single information object can be generated and the org (sub)systems can determine the relevant tasks 253 that they need to execute within the single information object.

Additionally or alternatively, org contexts can have one or more assigned owners, who are responsible for signing off on requirements 251, and/or can delegate this role either within the ADPP 140 or an integrated workflow tool (e.g., email and/or the like).

Requirements 251 and tasks 253 (show many-to-many relationship). Because legal requirements are often at a level that is difficult to operationalize, the ADPP 140 model also includes the concept of operational tasks. To reduce duplication and overlap, operational tasks and requirements 251 can have a many-to-many relationship. Each requirement may require completion of several Tasks, and each Task can support meeting several requirements. For example, a Task such as “Create a data map” may support several requirements such as “produce an access report for an individual on request” and “delete an individual's data on request.”

Furthermore, because the tool is not intended to provide legal advice, the set of requirements suggested by the Adaptive Privacy model must be reviewed and approved by a legal representative prior to being made available to an org. Once this approval occurs, tasks to complete these requirements will be generated. These can then be assigned to individuals or teams for completion either within the Adaptive privacy tool or an integration with another technology solution.

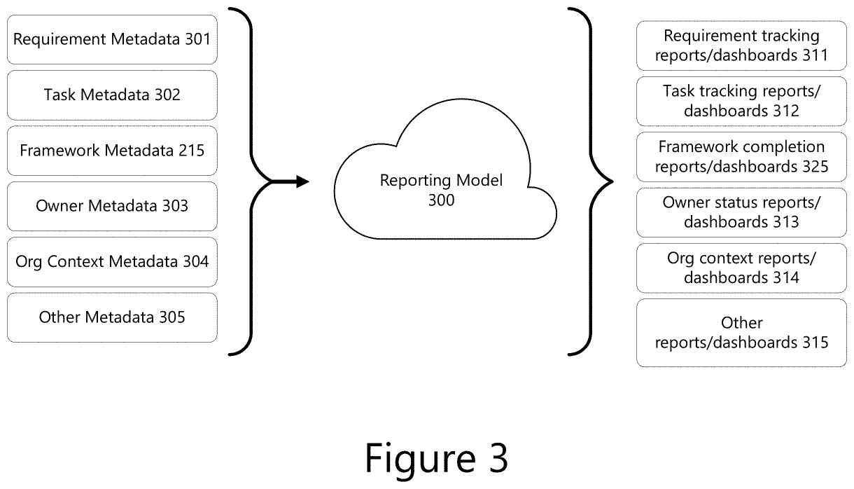

FIG. 3 illustrates an example of an ADPP reporting model 300, which may be used by the ADPP 140. The reporting model 300 is based on the defined terms 217 and metadata tags 210 described previously. In particular, the reporting model 300 may be fed with requirements metadata 301, task metadata 302, framework metadata 215, owner metadata 303, org context metadata 304, and other metadata 305 ingested via APIs, web services, and/or other methods. The requirements metadata 301 describes various requirements on how the org is to process collected data. In one example, the requirements metadata 301 includes reporting timeframes such as “respond to delete requests within <time frame>”, “provide notice before or at the time of the collection of personal data”, and the like) The requirements metadata 301 describes various tasks that may be related or relevant to individual requirements and/or actions to be performed for individual requirements (e.g., as described by the requirements metadata 301). For example, the task metadata 302 can include “Create ticketing queue for data subject rights requests”, “assign policy owners”, and the like. The framework metadata 215 describes various aspects of the PFs 211 such as, for example, “region or country”, “date enacted”, and the like. The owner metadata 303 describes various aspects of the owner of collected data such as, for example, “owner name”, “data owner was assigned”, and the like. The org context metadata 304 describes various aspects of the org 120 such as, for example, “country”, “types of personal data collected”, and the like. The other metadata 305 can include any other type of information/data and/or arbitrary information. The other metadata 305 can be anything a or org 120 user finds useful such as, for example, “requirement priority”, “assign to engineers not program managers”, and the like.

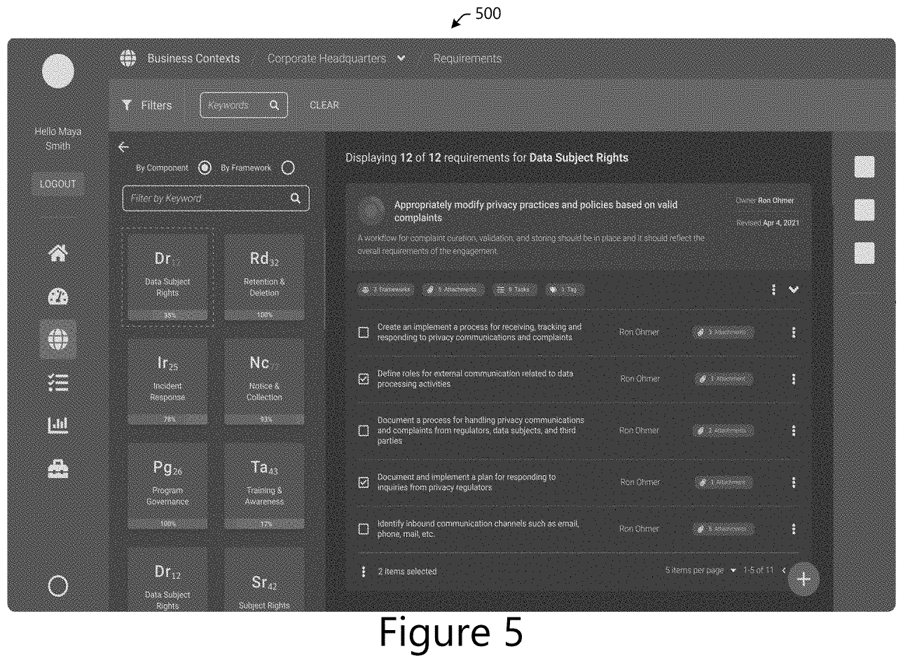

The ADPP reporting model 300 uses the various metadata 301, 302, 215, 303, 304, and 305 to produce various reports and/or dashboards including requirements tracking reports/dashboards 311, task tracking reports/dashboards 312, framework completion tracking reports/dashboards 325, owner status reports/dashboards 313, org context reports/dashboards 314, and other reports/dashboards 315. Examples of such dashboards are shown by FIGS. 5-19.

In one example, the ADPP 140 can report on status of a specific component (e.g., Training and Awareness) for a particular org context (e.g., any of org contexts 220, 225, 227 or the like), for a specific geography (e.g., “how are we doing with training in Brazil?”) or even for a requirement or task owner (e.g., “how is Joe doing with the training he is supposed to be delivering?”). A combination of standardized report formats with report-building functionality allows a user of the ADPP 140 to report on any dimension of their program that the tool is aware of. Furthermore, the ADPP reporting model 300 can report on any combination of metadata captured by the system or ingested by an API, web service, or other like mechanism. This allows answers to complex questions such as “how am I meeting my training requirements globally?” or “what is the aging of open task by owner?”

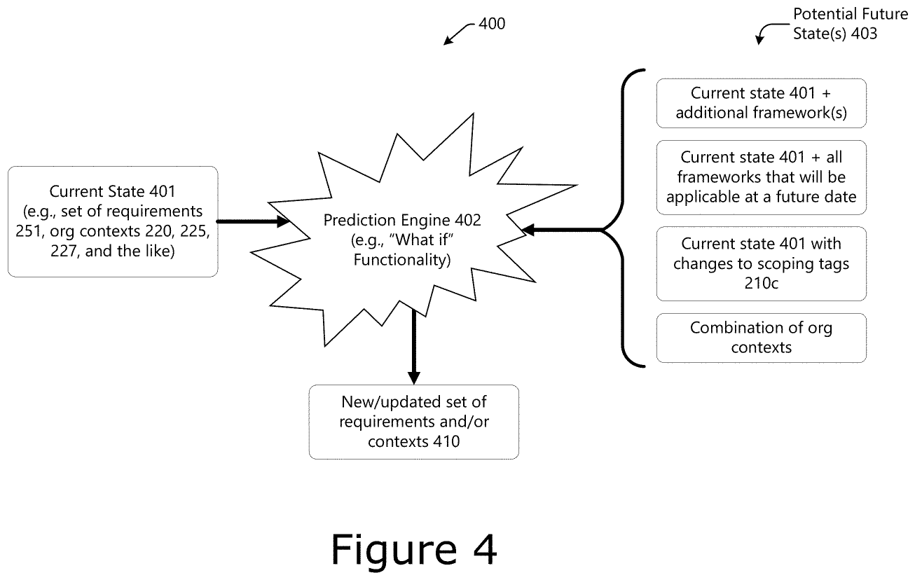

FIG. 4 shows an example architecture 400 demonstrating how the ADPP 140 is able to determine future scenarios. In FIG. 4, a current state 401 (e.g., the set of requirements 251, existing org context 220, 225, 227 and/or other parameters, conditions, variables, and the like) and potential future states 403 are provided to a prediction engine 402. The prediction engine 402 compares scoping tags 210c of the current state 401 (e.g., existing org context 220, 225, 227) with one or more potential future state(s) 403, and the prediction engine 402 generates outputs 410 including a new or updated contexts and/or a set of new or updated/changes requirements, variables, and values that shows the impact to the org's 120 privacy program.

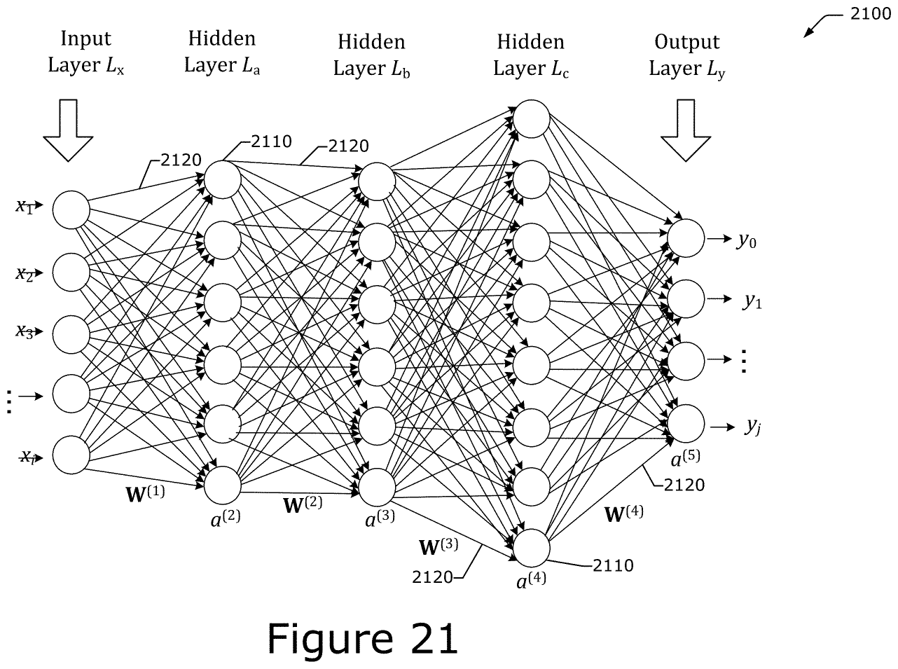

In some implementations, the prediction engine 402 is an inference engine, intelligent agent, AI/ML model or algorithm, or other software and/or hardware element that employs “what if” functionality to determine the potential (predicted) future states 403. Additionally or alternatively, the prediction engine 402 employs one or more machine learning (ML) and/or artificial intelligence (AI) techniques, such as the NN 2100 of FIG. 21 and/or any ML/AI technique discussed herein, to produce the potential (predicted) future states 403. Additionally or alternatively, the prediction engine 402 can employ suitable multiple optimization problems and/or multiple objective functions including evolutionary algorithms (EAs), multi-objective evolutionary algorithms (MOEAs), and/or the like.

The potential future states 403 can be predicted or otherwise determined based on the current state 401 and one or more additional framework 211a, 211b, the current state 401 and some or all frameworks that will be applicable at one or more future dates, the current state 401 with changes to scoping tags 210c (e.g., adding and/or deleting scoping tags 210c and/or aspects/elements of the scoping tags 210c), and/or a combination of two or more org contexts 220, 225, 227 (e.g., for mergers and acquisitions (M&A) planning and/or the like). In addition to creating a custom list of requirements that are applicable today, the ADPP 140 is also able to determine future scenarios (e.g., outputs 410) in several ways.

In a first example implementation, the ADPP 140 is able to determine future scenarios (e.g., outputs 410) by adding a “virtual applicability tag” to an existing org context 220, 225, 227. By adding a “virtual applicability tag”, the ADPP 140 can show the impact of a specific proposed privacy law or framework 211 and allow an org 120 to plan to meet new or amended requirements. The ADPP 140 can keep track of those requirements as being ones that are not yet required but are being worked towards (e.g., a new law is passed in Singapore that is included in an existing org context). By selecting a framework 211 from among a plurality of framework 211, which are not currently applicable, a user can determine how many new requirements they will need to meet, and where existing requirements may be expanded or changed. In one example implementation, a standard framework 211a can be selected from a drop-down list of frameworks. In another example implementation, a custom framework 211b can be added, updated, or otherwise defined by a user.

In a second example implementation, the ADPP 140 can show all of the frameworks 211 that will be applicable at a selected date. Because each framework (e.g., standard framework 211a or custom framework 211b) has effective date ranges assigned to it, by selecting a date in the future, the ADPP 140 can show all of the frameworks 211 that will be applicable at that date. This avoids the user having to be aware of all of the different frameworks 211 and significantly reduces the time and effort to perform research. Similar to the previous example, these “future requirements” can then be turned into a project plan and worked on so that they can be in place when the new frameworks come into effect.

In a third example implementation, the ADPP 140 can be used to show changes that will occur to a privacy program if the scope of an org context 220, 225, 227 changes, for example, by an org 120 expanding into a new jurisdiction. By creating a “virtual applicability tag”, the ADPP 140 can compare the current and future requirement set based on any combination of changes to one or more scoping tags 210c for an org context 220, 225, 227. For example, by adding Brazil as an applicable geography/jurisdiction, the impact of applicable Brazilian privacy laws can be displayed to the user. This functionality significantly reduces the privacy knowledge required to determine changes in various requirements, as the user just needs to understand how the org 120 (or data processing processes and procedures) will change, and the prediction engine 402 calculates the resulting impact(s).

In a fourth example implementation, the prediction engine 402 can use a suitable ML model to predict the future state(s) 403. In this example, parameters and/or data can of existing privacy programs (which may include known outcomes) can be used as training data to train the ML model. When a “virtual applicability tag” is created (as discussed in the previous examples), the prediction engine 402 predicts the potential future state(s) 403 based on existing practices and/or solving optimization functions, and a suitable requirements set and/or set of tasks can be generated based on the potential future state(s) 403.

As mentioned previously, the prediction engine 402 functionality compares scoping tags 210c of an existing org context 220, 225, 227 with one or more potential future state(s) 403, and the output 410 is new/updated contexts and/or a set of new/update requirements, variables, and values that shows the impact to the org's 120 privacy program. In one example, a requirement to deliver an access report in anew law may have different data elements to be included, or a different timeframe to deliver. This functionality can report against both external changes (e.g., new laws and/or requirements) and internal changes (e.g., new types of data being collected, or expanding into a new country with different privacy laws). In some implementations, the prediction engine 402 indicates how many requirements (e.g., response times, data types in scope, and so forth) are net new under the new/updated frameworks that are being considered (e.g., how many requirements and/or tasks are exactly the same and/or are already represented within the org's existing privacy program, and then how many already exist when you're within the org's existing privacy program but have updated attribute values). In some implementations, the outputs 410 can be arranged by framework (e.g., jurisdiction, legislative or regulatory regime, and/or the like) or by the functional area of a privacy program such as, for example, data subject rights, incident response, training and awareness, and so forth.

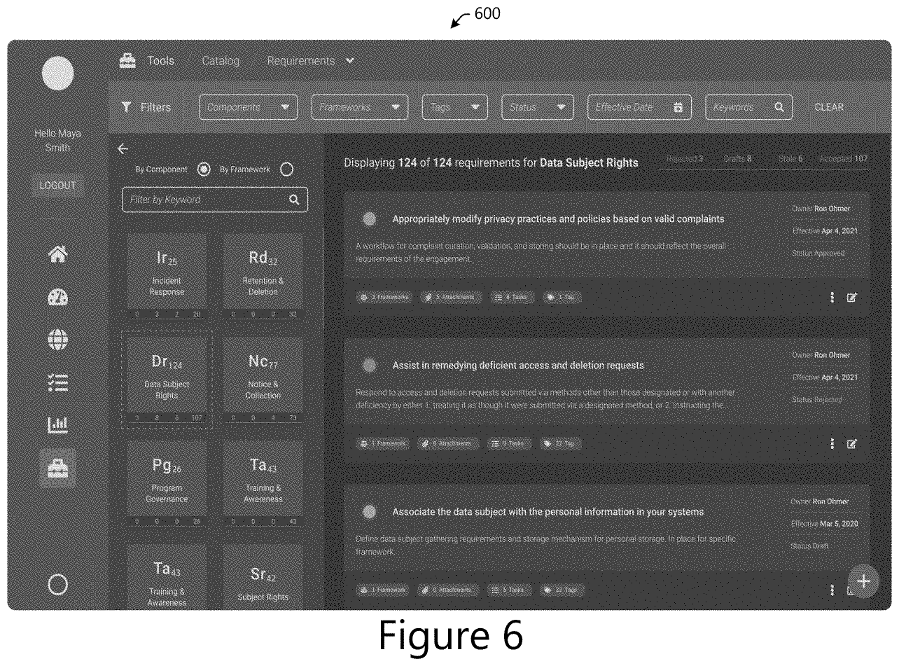

FIGS. 5-19 show various graphical user interfaces (GUIs) of an ADPP app 115 according to various embodiments. FIGS. 5 and 6 show difference views of requirements catalog GUI instances 500 and 600, respectively. The requirements catalog is a selectable list of laws and regulations from different jurisdictions that is updated over time. The requirements catalog in GUI instances 500 and 600 may correspond to the content catalog 240 of FIG. 2. For example, the requirements displayed via the GUI instances 500 and 600 may be based on data stored in the content catalogue 240. In some implementations, some fields or records in the content catalog 240 are not displayed via the GUI instances 500 and 600. The user of the ADPP app 115 can also add custom org requirements to the catalog that are specific to their org 120. The requirements in the catalog 240 allow the user to add specific tags to different org contexts.

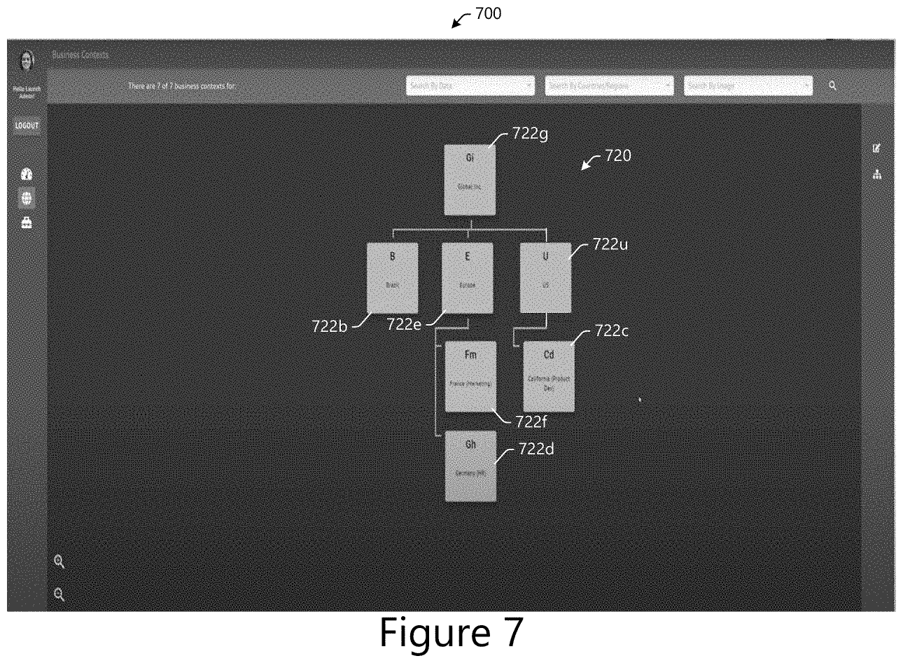

FIGS. 7-10 show example org modeler GUI instances 700-1000, respectively. The ADPP app 115 includes org modeler 255, which allows privacy program developers to build a privacy model of their org 120. The GUI instance 700 in FIG. 7 is an example client-side interface of the org modeler 255. The GUI instance 700 includes a privacy model 720 (or “org context tree 720”) that was built by a user of the ADPP app 115. The privacy model 720 is a graphical representation of the org context model 220 and/or global org context 225 of FIG. 2, which shows different parts of the org 120 (e.g., business units, subsidiaries, working groups, and/or the like). Each of these parts of the org 120 is referred to as an “org context” which may correspond to the org contexts 220, 225, and 227 in FIG. 2. Here, each box or rectangle graphical element 722 in the privacy model 720 represents a respective org context 220, 225, and/or 227 (also referred to as “org contexts 722”). In this example, the org model 720 includes a global org context 722g (corresponding to the global context model 225 in FIG. 2), which includes three child org contexts 722 (corresponding to the local org contexts 227 in FIG. 2) including a Brazil org context 722b, a Europe org context 722e, and a US org context 722u. Some child org contexts 722 can have their own child org contexts 722. For example, the Europe org context 722e includes two child org contexts 722 including a France marketing child org context 722f and a Germany human resources child org context 722d, and the US org context 722u includes one child org context 722 which is the California product development child org context 722c. By building org contexts 722, with variation between the org contexts 722, it allows an org to build a model 720 of the org's privacy organization and the way that the org handles data.

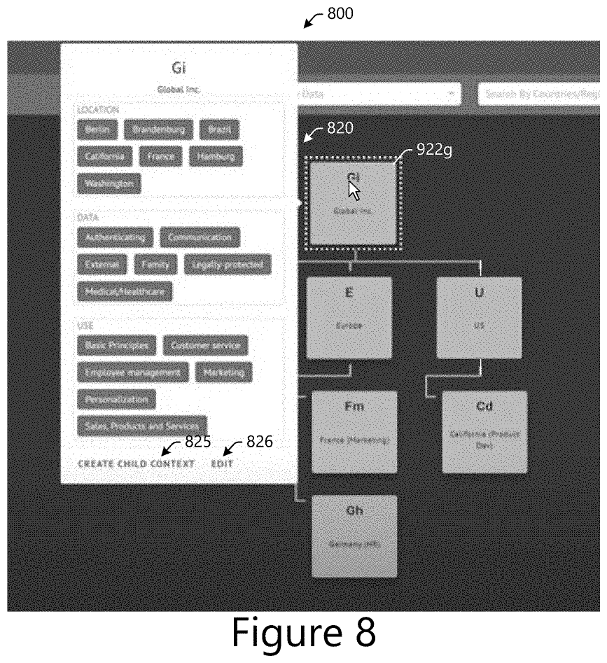

Hovering over an individual org context 722 allows a user to view different privacy properties, parameters, tasks, and/or other information via respective GUI elements (e.g., window/pop-up GUI elements 820, 920, and 1000 in FIGS. 8, 9, and 10, respectively). In other examples, other user interactions may cause these GUI elements to be displayed such as, for example, using tapping or other touch gestures for touchscreen interfaces (e.g., when the user device is a smartphone, tablet, or the like). In some implementations, each org context 722 is built from different tags 210 for different privacy categories. In these implementations, the privacy categories include “location” (e.g., geographic location or jurisdiction), “data”, and “uses”. The location category is included because some laws apply geographically or to a specific jurisdiction. For example, the CCPA and CPRA applies to residents of California, USA whereas the GDPR applies to the EU and potentially other jurisdictions. The data category is included because some laws apply to different types of data, for example, HIPAA applies to medical data and the CCPA and GDPR apply to personal information. The uses category is included because some laws apply to specific use cases, for example, CAN-SPAM in the US which applies to email marketing activities. There is variation between the individual org contexts 722, which allows an org to build a privacy model according to how the data is used and where it is used. Additional or alternative privacy categories can be used to create org contexts 722 in some implementations.

In a first example, which is shown by FIG. 8, the user hovers their pointer/cursor over the global org context 722g (represented by a dashed box/rectangle surrounding the org context 722g), which causes a window/pop-up GUI element 820 to be displayed as shown by GUI instance 800 in FIG. 8. In this example, GUI element 820 shows the global org context 722g which includes the following privacy categories: a location privacy category listing the jurisdictions in which the org operates including “Berlin”, “Brandenburg”, “Brazil”, “California”, “France”, “Hamburg”, and “Washington”; a data privacy category listing the types of data being processed or otherwise handled by the org including “Authenticating”, “Communication”, “External”, “Family”, “Legally-protected”, and “Medical/Healthcare”; and a uses privacy category listing the ways in which the data is used by the org (e.g., particular use cases) including “Basic Principles”, “Customer service”, “Employee management”, “Marketing”, “Personalization”, and “Sales, Products and Service”. The various privacy categories may be those corresponding to different child org contexts 722. The GUI element 820 also includes a graphical control element (GCE) 825 which, when selected, allows the user to create another child context 722, 227 of the global org context 722g. The newly created child context 722, 227 may be placed at the same level as the child contexts 722b, 722e, and 722u (e.g., “nation” level contexts). The GUI element 920 also includes a GCE 926 which, when selected, allows the user to edit the org context 722g such as by adding additional parameters to the privacy categories, removing existing parameters from the privacy categories, and/or adding/removing additional or alternative privacy categories.

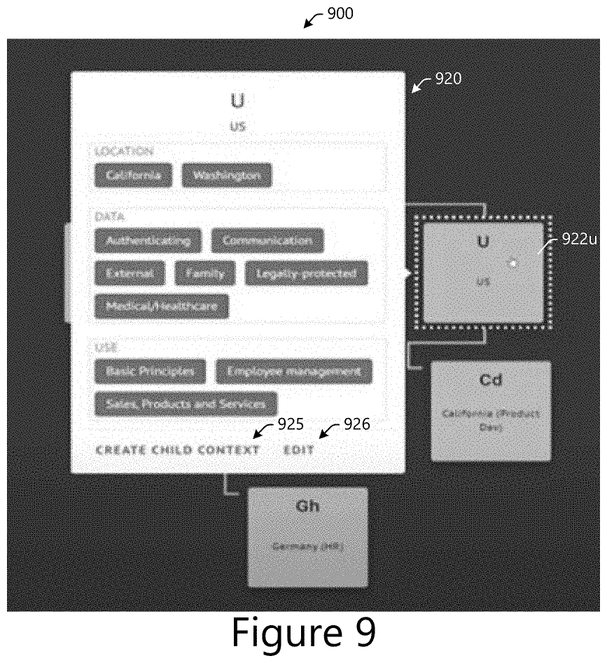

In a second example, which is shown by FIG. 9, the user hovers their pointer/cursor over org context 722u (represented by a dashed box/rectangle surrounding the org context 722u), which causes a window/pop-up GUI element 920 to be displayed as shown by GUI instance 900 in FIG. 9. In this example, GUI element 920 shows the US org context 722u which includes the following privacy categories: a location privacy category listing the States in which this org operates including California and Washington; a data privacy category listing the types of data being processed or otherwise handled including “Authenticating”, “Communication”, “External”, “Family”, “Legally-protected”, and “Medical/Healthcare”; and a uses privacy category listing the ways in which the data is used (e.g., particular use cases) including “Basic Principles”, “Employee management”, and “Sales, Products and Service”. The GUI element 920 also includes GCEs 925 and 926, which may operate in a same or similar manner as GCEs 825 and 826.

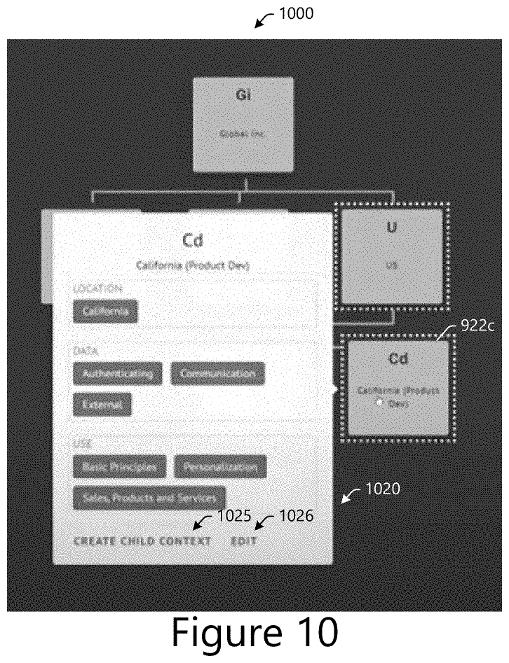

In a third example, which is shown by FIG. 10, the user hovers their pointer/cursor over org context 722c (represented by a dashed box/rectangle surrounding the org context 722c), which causes a window/pop-up GUI element 1020 to be displayed as shown by GUI instance 1000 in FIG. 10. In this example, GUI element 1020 shows the California product development org context 722c which includes the following privacy categories: a location privacy category listing the state of “California”; a data privacy category listing the types of data being processed or otherwise handled by this part of the org including “Authenticating”, “Communication”, and “External”; and a uses privacy category listing the ways in which the data is used (e.g., particular use cases) including “Basic Principles”, “Personalization”, and “Sales, Products and Service”. The GUI element 1020 also includes GCEs 1025 and 1026, which may operate in a same or similar manner as GCEs 925 and GCE 926.

In various embodiments, the various requirements are cascaded down from the global org context 220, 722g, which allows those requirements to be inherited down to more localized org contexts 227. For example, if a global program is set up that includes Brazil (e.g., org context 722b in FIG. 7) and not Argentina, then none of the children org contexts 722 are incorporated into Argentina without alerting the org platform 120. In this example, if a user tries to change or set up an org context for Argentina, the ADPP 140 will issue an alert to that person indicating that Argentina is not in the global context model 220, 720 (although adding such an org context may or may not actually be prohibited).

This feature also allows different privacy notices to be used in different ways. For example, if an org 120 has a first privacy notice for the US org context 722u and a second privacy notice for the EU org context 722e, the commonalities for all privacy notices can be implemented in the global org context 722g. For instance, various taxonomies that are common to all privacy notices are built into the global org context 722g, and then adapted for individual jurisdictions based on the different types of data and the different use cases that are input to the global model 720 and/or the ADPP 140. This allows orgs 120 easily to see the way that personal information is used throughout the org 120. In some implementations, various taxonomies can be pre-populated into the org modeler 255 and/or ADPP app 115.

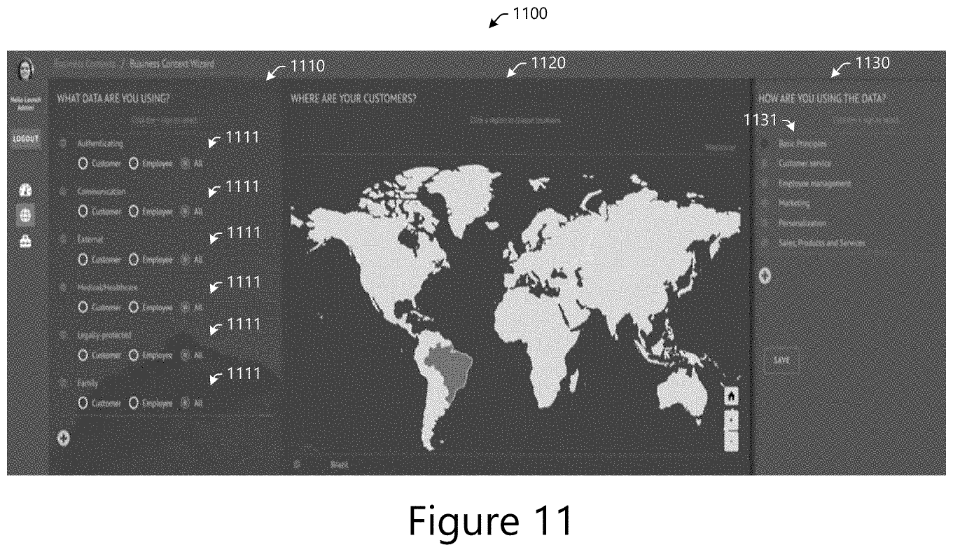

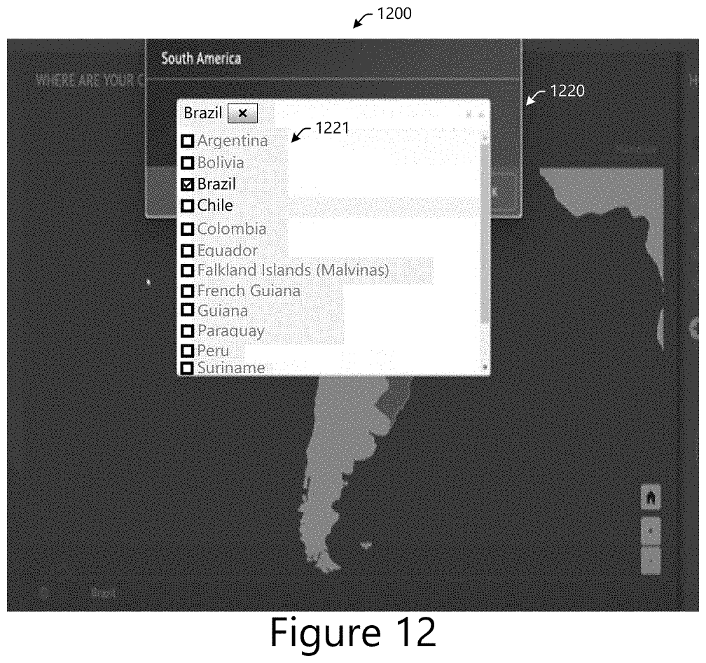

FIGS. 11-12 show an example of how an org context can be setup. FIG. 11 shows a GUI instance 1100 for editing an org context for “Brazil”, which may be accessed by selecting the Brazil org context 722b in the GUI instance 700 of FIG. 7.

The central section of GUI instance 1100 is a global map GUI 1120 showing the country of Brazil highlighted. FIG. 12 shows a GUI instance 1200 including a GUI element 1220 for adding a new or different jurisdiction to an org context 722. The GUI element 1220 includes various GCEs 1221 (e.g., check boxes) for adding individual jurisdictions to the org context 722. In this example, a user is attempting to add Argentina, which is greyed out because at the organizational level, the org 120 has specified that Argentina is not part of its global strategy. If the global strategy were to change, then the user can go back to the global org context 722g, and work out how adding Argentina to the global org context 722g would cascade down the privacy model 720. By contrast, the country Chile is not greyed out because at the organizational level, the org 120 has specified that Chile is part of its global strategy.

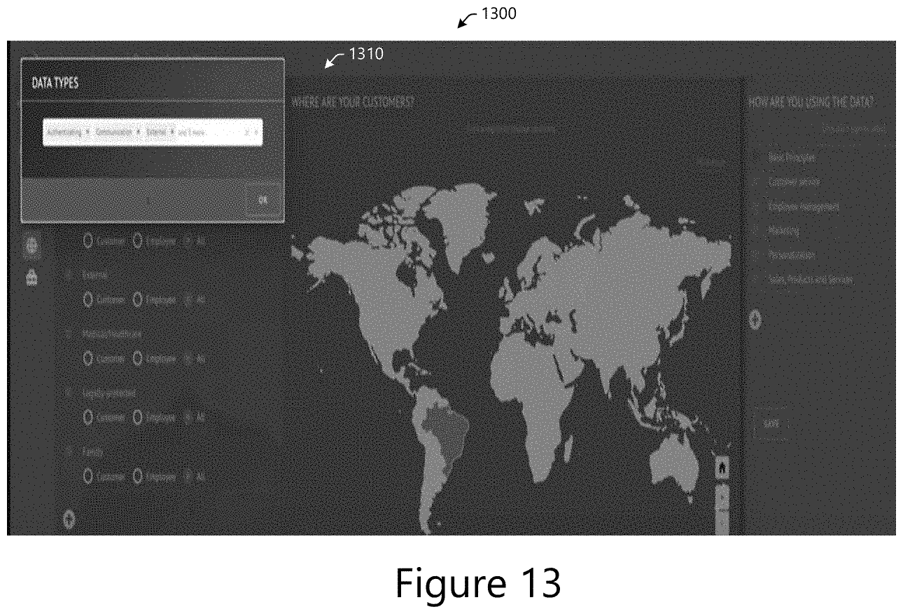

Referring back to FIG. 11, the left side portion of GUI instance 1100 is a data type selection GUI 1110 (labeled “what data are you using” in FIG. 11) including a taxonomy for the types of data to be defined for this org context 722. The taxonomy includes various GCEs 1111 (e.g., radio buttons) for selecting the types of data for this org context 722. FIG. 11 shows a curated set of data types that may be selected, and FIG. 13 shows a GUI instance 1300 including a GUI element 1310 for adding new or different data types to the org context 722, which allows the org 120 to adapt the org contact/org context 722 to meet their own specific requirements or policies they already have.

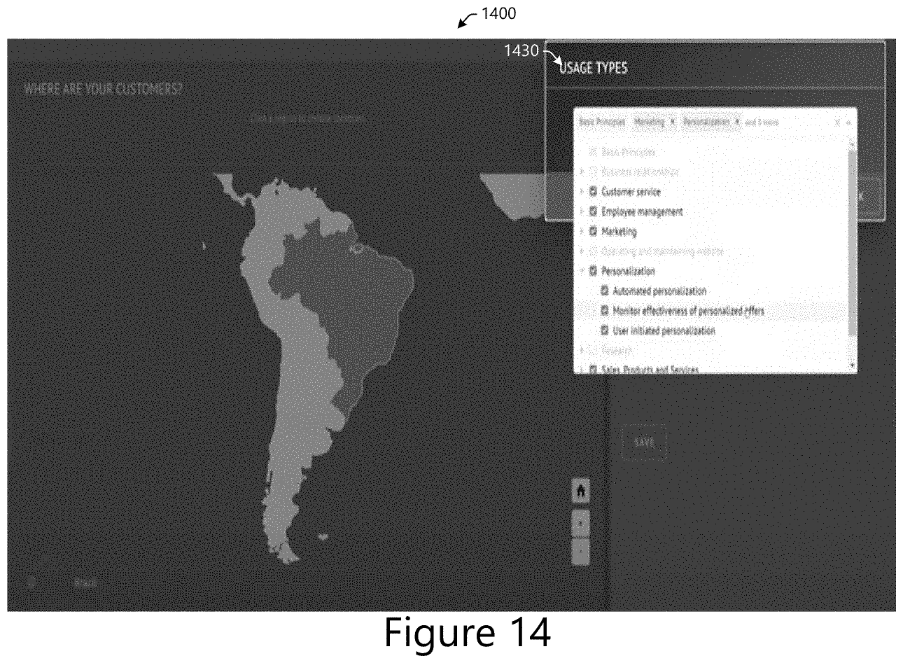

Referring back to FIG. 11, the right portion side portion of GUI instance 1100 is a data usage selection GUI 1130 (labeled “how are you using the data?”), which is used to specify how the data is being used in the global context 722g and/or local context 722b. The GUI 1130 includes various GCEs 1131 for selecting the data usage(s) for this org context 722. FIG. 14 shows a GUI instance 1400 including a GUI element 1430 for adding and/or removing different data usage taxonomies. In this example, the GUI element 1430 includes prepopulated taxonomies that have a number of different data uses. As can be seen in FIG. 14, all of the taxonomies are hierarchical. The user can also make changes to how the taxonomies are listed and arranged within the hierarchy to fit their particular org 120.

Furthermore, sometimes laws apply to differently to different types of data, for example depending on data class or data source. The GUI allows those different aspects to be selected and added to the org context as well. For example, an org context may be defined to treat employee privacy differently than customer privacy, and these treatment types can be captured by the ADPP 140. Additionally or alternatively, the ADPP 140 may have data processor/processing use cases pre-populated for org platforms 120 operating as data. This includes org relationships, which involves services to other orgs and some data processor requirements that may be applicable.

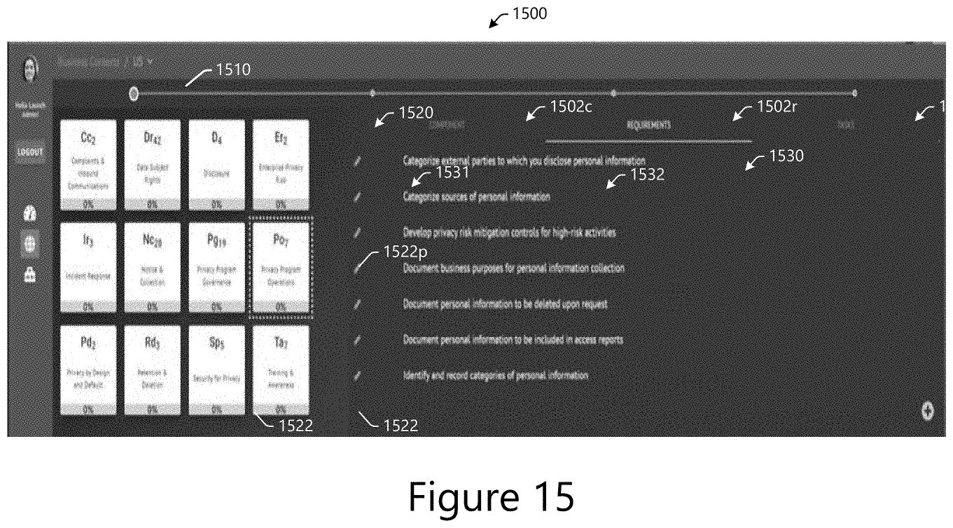

FIG. 15 includes component view GUI instance 1500, which includes a graphical representation 1520 of a components model of an org context 722 (also referred to as “components model 1520”). In this example, the components model 1520 includes graphical objects 1522 representing respective context components (also referred to as “components 1522” or the like). In this example, the components model 1520 includes twelve (12) prepopulated components 1522 that most orgs 120 have to accomplish for most privacy regulatory compliance (note that not all components 1522 are labeled in FIG. 15 for the sake of clarity). The user can also add or remove various components 1522 to/from the components model 1520. The ADPP 140 maps an org's 120 privacy framework (PF) or model to at least one of the components 1522. Additionally or alternatively, the ADPP 140 adds or otherwise includes at least one component 1522 to each org context 722.

Each component 1522 includes an abbreviation of a description of the component, and the description itself (e.g., component 1522p includes the abbreviation “Po₇” and the description “Privacy Program Operations”). Additionally, each component 1522 includes a status/progress indicator at the bottom portion of the component 1522 indicating the amount of progress that has been made towards completing the tasks and/or requirements of the component 1522 (e.g., component 1522p includes a status/progress indicator of “0%” indicating that no tasks/requirements have been completed for this component 1522p).

The component view GUI instance 1500 also includes various tab GCEs 1502 (or “tabs 1502”) for viewing different properties of individual components 1522. In this example, the tabs 1502 include a component tab 1502c, a requirements tab 1502r, and a tasks tab 1502t. The example of FIG. 15 shows the requirements tab 1502r being selected. The requirements tab 1502r includes a list of org requirements 1530 that need to be completed for a selected component 1522p in the components model 1520 (represented by a dashed box/rectangle surrounding the component 1522p). The user can select a GCE 1531 to edit a corresponding requirement 1532 in the list of requirements 1530 (note that not all GCEs 1531 and graphical elements 1532 are labeled in FIG. 15 for the sake of clarity). The requirements section/tab 1502r shows traceability back to where the requirements came from, such as by allowing the user to look up the exact text of the relevant law, and gives the org 120 the flexibility in the reporting that allows the user to track status against a particular framework. The requirements section/tab 1502r also indicates the requirements in a way that laymen can understand. The component view GUI instance 1500 also includes a GCE 1510 (e.g., a slider or the like), which allows the user to view how different external requirements may affect the privacy program over time. In this example, the user can slide the slider 1510 forwards (to the right) or backwards (to the left) in time to see how any changed requirements affect the different listed requirements 1532. The user can also add or remove different data types to be collected or different data uses to see how the changes in the requirements 1532 may change.

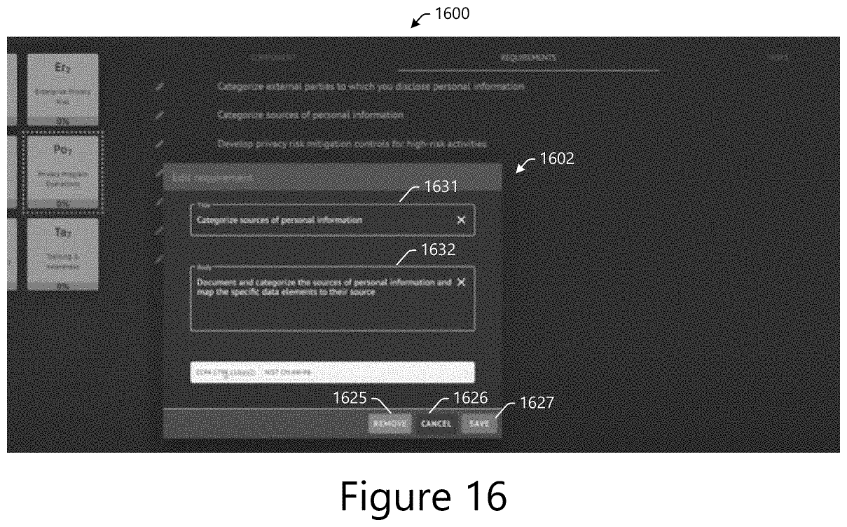

FIG. 16 shows GUI instance 1600, which is displayed after the GCE 1531 in FIG. 15 is selected. In this example, the selected GCE 1531 corresponds to a requirement 1532 titled “Categorize sources of personal information”. GUI instance 1600 includes a GUI, window/pop-up GUI element 1602 for editing requirement 1532. The GUI element 1602 includes a title GCE 1631 (e.g., a text box) which allows the user to edit the title of the requirement 1532 by entering desired text, and a body GCE 1632 (e.g., a text box) which allows the user to edit the body section of the requirement 1532 by entering desired text. Selecting GCE 1525 may remove the existing text from the GCEs 1631 and 1632, selecting GCE 1526 may close the GUI element 1602 without saving any of the changes (if any), and selecting GCE 1527 may close the GUI element 1602 and save (submit) any of changes that may have been made.

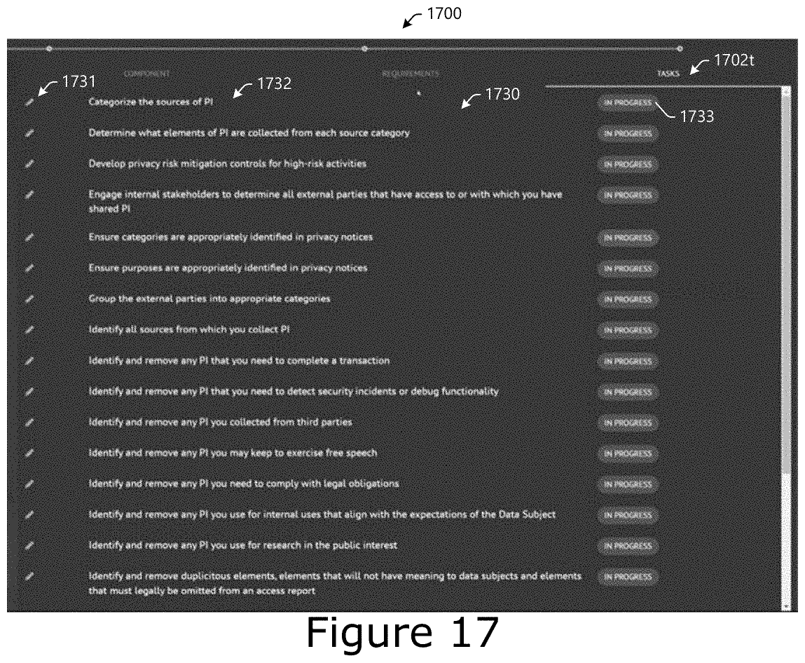

FIG. 17 shows a task view GUI instance 1700 that is accessed from the GUI instance 1500 of FIG. 15 by selecting the tasks tab 1502t. The task view GUI instance 1700 shows various tasks 1732 in a set of tasks 1730 that are derived from an individual requirement 1532 shown in the requirements view/tab 1502r. Similar to the requirements view/tab 1502r, each task in the set of tasks 1730 includes a corresponding GCE 1731, which when selected, allows the user to edit the corresponding task 1732. The interface for editing a task 1732 may be similar to the GUI instance 1600 for editing an individual requirement 1532. Additionally, each task 1732 includes a corresponding status/progress graphical element 1733, which indicates the status/progress of the corresponding task 1732. Various types of indicators can be used for the graphical element 1733 including, for example, “in progress” (as shown by FIG. 17), “completed”, “not started”, and so forth. Additionally or alternatively, a percentage can be used to show how far along or how close a task 1732 is from being completed.

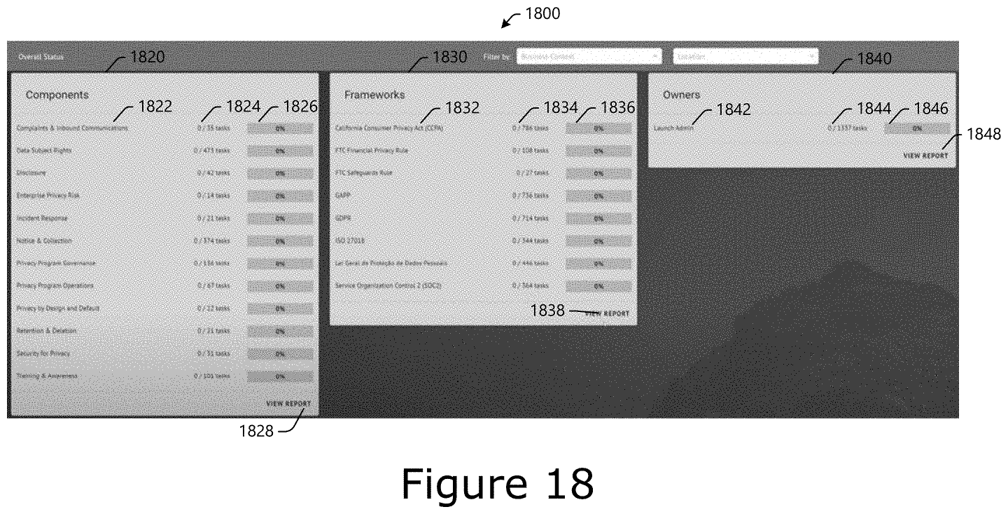

One drawback of existing privacy regulation compliance tools/platforms is that these tools only provide requirements to their users. However, the requirements alone are not enough for the practical application and/or implementation of various privacy regulations. By contrast, the ADPP 140 drills down to the next level as to how to practically implement new or updated privacy-related notices and procedures locally and worldwide. In particular, he ADPP 140 breaks down each of the requirements 1532 into a set of tasks 1730 that includes the specific tasks 1732 that go through a requirement 1532. Here, the user can track the progress of an individual component 1522 at an individual task 1732 level based on the status/progress graphical element 1733, where the tasks 1730, 1732 roll up to corresponding requirements 1532, that then roll up to corresponding components 1522. This is then reflected in the ADPP dashboard module shown by FIG. 18.

FIG. 18 shows an example GUI instance 1800 of an ADPP dashboard module (also referred to as “ADPP dashboard 1800” or the like). The ADPP dashboard 1800 shows an overall status of various components 1822 in a components dialog GUI element 1820, various frameworks 1832 in a frameworks dialog GUI element 1830, and owners 1842 in an owners dialog GUI element 1840 for the example privacy program discussed previously with respect to FIGS. 7-17 (note that not all components 1822 and frameworks 1832 are labeled in FIG. 18 for the sake of clarity).

The components dialog 1820 lists the various components 1822 including “Complaints & Inbound Communications”, “Data Subject Rights”, “Disclosure”, “Enterprise Privacy Risk”, Incident Response”, “Notice & Collection”, “Privacy Program Governance”, “Privacy Program Operations”, “Privacy by Design and Default”, “Retention & Deletion”, “Security for Privacy”, and “Training & Awareness”. The components dialog 1820 also includes a status ratio GUI element 1824 and a status bar GUI element 1826. The status ratio GUI element 1824 shows a ration of completed tasks to the total number of tasks for the component 1822, and the status bar GUI element 1826 shows a percentage towards completed all tasks for the component 1822. The user can track the progress of an individual component 1822 per task based on the status ratio GUI element 1824 and/or the status/progress graphical element 1826.

The frameworks dialog 1830 lists the various frameworks 1832 for this example privacy program including “California Consumer Privacy Act (CCPA)”, “FTC Financial Privacy Rule”, “FTC Safegurards Rule”, “GAPP”, “GDPR”, “ISO 27018”, “Lei Geral De Proteção De Dados Pessoais” (e.g., the General Personal Data Protection Law 13709/2018 in the Federative Republic of Brazil), and “Service Organization Control (SOC2)”. The frameworks dialog 1830 also includes a status ratio GUI element 1834 and a status bar GUI element 1836, which show the number of completed tasks for each framework 1832 in a same or similar manner as the graphical elements 1824 and 1826. The owners dialog 1840 lists various owners 1842, which in this example is only the “Launch Admin”. The owners dialog 1840 also includes a status ratio GUI element 1844 and a status bar GUI element 1846, which show the number of completed tasks for each owner 1842 in a same or similar manner as the graphical elements 1824, 1826, 1834, and 1836. The ADPP dashboard 1800 allows the user to “pivot and track” the status of their privacy program in different ways, either at the task level, which may be useful in some circumstances or the requirement level.

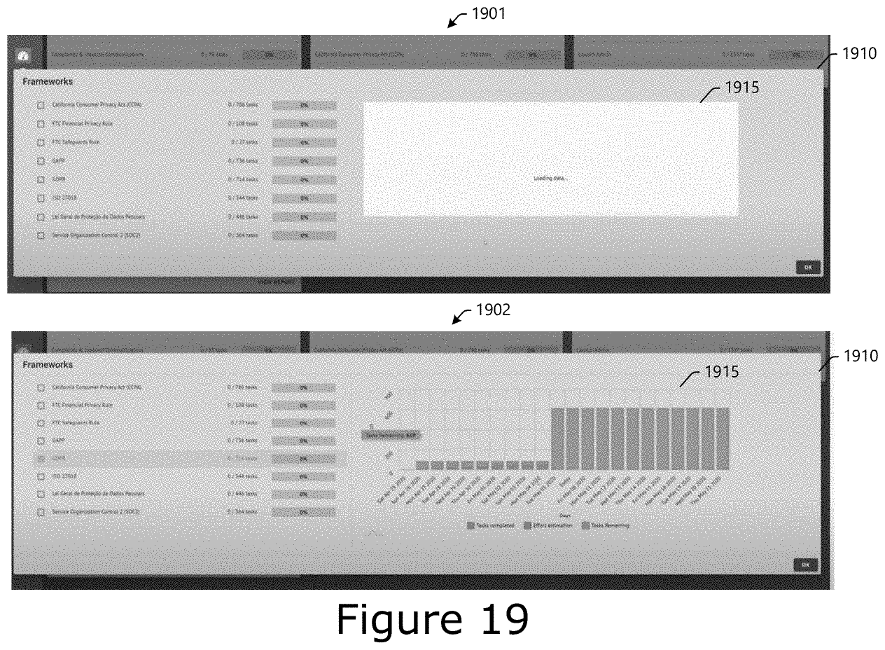

Each of the dialogs 1820, 1830, and 1840 each includes respective “view report” GCEs 1828, 1838, and 1848. The GCEs 1828, 1838, and 1848 allows the user to track the status of the component, framework, and/or owner aspects over time as is shown by GUI instances 1901 and 1902 of FIG. 19.

GUI instance 1901 shows a GUI element (e.g., window) 1910, which may be produced as a result of the user selecting and/or activating the framework “view report” GCEs 1838 in FIG. 18. The GUI element 1910 includes the framework GUI elements 1832, 1834, 1836 discussed previously (not labeled in FIG. 19) and graph GUI element 1915. The graph GUI element 1915 is a region of the GUI element 1910 that is to display a graphical representation of the frameworks 1832 over time. Here, the graph GUI element 1915 shows a “loading data . . . ” indicator indicating that the framework information for this privacy program is being retrieved from the ADPP DB 150. GUI instance 1902 shows the GUI element (e.g., window) 1910 with the graph GUI element 1915 including the relevant data for the selected framework “GDPR”. Here, the graph GUI element 1915 shows an amount of tasks remaining to be completed for different time periods.

As alluded to previously, pivoting and tracking can also be broken down by data type over time and/or with respect to upcoming deadlines. Furthermore, the ADPP app 115 allows the user to assign metadata in the org context level. For example, a first user may be assigned as the owner of the org's 120 US privacy team and operations, and a second user may be assigned as the owner over of the org's 120 European privacy team and operations. The ADPP 140 then tracks each owners' tasks against each other owners' tasks. Moreover, the ADPP app 115 allows the user to add in other things such as attaching different privacy notices, and the ADPP 140 can track some of those documents and attach them to where they need to be used. In the org context, this can be particularly useful for tasks such as BCRs where an org may need to know which of the org's 120 legal entities have signed up.

Additionally or alternatively, the ADPP app 115 allows the user to add additional frameworks based on pre-existing privacy policies, BCRs, ESGs, MSAs, SLAs, SLOs, SLEs, and/or the like. A privacy policy, BCR, ESG, MSA, SLA, SLO, SLE and the like, can be uploaded to the ADPP 140 and any of the controls that are associated with it are added and/or converted into a PF. Additionally, or alternatively, standards or policies can be added and converted in PFs. For example, [NISTPF] and [ISO/IEC 27018], although not a legal requirement, can be added by an org platform 120 that operates as a cloud service provider based on subscriber demand.

### 2. EXAMPLE HARDWARE AND SOFTWARE SYSTEMS AND CONFIGURATIONS

Referring back to FIG. 1, the user systems 105 (also referred to as a “client device,” “user device,” or the like) include physical hardware devices and software components capable of accessing content and/or services provided by the org platforms 120 and/or ADPP 140.

The user system 105 can be implemented as any suitable computing system or other data processing apparatus usable by users to access content/services provided by the org platform 120 and ADPP 140. In order to access the content/services, the user system 105 includes components such as processors, memory devices, communication interfaces, and the like. Additionally, the user system 105 may include, or be communicatively coupled with, one or more sensors (e.g., image capture device(s), microphones, and the like), which is/are used to capture other types of data, such as biometric data. The user system 105 may include a touch-based user interface (UI), such as a touchscreen, touchpad, motion-capture interface, and/or the like. The user systems 105 can be implemented as any suitable computing system/device or other data processing apparatus usable by users to access content/services provided by the ADPP 140. Examples of such computing systems/devices may include cellular phones or smartphones, tablet computers, portable media players, wearable devices (e.g., smart watches), desktop/personal computers (PCs), 2-in-1 PCs, 2-in-1 tablets, all-in-one desktop computers, workstations, laptops, in-vehicle systems, and/or some other computing systems/devices.

The user system 105 communicates with systems 120 and 140 to obtain content/services using, for example, HTTP over TCP/IP and/or any other communication protocols/layers such as any of those discussed herein, or combinations thereof. In this regard, the user system 105 may establish a communication session with the ADPP 140. As used herein, a “session” refers to a persistent interaction between a subscriber (e.g., user system 105) and an endpoint that may be either a relying party (RP) such as a web server, app server, a Credential Service Provider (CSP), and/or ADPP 140. A session begins with an authentication event and ends with a session termination event. A session is bound by use of a session secret (e.g., a password, digital certificate, and the like) that the subscriber's software (e.g., a browser, app, or OS) can present to the RP or CSP in lieu of the subscriber's authentication credentials. A “session secret” refers to a secret used in authentication that is known to a subscriber and a verifier.

In order to provide content and/or services to the user system 105, the org platforms 120 and ADPP 140 may operate web servers and/or app servers. The web server(s) serve static content from a file system of the web server(s), and may generate and serve dynamic content (e.g., server-side programming, database connections, dynamic generation of web documents) using an appropriate plug-in or the like. The application server(s) implement an application platform, which is a framework that provides for the development and execution of server-side applications as part of an application hosting service. The application platform enables the creation, management, and execution of one or more server-side applications developed by the org platforms 120 and/or third party application developers, which allow users and/or third party application developers to access the org 120 via respective user systems 105. The user system 105 may operate the app 110 to access the dynamic content, for example, by sending appropriate HTTP messages or the like, and in response, the server-side application(s) may dynamically generate and provide the code, scripts, markup documents, and the like, to the app 110 to render and display objects 115 within the app 110. A collection of some or all of the objects 115 may be a webpage or application (app) comprising a graphical user interface (GUI) including graphical control elements (GCEs) for accessing and/or interacting with the org 120. This collection of objects 115 may be referred to as “webpage 115,” “app 115,” or the like. The server-side applications may be developed with any suitable server-side programming languages or technologies, such as PHP; Java™ based technologies such as Java Servlets, JavaServer Pages (JSP), JavaServer Faces (JSF), and the like; ASP.NET; Ruby or Ruby on Rails; Kotlin; and/or any other like technology such as those discussed herein. The applications may be built using a platform-specific and/or proprietary development tool and/or programming languages.

In some examples, the ADPP 140 may represent a cloud computing service, an intranet, enterprise network, or some other like private network that is unavailable to the public. In one example implementation, the entirety of ADPP 140 including both the front end and the back end may be implemented in or by a cloud computing service (e.g., a “full stack” cloud implementation). The cloud computing service (or “cloud”) includes networks of physical and/or virtual computer systems (e.g., one or more servers), data storage systems/devices, and the like within or associated with a data center or data warehouse that provide access to a pool of computing resources. The one or more servers in a cloud include user computer systems, where each of the servers include one or more processors, one or more memory devices, input/output (I/O) interfaces, communications interfaces, and/or other like components. The servers may be connected with one another via a Local Area Network (LAN), fast LAN, message passing interface (MPI) implementations, and/or any other suitable networking technology. Various combinations of the servers may implement different cloud elements or nodes, such as cloud manager(s), cluster manager(s), master node(s), one or more secondary (slave) nodes, and the like. The one or more servers may implement additional or alternative nodes/elements in other embodiments. In some cloud implementations, at least some of the servers in the cloud (e.g., servers that act as secondary nodes) may implement app server and/or web server functionality, which includes, inter alia, obtaining various messages from the user systems 105; processing data contained in those messages; routing data to other nodes in the cloud for further processing, storage, retrieval, and the like; generating and communicating messages including data items, content items, program code, renderable webpages and/or documents (e.g., including the various GUIs discussed herein), and/or other information to/from user systems 105; and/or other like app server functions. In this way, various combinations of the servers may implement different cloud elements/nodes configured to perform the embodiments discussed herein

The servers 145 comprise one or more physical and/or virtualized systems for providing content and/or functionality (e.g., services) to one or more clients (e.g., user system 105) over a network. The physical and/or virtualized systems include one or more logically or physically connected servers and/or data storage devices distributed locally or across one or more geographic locations. Generally, the web/app servers 145 a are configured to use IP/network resources to provide web pages, forms, apps, data, services, and/or media content to user system 105, generate and serve dynamic content (e.g., server-side programming, database connections, dynamic generation of web documents) using an appropriate plug-in (e.g., a ASP.NET plug-in). The app server(s) implement an app platform, which is a framework that provides for the development and execution of server-side apps as part of an app hosting service. The app platform enables the creation, management, and execution of one or more server-side apps developed by the ADPP 140 and/or third-party app developers, which allow users and/or third-party app developers to access the ADPP 140 via respective user systems 105. The user systems 105 may operate respective client apps to access the dynamic content, for example, by sending appropriate HTTP messages or the like, and in response, the server-side app(s) may dynamically generate and provide source code documents to the client app, and the source code documents are used for generating and rendering graphical objects (or simply “objects”) within the client app. The server-side apps may be developed with any suitable server-side programming languages or technologies, such as PHP; Java™ based technologies such as Java Servlets, JavaServer Pages (JSP), JavaServer Faces (JSF), and the like; ASP.NET; Ruby or Ruby on Rails; and/or any other like technology that renders HyperText Markup Language (HTML), such as those discussed herein. The apps may be built using a platform-specific and/or proprietary development tool, and/or programming languages.

The ADPP servers 145 serve one or more instructions or source code documents to user systems 105, which may then be executed within a client app 110 to render one or more objects (e.g., graphical user interfaces (GUIs)). The GUIs comprise graphical control elements (GCEs) that allow the user systems 105 to perform various functions and/or to request or instruct the ADPP 140 to perform various functions. The ADPP servers 145 may provide various interfaces such as those discussed herein. The interfaces may be developed using website development tools and/or programming languages (e.g., HTML, Cascading Stylesheets (CSS), JavaScript, Jscript, Ruby, Python, and the like) and/or using platform-specific development tools (e.g., Android® Studio™ integrated development environment (IDE), Microsoft® Visual Studio® IDE, Apple® iOS® software development kit (SDK), Nvidia® Compute Unified Device Architecture (CUDA)® Toolkit, and the like). The term “platform-specific” may refer to the platform implemented by the user systems 105 and/or the platform implemented by the ADPP servers 145. Example interfaces are shown and described with regard to FIGS. 1-19. In an example implementation, the servers 145 may implement Apache HTTP Server (“httpd”) web servers or NGINX™ webservers on top of the Linux® OS. In this example implementation, PHP and/or Python may be employed as server-side languages, MySQL may be used as the DQL/DBMS. In an example implementation, the mobile apps may be developed for Android®, iOS®, and/or some other mobile platform.

In some embodiments, the one or more ADPP servers 145 may implement or operate user artificial intelligence (AI) agents to perform respective identity verification services of the identity verification services discussed previously, or portions thereof. The AI agents are autonomous entities configured to observe environmental conditions and determine actions to be taken in furtherance of a particular goal and based on learnt experience (e.g., empirical data). The particular environmental conditions to be observed, the actions to be taken, and the particular goals to be achieved may be based on an operational design domain (ODD) and/or may be specific or based on the subsystem itself Δn ODD includes the operating conditions under which a given AI agent, or feature thereof, is specifically designed to function. An ODD may include operational restrictions, such as environmental, geographical, and time-of-day restrictions, and/or the requisite presence or absence of certain conditions or characteristics.

To observe environmental conditions, the AI agents is/are configured to receive, or monitor for, collected data from user systems 105, ADPP servers 145, ADPP 140, and/or other sources. The act of monitoring may include, for example, polling (e.g., periodic polling, sequential (roll call) polling, and the like) user systems 105 and/or other ADPP servers 145 for identity/biometric data for a specified/selected period of time. In other embodiments, monitoring may include sending a request or command for identity/biometric data in response to an external request for identity/biometric data. In some embodiments, monitoring may include waiting for identity/biometric data from various user systems 105 based on triggers or events. The events/triggers may be AI agent specific and may vary depending on a particular embodiment. In some embodiments, the monitoring may be triggered or activated by an app or subsystem of the ADPP 140 and/or by a remote device, such as or server(s) 145 of ADPP 140.

To determine actions to be taken in furtherance of a particular goal, each of the AI agents are configured to identify a current state (context) of a live interview session or instance and/or the AI agent itself, identify or obtain one or more models (e.g., the various models discussed previously with respect to the example identity verification services), identify or obtain goal information, and predict a result of taking one or more actions based on the current state (context), the one or more models, and the goal information. The one or more models may be any algorithms or objects created after an AI agent is trained with one or more training datasets, and the one or more models may indicate the possible actions that may be taken based on the current state (context). The one or more models may be based on the ODD defined for a particular AI agent. The current state (context) is a configuration or set of information collected by the ADPP 140 and/or one or more ADPP servers 145. The current state (context) is stored inside an AI agent and is maintained in a suitable data structure. The AI agents are configured to predict possible outcomes as a result of taking certain actions defined by the models.

The goal information describes outcomes (or goal states) that are desirable given the current state (context). Each of the AI agents may select an outcome from among the predicted possible outcomes that reaches a particular goal state, and provide signals or commands to various other subsystems of the ADPP 140 to perform one or more actions determined to lead to the selected outcome. In addition, the AI agents may also include a learning module configured to learn from an experience with respect to the selected outcome and some performance measure(s). The experience may include state (context) data collected after performance of the one or more actions of the selected outcome. The learned experience may be used to produce new or updated models for determining future actions to take.

The AI agent(s) is/are implemented as autonomous software agents, implemented using user hardware elements, or a combination thereof. In an example software-based implementation, the AI agents may be developed using a suitable programming language, development tools/environments, and the like, which are executed by one or more processors of one or more ADPP servers 145. In this example, program code of the AI agents may be executed by a single processor or by user processing devices. In an example hardware-based implementation, each AI agent may be implemented in a respective hardware accelerator (e.g., FPGA, ASIC, DSP, and the like) that are configured with appropriate bit stream(s) or logic blocks to perform their respective functions. The aforementioned processor(s) and/or hardware accelerators may be specifically tailored for operating AI agents and/or for ML functionality, such as computer vision (CV) and/or deep learning (DL) accelerators, a cluster of AI GPUs, tensor processing units (TPUs) developed by Google® Inc., Real AI Processors (RAPs™) provided by AlphalCs®, Nervana™ Neural Network Processors (NNPs) provided by Intel® Corp., Intel® Movidius™ Myriad™ X Vision Processing Unit (VPU), NVIDIA® PX™ based GPUs, the NM500 chip provided by General Vision®, Hardware 3 provided by Tesla®, Inc., an Epiphany™ based processor provided by Adapteva®, or the like. In some embodiments, the hardware accelerator may be implemented as an AI accelerating co-processor, such as the Hexagon 685 DSP provided by Qualcomm®, the PowerVR 2NX Neural Net Accelerator (NNA) provided by Imagination Technologies Limited®, the Neural Engine core within the Apple® A11 or A12 Bionic SoC, the Neural Processing Unit within the HiSilicon Kirin 970 provided by Huawei®, and/or the like.

Furthermore, one or more ADPP servers 145 may hash, digitally sign, and/or encrypt/decrypt data using, for example, a cryptographic hash algorithm, such as a function in the Secure Hash Algorithm (SHA) 2 set of cryptographic hash algorithms (e.g., SHA-226, SHA-256, SHA-512, and the like), SHA 3, and so forth, or any type of keyed or unkeyed cryptographic hash function and/or any other function discussed herein; an elliptic curve cryptographic (ECC) algorithm, Elliptic Curve cryptography Digital Signature Algorithm (ECDSA), Rivest-Shamir-Adleman (RSA) cryptography, Merkle signature scheme, advanced encryption system (AES) algorithm, a triple data encryption algorithm (3DES), and/or the like.

The ADPP DB 150 may be stored in or by one or more data storage devices or storage systems that act as a repository for persistently storing and managing collections of data according to one or more predefined DB structures. The data storage devices/systems may include one or more primary storage devices, secondary storage devices, tertiary storage devices, non-linear storage devices, and/or other like data storage devices. In some implementations, at least some of the ADPP servers 145 may implement a suitable database management system (DBMS) to execute storage and retrieval of information against various database object(s) in the ADPP DB 150. These ADPP servers 145 may be storage servers, file servers, or other like computing systems. The DBMS may include a relational database management system (RDBMS), an object database management system (ODBMS), a non-relational DBMS (e.g., a NoSQL DB system), and/or some other DBMS used to create and maintain the ADPP DB 150. The ADPP DB 150 can be implemented as part of a single database, a distributed database, a collection of distributed databases, a database with redundant online or offline backups or other redundancies, and the like, and can include a distributed database or storage network. These ADPP server(s) 145 may implement one or more query engines that utilize one or more data query languages (DQLs) to store and retrieve information in/from the ADPP DB 150, such as Structured Query Language (SQL), Structured Object Query Language (SOQL), Procedural Language/SOQL (PL/SOQL), GraphQL, Hyper Text SQL (HTSQL), Query By Example (QBE), object query language (OQL), object constraint language (OCL), non-first normal form query language (N1QL), XQuery, and/or any other DQL or combinations thereof. The query engine(s) may include any suitable query engine technology or combinations thereof including, for example, direct (e.g., SQL) execution engines (e.g., Presto SQL query engine, MySQL engine, SOQL execution engine, Apache® Phoenix® engine, and the like), a key-value datastore or NoSQL DB engines (e.g., DynamoDB® provided by Amazon.com®, MongoDB query framework provided by MongoDB Apache® Cassandra, Redis™ provided by Redis Labs®, and the like), MapReduce query engines (e.g., Apache® Hive™, Apache® Impala™ Apache® HAWQ™, IBM® Db2 Big SQL®, and the like for Apache® Hadoop® DB systems, and the like), relational DB (or “NewSQL”) engines (e.g., InnoDB™ or MySQL Cluster™ developed by Oracle®, MyRocks™ developed by Facebook.com®, FaunaDB provided by Fauna Inc.), PostgreSQL DB engines (e.g., MicroKernel DB Engine and Relational DB Engine provided by Pervasive Software®), graph processing engines (e.g., GraphX of an Apache® Spark® engine, an Apache® Tez engine, Neo4J provided by Neo4j, Inc.™, and the like), pull (iteration pattern) query engines, push (visitor pattern) query engines, transactional DB engines, extensible query execution engines, package query language (PaQL) execution engines, LegoBase query execution engines, and/or some other query engine used to query some other type of DB system (such as any processing engine or execution technology discussed herein). In some implementations, the query engine(s) may include or implement an in-memory caching system and/or an in-memory caching engine (e.g., memcached, Redis, and the like) to store frequently accessed data items in a main memory of the ADPP server(s) 145 for later retrieval without additional access to the persistent data store. Suitable implementations for the database systems and storage devices are known or commercially available, and are readily implemented by persons having ordinary skill in the art.

The ADPP DB 150 stores a plurality of database objects (DBOs). The DBOs may be arranged in a set of logical tables containing data fitted into predefined or customizable categories, and/or the DBOs may be arranged in a set of blockchains or ledgers wherein each block (or DBO) in the blockchain is linked to a previous block. Each of the DBOs may include data associated with users 105 and/or org platforms 120, such as data policy framework information, org objectives, use case and/or other data as discussed previously; data collected from various external sources; identity session identifiers (IDs); and/or other like data.

Some of the DBOs may store information pertaining to relationships between any of the data items discussed herein. Some of the DBOs may store permission or access-related information for each user. These DBOs may indicate specific third parties that are permitted to access identity data of a particular user. In some implementations, the permission or access-related DBOs for each user may be arranged or stored as a blockchain to control which third parties can access that user's identity data. In these embodiments, the blockchain(s) do not actually store user biometric and/or biographic data, but instead are used to authorize specific third party platforms to access specific identity data items and to track or account for the accesses to the identity data items.

As alluded to previously, the client system(s) is/are configured to run, execute, or otherwise operate client app. The client app is a software app designed to generate and render objects, which include various types of content. At least some of the objects include graphical user interfaces (GUIs) and/or graphical control elements (GCEs) that enable interactions with the ADPP 140. In some embodiments, the client app is an app container/skeleton 110 in which a CTS app operates. For example, the objects may represent a web app that runs inside the client app, and the client app may be an HTTP client, such as a “web browser” (or simply a “browser”) for sending and receiving HTTP messages to and from a web/app servers 145 of the ADPP 140. In some examples, a CTS browser extension or plug-in may be configured to allow the client app to render objects that allow the user to interact with the ADPP 140 for contact tracing services according to the embodiments discussed herein. Example browsers include WebKit-based browsers, Microsoft's Internet Explorer browser, Microsoft's Edge browser, Apple's Safari, Google's Chrome, Opera's browser, Mozilla's Firefox browser, and/or the like. In some embodiments, the client app is an app specifically developed or tailored to interact with the ADPP 140. For example, the client app may be a desktop or native (mobile) app that runs directly on the client system(s) without a browser, and which communicates (sends and receives) suitable messages with the ADPP 140. In some embodiments, the client app is an app specifically developed or tailored to interact with the ADPP 140 for contact tracing services.

The client app may be developed using any suitable programming languages and/or development tools, such as those discussed herein or others known in the art. The client app may be platform-specific, such as when the client system(s) is/are implemented as a mobile device, such as a smartphone, tablet computer, or the like. In these embodiments, the client app may be a mobile web browser, a native app (or “mobile app”) specifically tailored to operate on the mobile client system(s), or a hybrid app wherein objects (or a web app) is embedded inside the native app. In some implementations, the client app and/or the web apps that run inside the client app is/are specifically designed to interact with server-side apps implemented by the app platform of the provider system (discussed infra). In some implementations, the client app, and/or the web apps that run inside the client app may be platform-specific or developed to operate on a particular type of client system(s) or a particular (hardware and/or software) client system(s) configuration. The term “platform-specific” may refer to the platform implemented by the client system(s), the platform implemented by the ADPP 140, and/or a platform of a third-party system/platform.

In the aforementioned embodiments, the client system(s) implementing a client (CTS) app is capable of controlling its communications/network interface(s) to send and receive HTTP messages to/from the ADPP 140, render the objects in the client app, request connections with other devices, and/or perform (or request performance) of other like functions. The header of these HTTP messages includes various operating parameters and the body of the HTTP messages include program code or source code documents (e.g., HTML, XML, JSON, and/or some other like object(s)/document(s)) to be executed and rendered in the client app. The client app executes the program code or source code documents and renders the objects (or web apps) inside the client app.

The rendered objects (or executed web app) allows the user of the client system(s) to view content provided by the ADPP 140, which may include the results of a requested service, visual representations of data, hyperlinks or links to other resources, and/or the like. The rendered objects also include interfaces for interacting with the ADPP 140, for example, to request additional content or services from the ADPP 140. In an example, the rendered objects may include GUIs, which are used to manage the interactions between the user of the client system(s) and the ADPP 140. The GUIs comprise one or more GCEs (or widgets) such as buttons, sliders, text boxes, tabs, dashboards, and the like The user of the client system(s) may select or otherwise interact with one or more of the GCEs (e.g., by pointing and clicking using a mouse, or performing a gesture for touchscreen-based systems) to request content or services from the ADPP 140.

In some cases, the user of client system(s) may be required to authenticate their identity in order to obtain content and/or services from the ADPP 140, and the ADPP 140 provides contact tracing services for the user of client system(s) so that the user can access the content/services from the ADPP 140. To provide the contact tracing services to the user, the client app may be, or may include, a secure portal to the ADPP 140. The secure portal may be a stand-alone app, embedded within a web or mobile app provided by ADPP 140, and/or invoked or called by the web/mobile app provided by ADPP 140 (e.g., using an API, Remote Procedure Call (RPC), and/or the like). In these cases, graphical objects rendered and displayed within the client app may be a GUI and/or GCEs of the secure portal, which allows the user to share data (e.g., contact info, biographic data, biometric data, and the like) with the ADPP 140. In any of the aforementioned embodiments and example use cases, the secure portal allows users 105, GPOs 110, and/or orgs/contact tracers 121 to enroll with the ADPP 140 for contact tracing purposes. The secure portal also allows enrolled users to access and/or perform various contact tracing tasks. For example, the secure portal may provide access to a dashboard GUI that allows contact tracers 121 to submit queries for case subjects (e.g., contact information); obtain/see the depth and quality of contact data for a particular case subject, update and improve the quality of the collected information, and set notifications for automatically receiving updated data for contacts of particular case subjects.

Additionally or alternatively, the client app may collect various data from the client system(s) without direct user interaction with the client app. For example, the client app may cause the client system(s) to generate and transmit one or more HTTP messages with a header portion including, inter alia, an IP address of the client system(s) in an X-Forwarded-For (XFF) field, a time and date that the message was sent in a Date field, and/or a user agent string contained in a User Agent field. The user agent string may indicate an operating system (OS) type/version being operated by the client system(s), system information of the client system(s), an app version/type or browser version/type of the client app, a rendering engine version/type implemented by the client app, a device and/or platform type of the client system(s), and/or other like information. These HTTP messages may be sent in response to user interactions with the client app (e.g., when a user submits biographic or biometric data as discussed infra), or the client app may include one or more scripts, which when executed by the client system(s), cause the client system(s) to generate and send the HTTP messages upon loading or rendering the client app. Other message types may be used and/or the user and/or client system(s) information may be obtained by other means in other embodiments.

In addition to (or alternative to) obtaining information from HTTP messages as discussed previously, the ADPP servers 145 may determine or derive other types of user information associated with the client system(s). For example, the ADPP servers 145 may derive a time zone and/or geolocation in which the client system(s) is/are located from an obtained IP address. In some embodiments, the user and/or client system(s) information may be sent to the ADPP servers 145 when the client system(s) loads or renders the client app. For example, the login page may include JavaScript or other like code that obtains and sends back information (e.g., in an additional HTTP message) that is not typically included in an HTTP header, such as time zone information, global navigation satellite system (GNSS) and/or Global Positioning System (GPS) coordinates, screen or display resolution of the client system(s), and/or other like information. Other methods may be used to obtain or derive such information in other embodiments.

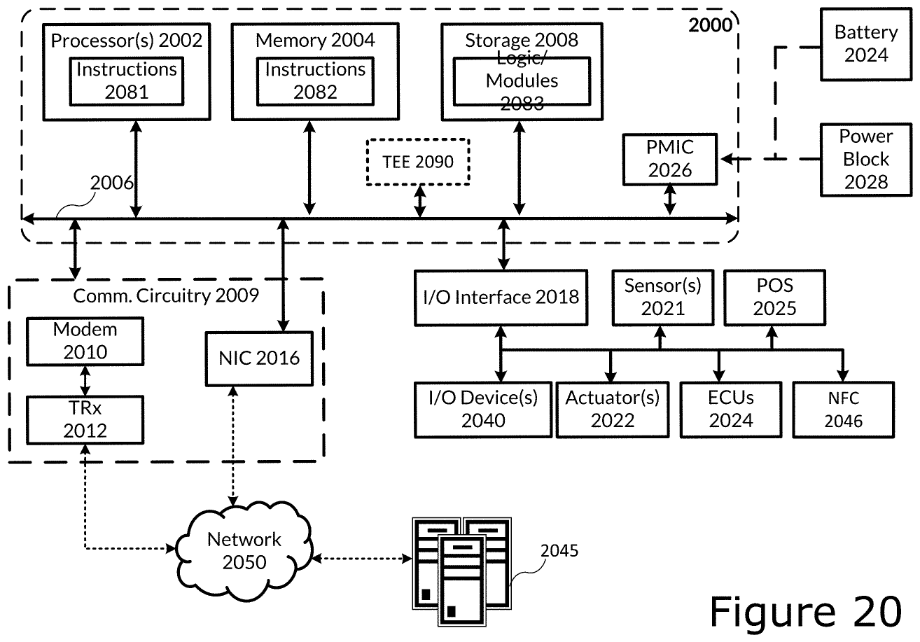

FIG. 20 illustrates an example of a computing system 2000 (also referred to as “platform 2000,” “device 2000,” “appliance 2000,” or the like) in accordance with various embodiments. In FIG. 20, like numbered items are the same as discussed previously. The system 2000 may be suitable for use as any of the computer devices discussed herein, such as the client systems 105, ADPP servers 145, and the like. The components of system 2000 may be implemented as an individual computer system, or as components otherwise incorporated within a chassis of a larger system. The components of system 2000 may be implemented as integrated circuits (ICs) or other discrete electronic devices, with the appropriate logic, software, firmware, or a combination thereof, adapted in the computer system 2000. Additionally or alternatively, some of the components of system 2000 may be combined and implemented as a suitable SoC, SiP, MCP, and/or the like.

The system 2000 includes physical hardware devices and software components capable of providing and/or accessing content and/or services to/from the remote system 2045. The system 2000 and/or the remote system 2045 can be implemented as any suitable computing system or other data processing apparatus usable to access and/or provide content/services from/to one another. As examples, the system 2000 and/or the remote system 2045 may comprise desktop computers, workstations, laptops, mobile phones (e.g., “smartphones”), tablet computers, portable media players, wearable devices, server systems, network appliances, policy appliances, smart appliances, an aggregation of computing resources (e.g., in a cloud-based environment), or some other computing devices capable of interfacing directly or indirectly with network 2050 or other network. The system 2000 communicates with remote systems 2045, and vice versa, to obtain/serve content/services using any suitable communication protocol, such as any of those discussed herein.

Referring now to system 2000, the system 2000 includes processor circuitry 2002, which is configured to execute program code, and/or sequentially and automatically carry out a sequence of arithmetic or logical operations; record, store, and/or transfer digital data. The processor circuitry 2002 includes circuitry such as, but not limited to, one or more processor cores and one or more of cache memory, low drop-out voltage regulators (LDOs), interrupt controllers, serial interfaces such as serial peripheral interface (SPI), inter-integrated circuit (I²C) or universal programmable serial interface circuit, real time clock, timer-counters including interval and watchdog timers, general purpose input/output (I/O), memory card controllers, interconnect (IX) controllers and/or interfaces, universal serial bus (USB) interfaces, mobile industry processor interface (MIPI) interfaces, Joint Test Access Group (JTAG) test access ports, and the like. The processor circuitry 2002 may include on-chip memory circuitry or cache memory circuitry, which may include any suitable volatile and/or non-volatile memory, such as DRAM, SRAM, EPROM, EEPROM, Flash memory, solid-state memory, and/or any other type of memory device technology, such as those discussed herein. Individual processors (or individual processor cores) of the processor circuitry 2002 may be coupled with or may include memory/storage and may be configured to execute instructions stored in the memory/storage to enable various apps or operating systems to run on the system 2000. In these embodiments, the processors (or cores) of the processor circuitry 2002 are configured to operate app software (e.g., logic/modules 2083) to provide specific services to a user of the system 2000. In some embodiments, the processor circuitry 2002 may include a special-purpose processor/controller to operate according to the various embodiments herein.

In various implementations, the processor(s) of processor circuitry 2002 may include, for example, one or more processor cores (CPUs), graphics processing units (GPUs), reduced instruction set computing (RISC) processors, Acorn RISC Machine (ARM) processors, complex instruction set computing (CISC) processors, digital signal processors (DSP), programmable logic devices (PLDs), field-programmable gate arrays (FPGAs), Application Specific Integrated Circuits (ASICs), SoCs and/or programmable SoCs, microprocessors or controllers, or any suitable combination thereof. As examples, the processor circuitry 2002 may include Intel® Core™ based processor(s), MCU-class processor(s), Xeon® processor(s); Advanced Micro Devices (AMD) Zen® Core Architecture processor(s), such as Ryzen® or Epyc® processor(s), Accelerated Processing Units (APUs), MxGPUs, or the like; A, S, W, and T series processor(s) from Apple® Inc., Snapdragon™ or Centrig™ processor(s) from Qualcomm® Technologies, Inc., Texas Instruments, Inc.® Open Multimedia Applications Platform (OMAP)™ processor(s); Power Architecture processor(s) provided by the OpenPOWER® Foundation and/or IBM®, MIPS Warrior M-class, Warrior I-class, and Warrior P-class processor(s) provided by MIPS Technologies, Inc.; ARM Cortex-A, Cortex-R, and Cortex-M family of processor(s) as licensed from ARM Holdings, Ltd.; the ThunderX2® provided by Cavium™, Inc.; GeForce®, Tegra®, Titan X®, Tesla®, Shield®, and/or other like GPUs provided by Nvidia®; or the like. Other examples of the processor circuitry 2002 may be mentioned elsewhere in the present disclosure.

In some implementations, the processor circuitry 2002 may include one or more hardware accelerators (e.g., where the system 2000 is a server computer system). The hardware accelerators may be microprocessors, configurable hardware (e.g., FPGAs, programmable ASICs, programmable SoCs, DSPs, and the like), or some other suitable special-purpose processing device tailored to perform one or more specific tasks or workloads, for example, specific tasks or workloads of the subsystems of the ADPP 140, which may be more efficient than using general-purpose processor cores. In some embodiments, the specific tasks or workloads may be offloaded from one or more processors of the processor circuitry 2002. In these implementations, the circuitry of processor circuitry 2002 may comprise logic blocks or logic fabric including some other interconnected resources that may be programmed to perform various functions, such as the procedures, methods, functions, and the like of the various embodiments discussed herein. Additionally, the processor circuitry 2002 may include memory cells (e.g., EPROM, EEPROM, flash memory, static memory (e.g., SRAM, anti-fuses, and the like) used to store logic blocks, logic fabric, data, and the like, in look-up tables (LUTs) and the like. In some hardware-based implementations, one or more of the subsystems of the ADPP 140 may be operated by the respective AI accelerating co-processor(s), AI GPUs, TPUs, or hardware accelerators (e.g., FPGAs, ASICs, DSPs, SoCs, and the like), and the like, that are configured with appropriate logic blocks, bit stream(s), and the like to perform their respective functions.

In some implementations, the processor circuitry 2002 may include hardware elements specifically tailored for AI, ML, and/or deep learning functionality, such as for operating the subsystems of the ADPP 140 discussed previously with regard to FIGS. 1-22. In these implementations, the processor circuitry 2002 may be, or may include, an AI engine chip that can run many different kinds of AI instruction sets once loaded with the appropriate weightings and training code. Additionally or alternatively, the processor circuitry 2002 may be, or may include, AI accelerator(s), which may be one or more of the aforementioned hardware accelerators designed for hardware acceleration of AI apps, such as one or more of the subsystems of ADPP 140. As examples, these processor(s) or accelerators may be a cluster of artificial intelligence (AI) GPUs, tensor processing units (TPUs) developed by Google® Inc., Real AI Processors (RAPs™) provided by AlphalCs®, Nervana™ Neural Network Processors (NNPs) provided by Intel® Corp., Intel® Movidius™ Myriad™ X Vision Processing Unit (VPU), NVIDIA® PX™ based GPUs, the NM500 chip provided by General Vision®, Hardware 3 provided by Tesla®, Inc., an Epiphany™ based processor provided by Adapteva®, or the like. In some embodiments, the processor circuitry 2002 and/or hardware accelerator circuitry may be implemented as AI accelerating co-processor(s), such as the Hexagon 685 DSP provided by Qualcomm®, the PowerVR 2NX Neural Net Accelerator (NNA) provided by Imagination Technologies Limited®, the Neural Engine core within the Apple® A11 or A12 Bionic SoC, the Neural Processing Unit (NPU) within the Hi Silicon Kirin 970 provided by Huawei®, and/or the like.

In some implementations, the processor(s) of processor circuitry 2002 may be, or may include, one or more custom-designed silicon cores specifically designed to operate corresponding subsystems of the ADPP 140. These cores may be designed as synthesizable cores comprising hardware description language logic (e.g., register transfer logic, verilog, Very High Speed Integrated Circuit hardware description language (VHDL), and the like); netlist cores comprising gate-level description of electronic components and connections and/or process-specific very-large-scale integration (VLSI) layout; and/or analog or digital logic in transistor-layout format. In these implementations, one or more of the subsystems of the ADPP 140 may be operated, at least in part, on custom-designed silicon core(s). These “hardware-ized” subsystems may be integrated into a larger chipset but may be more efficient than using general purpose processor cores.

The system memory circuitry 2004 comprises any number of memory devices arranged to provide primary storage from which the processor circuitry 2002 continuously reads instructions 2082 stored therein for execution. In some embodiments, the memory circuitry 2004 is on-die memory or registers associated with the processor circuitry 2002. As examples, the memory circuitry 2004 may include volatile memory such as random access memory (RAM), dynamic RAM (DRAM), synchronous DRAM (SDRAM), and the like. The memory circuitry 2004 may also include nonvolatile memory (NVM) such as high-speed electrically erasable memory (commonly referred to as “flash memory”), phase change RAM (PRAM), resistive memory such as magnetoresistive random access memory (MRAM), and the like. The memory circuitry 2004 may also comprise persistent storage devices, which may be temporal and/or persistent storage of any type, including, but not limited to, non-volatile memory, optical, magnetic, and/or solid-state mass storage, and so forth.

Storage circuitry 2008 is arranged to provide persistent storage of information such as data, apps, operating systems (OS), and so forth. As examples, the storage circuitry 2008 may be implemented as hard disk drive (HDD), a micro HDD, a solid-state disk drive (SSDD), flash memory cards (e.g., SD cards, microSD cards, xD picture cards, and the like), USB flash drives, on-die memory or registers associated with the processor circuitry 2002, resistance change memories, phase change memories, holographic memories, or chemical memories, and the like.

The storage circuitry 2008 is configured to store computational logic 2083 (or “modules 2083”) in the form of software, firmware, microcode, or hardware-level instructions to implement the techniques described herein. The computational logic 2083 may be employed to store working copies and/or permanent copies of programming instructions, or data to create the programming instructions, for the operation of various components of system 2000 (e.g., drivers, libraries, application programming interfaces (APIs), and the like), an OS of system 2000, one or more apps, and/or for carrying out the embodiments discussed herein. The computational logic 2083 may be stored or loaded into memory circuitry 2004 as instructions 2082, or data to create the instructions 2082, which are then accessed for execution by the processor circuitry 2002 to carry out the functions described herein. The processor circuitry 2002 accesses the memory circuitry 2004 and/or the storage circuitry 2008 over the interconnect (IX) 2006. The instructions 2082 to direct the processor circuitry 2002 to perform a specific sequence or flow of actions, for example, as described with respect to flowchart(s) and block diagram(s) of operations and functionality depicted previously. The various elements may be implemented by assembler instructions supported by processor circuitry 2002 or high-level languages that may be compiled into instructions 2081, or data to create the instructions 2081, to be executed by the processor circuitry 2002. The permanent copy of the programming instructions may be placed into persistent storage devices of storage circuitry 2008 in the factory or in the field through, for example, a distribution medium (not shown), through a communication interface (e.g., from a distribution server (not shown)), or over-the-air (OTA).

In some embodiments, the instructions 2081 on the processor circuitry 2002 (separately, or in combination with the instructions 2082 and/or logic/modules 2083 stored in computer-readable storage media) may configure execution or operation of a trusted execution environment (TEE) 2090. The TEE 2090 operates as a protected area accessible to the processor circuitry 2002 to enable secure access to data and secure execution of instructions. In some embodiments, the TEE 2090 may be a physical hardware device that is separate from other components of the system 2000 such as a secure-embedded controller, a dedicated SoC, or a tamper-resistant chipset or microcontroller with embedded processing devices and memory devices. Examples of such embodiments include a Desktop and mobile Architecture Hardware (DASH) compliant Network Interface Card (NIC), Intel® Management/Manageability Engine, Intel® Converged Security Engine (CSE) or a Converged Security Management/Manageability Engine (CSME), Trusted Execution Engine (TXE) provided by Intel® each of which may operate in conjunction with Intel® Active Management Technology (AMT) and/or Intel® vPro™ Technology; AMD® Platform Security coProcessor (PSP), AMD® PRO A-Series Accelerated Processing Unit (APU) with DASH manageability, Apple® Secure Enclave coprocessor; IBM® Crypto Express3®, IBM® 4807, 4808, 4809, and/or 4765 Cryptographic Coprocessors, IBM® Baseboard Management Controller (BMC) with Intelligent Platform Management Interface (IPMI), Dell™ Remote Assistant Card II (DRAC II), integrated Dell™ Remote Assistant Card (iDRAC), and the like.

In other embodiments, the TEE 2090 may be implemented as secure enclaves, which are isolated regions of code and/or data within the processor and/or memory/storage circuitry of the system 2000. Only code executed within a secure enclave may access data within the same secure enclave, and the secure enclave may only be accessible using the secure app (which may be implemented by an application processor or a tamper-resistant microcontroller). Various implementations of the TEE 2090, and an accompanying secure area in the processor circuitry 2002 or the memory circuitry 2004 and/or storage circuitry 2008 may be provided, for instance, through use of Intel® Software Guard Extensions (SGX), ARM® TrustZone® hardware security extensions, Keystone Enclaves provided by Oasis Labs™, and/or the like. Other aspects of security hardening, hardware roots-of-trust, and trusted or protected operations may be implemented in the device 2000 through the TEE 2090 and the processor circuitry 2002.

In some embodiments, the memory circuitry 2004 and/or storage circuitry 2008 may be divided into isolated user-space instances such as containers, partitions, virtual environments (VEs), and the like. The isolated user-space instances may be implemented using a suitable OS-level virtualization technology such as Docker® containers, Kubernetes® containers, Solaris® containers and/or zones, OpenVZ® virtual private servers, DragonFly BSD® virtual kernels and/or jails, chroot jails, and/or the like. Virtual machines could also be used in some implementations. In some embodiments, the memory circuitry 2004 and/or storage circuitry 2008 may be divided into one or more trusted memory regions for storing apps or software modules of the TEE 2090.

The memory circuitry 2004 and/or storage circuitry 2008 may store program code of an operating system (OS), which may be a general purpose OS or an OS specifically written for and tailored to the computing platform 2000. For example, when the system 2000 is a server system or a desktop or laptop system 2000, the OS may be Unix or a Unix-like OS such as Linux e.g., provided by Red Hat Enterprise, Windows 10™ provided by Microsoft Corp.®, macOS provided by Apple Inc.®, or the like. In another example where the system 2000 is a mobile device, the OS may be a mobile OS, such as Android® provided by Google Inc.®, iOS® provided by Apple Inc.®, Windows 10 Mobile® provided by Microsoft Corp.®, KaiOS provided by KaiOS Technologies Inc., or the like. The OS manages computer hardware and software resources, and provides common services for various apps. The OS may include one or more drivers or APIs that operate to control particular devices that are embedded in the system 2000, attached to the system 2000, or otherwise communicatively coupled with the system 2000. The drivers may include individual drivers allowing other components of the system 2000 to interact or control various I/O devices that may be present within, or connected to, the system 2000. For example, the drivers may include a display driver to control and allow access to a display device, a touchscreen driver to control and allow access to a touchscreen interface of the system 2000, sensor drivers to obtain sensor readings of sensor circuitry 2021 and control and allow access to sensor circuitry 2021, actuator drivers to obtain actuator positions of the actuators 2022 and/or control and allow access to the actuators 2022, a camera driver to control and allow access to an embedded image capture device, audio drivers to control and allow access to one or more audio devices. The OSs may also include one or more libraries, drivers, APIs, firmware, middleware, software glue, and the like, which provide program code and/or software components for one or more apps to obtain and use the data from other apps operated by the system 2000, such as the various subsystems of the ADPP 140 discussed previously.

The components of system 2000 communicate with one another over the interconnect (IX) 2006. The IX 2006 may include any number of IX technologies such as industry standard architecture (ISA), extended ISA (EISA), inter-integrated circuit (I²C), serial peripheral interface (SPI), point-to-point interfaces, power management bus (PMBus), peripheral component interconnect (PCI), PCI express (PCIe), Intel® Ultra Path Interface (UPI), Intel® Accelerator Link (IAL), Common Application Programming Interface (CAPI), Intel® QuickPath Interconnect (QPI), Intel® Omni-Path Architecture (OPA) IX, RapidIO™ system interconnects, Ethernet, Cache Coherent Interconnect for Accelerators (CCIA), Gen-Z Consortium IXs, Open Coherent Accelerator Processor Interface (OpenCAPI), and/or any number of other IX technologies. The IX 2006 may be a proprietary bus, for example, used in a SoC based system.

The communication circuitry 2009 is a hardware element, or collection of hardware elements, used to communicate over one or more networks (e.g., network 2001) and/or with other devices. The communication circuitry 2009 includes modem 2010 and transceiver circuitry (“TRx”) 2012. The modem 2010 includes one or more processing devices (e.g., baseband processors) to carry out various protocol and radio control functions. Modem 2010 may interface with application circuitry of system 2000 (e.g., a combination of processor circuitry 2002, memory circuitry 2004, and/or storage circuitry 2008) for generation and processing of baseband signals and for controlling operations of the TRx 2012. The modem 2010 may handle various radio control functions that enable communication with one or more radio networks via the TRx 2012 according to one or more wireless communication protocols. The modem 2010 may include circuitry such as, but not limited to, one or more single-core or multi-core processors (e.g., one or more baseband processors) or control logic to process baseband signals received from a receive signal path of the TRx 2012, and to generate baseband signals to be provided to the TRx 2012 via a transmit signal path. In various embodiments, the modem 2010 may implement a real-time OS (RTOS) to manage resources of the modem 2010, schedule tasks, and the like.

The communication circuitry 2009 also includes TRx 2012 to enable communication with wireless networks using modulated electromagnetic radiation through a non-solid medium. The TRx 2012 may include one or more radios that are compatible with, and/or may operate according to any one or more of the radio communication technologies, radio access technologies (RATs), and/or communication protocols/standards including any combination of those discussed herein. TRx 2012 includes a receive signal path, which comprises circuitry to convert analog RF signals (e.g., an existing or received modulated waveform) into digital baseband signals to be provided to the modem 2010. The TRx 2012 also includes a transmit signal path, which comprises circuitry configured to convert digital baseband signals provided by the modem 2010 to be converted into analog RF signals (e.g., modulated waveform) that will be amplified and transmitted via an antenna array including one or more antenna elements (not shown). The antenna array may be a plurality of microstrip antennas or printed antennas that are fabricated on the surface of one or more printed circuit boards. The antenna array may be formed in as a patch of metal foil (e.g., a patch antenna) in a variety of shapes, and may be coupled with the TRx 2012 using metal transmission lines or the like.

Network interface circuitry/controller (NIC) 2016 may be included to provide wired communication to the network 101 or to other devices using a standard network interface protocol. The standard network interface protocol may include Ethernet, Ethernet over GRE Tunnels, Ethernet over Multiprotocol Label Switching (MPLS), Ethernet over USB, or may be based on other types of network protocols, such as Controller Area Network (CAN), Local Interconnect Network (LIN), DeviceNet, ControlNet, Data Highway+, PROFIBUS, or PROFINET, among many others. Network connectivity may be provided to/from the system 2000 via NIC 2016 using a physical connection, which may be electrical (e.g., a “copper interconnect”) or optical. The physical connection also includes suitable input connectors (e.g., ports, receptacles, sockets, and the like) and output connectors (e.g., plugs, pins, and the like). The NIC 2016 may include one or more dedicated processors and/or FPGAs to communicate using one or more of the aforementioned network interface protocols. In some implementations, the NIC 2016 may include multiple controllers to provide connectivity to other networks using the same or different protocols. For example, the system 2000 may include a first NIC 2016 providing communications to the cloud over Ethernet and a second NIC 2016 providing communications to other devices over another type of network. In some implementations, the NIC 2016 may be a high-speed serial interface (HS SI) NIC to connect the system 2000 to a routing or switching device.

Network 2050 comprises computers, network connections among various computers (e.g., between the system 2000 and remote system 2045), and software routines to enable communication between the computers over respective network connections. In this regard, the network 2050 comprises one or more network elements that may include one or more processors, communications systems (e.g., including network interface controllers, one or more transmitters/receivers connected to one or more antennas, and the like), and computer readable media. Examples of such network elements may include wireless access points (WAPs), a home/business/enterprise server (with or without radio frequency (RF) communications circuitry), a router, a switch, a hub, a radio beacon, base stations, picocell or small cell base stations, and/or any other like network device. Connection to the network 2050 may be via a wired or a wireless connection using the various communication protocols discussed infra. As used herein, a wired or wireless communication protocol may refer to a set of standardized rules or instructions implemented by a communication device/system to communicate with other devices, including instructions for packetizing/depacketizing data, modulating/demodulating signals, implementation of protocols stacks, and the like. More than one network may be involved in a communication session between the illustrated devices. Connection to the network 2050 may require that the computers execute software routines which enable, for example, the seven layers of the OSI model of computer networking or equivalent in a wireless (or cellular) phone network.

The network 2050 may represent the Internet, one or more cellular networks, a local area network (LAN) or a wide area network (WAN) including proprietary and/or enterprise networks, Transfer Control Protocol (TCP)/Internet Protocol (IP)-based network, or combinations thereof. In such embodiments, the network 2050 may be associated with network operator who owns or controls equipment and other elements necessary to provide network-related services, such as one or more base stations or access points, one or more servers for routing digital data or telephone calls (e.g., a core network or backbone network), and the like. Other networks can be used instead of or in addition to the Internet, such as an intranet, an extranet, a virtual private network (VPN), an enterprise network, a non-TCP/IP based network, any LAN or WAN or the like.

The remote system 2045 (also referred to as a “service provider”, “application server(s)”, “app server(s)”, “external platform”, and/or the like) comprises one or more physical and/or virtualized computing systems owned and/or operated by a company, enterprise, and/or individual that hosts, serves, and/or otherwise provides information object(s) to one or more users (e.g., system 2000). The physical and/or virtualized systems include one or more logically or physically connected servers and/or data storage devices distributed locally or across one or more geographic locations. Generally, the remote system 2045 uses IP/network resources to provide information objects such as electronic documents, webpages, forms, apps (e.g., web apps), data, services, web services, media, and/or content to different user/client devices. As examples, the service provider 2045 may provide mapping and/or navigation services; cloud computing services; search engine services; social networking, microblogging, and/or message board services; content (media) streaming services; e-commerce services; blockchain services; communication services such as Voice-over-Internet Protocol (VoIP) sessions, text messaging, group communication sessions, and the like; immersive gaming experiences; and/or other like services. In one example, the system 2000 may correspond to the user device 105, and the remote system 2045 corresponds to the ADPP 140 or one or more org platforms 120. The user devices 105 that utilize services provided by remote system 2045 may be referred to as “subscribers” or the like. Although FIG. 20 shows only a single remote system 2045, the remote system 2045 may represent multiple remote system 2045, each of which may have their own subscribing users.

The I/O interface circuitry 2018 is configured to connect or coupled the system 2000 with one or more external devices and/or subsystems. The external interface 2018 may include any suitable interface controllers and connectors to couple the system 2000 with the external components/devices. As an example, the external interface 2018 may be an external expansion bus (e.g., Universal Serial Bus (USB), FireWire, Thunderbolt, and the like) used to connect system 100 with external (peripheral) components/devices. The external devices include, inter alia, sensor circuitry 2021, actuators 2022, and positioning circuitry 2025, but may also include other devices or subsystems not shown by FIG. 20. In some cases, the I/O interface circuitry 2018 may be used to transfer data between the system 2000 and another computer device (e.g., a laptop, a smartphone, or some other user device) via a wired connection. I/O interface circuitry 2018 may include any suitable interface controllers and connectors to interconnect one or more of the processor circuitry 2002, memory circuitry 2004, storage circuitry 2008, communication circuitry 2009, and the other components of system 2000. The interface controllers may include, but are not limited to, memory controllers, storage controllers (e.g., redundant array of independent disk (RAID) controllers, baseboard management controllers (BMCs), input/output controllers, host controllers, and the like. The connectors may include, for example, busses (e.g., IX 2006), ports, slots, jumpers, interconnect modules, receptacles, modular connectors, and the like. The I/O interface circuitry 2018 may also include peripheral component interfaces including, but are not limited to, non-volatile memory ports, USB ports, audio jacks, power supply interfaces, on-board diagnostic (OBD) ports, and the like.

The sensor circuitry 2021 may include devices, modules, or subsystems whose purpose is to detect events or changes in its environment and send the information (sensor data) about the detected events to some other device, module, subsystem, and the like. Examples of such sensors 621 include, inter alia, inertia measurement units (IMU) comprising accelerometers, gyroscopes, and/or magnetometers; microelectromechanical systems (MEMS) or nanoelectromechanical systems (NEMS) comprising 3-axis accelerometers, 3-axis gyroscopes, and/or magnetometers; level sensors; flow sensors; temperature sensors (e.g., thermistors); pressure sensors; barometric pressure sensors; gravimeters; altimeters; image capture devices (e.g., cameras); light detection and ranging (LiDAR) sensors; proximity sensors (e.g., infrared radiation detector and the like), depth sensors, ambient light sensors, ultrasonic transceivers; microphones; and the like.

The actuators 2022 allow the system 2000 to change its state, position, and/or orientation, or move or control a mechanism or system. The actuators 2022 comprise electrical and/or mechanical devices for moving or controlling a mechanism or system, and convert energy (e.g., electric current or moving air and/or liquid) into some kind of motion. The actuators 2022 may include one or more electronic (or electrochemical) devices, such as piezoelectric biomorphs, solid state actuators, solid state relays (SSRs), shape-memory alloy-based actuators, electroactive polymer-based actuators, relay driver integrated circuits (ICs), and/or the like. The actuators 2022 may include one or more electromechanical devices such as pneumatic actuators, hydraulic actuators, electromechanical switches including electromechanical relays (EMRs), motors (e.g., DC motors, stepper motors, servomechanisms, and the like), wheels, thrusters, propellers, claws, clamps, hooks, an audible sound generator, and/or other like electromechanical components. The system 2000 may be configured to operate one or more actuators 2022 based on one or more captured events and/or instructions or control signals received from a service provider and/or various user systems 105. In embodiments, the system 2000 may transmit instructions to various actuators 2022 (or controllers that control one or more actuators 2022) to reconfigure an electrical network as discussed herein.

The positioning circuitry 2025 includes circuitry to receive and decode signals transmitted/broadcasted by a positioning network of a GNSS. Examples of such navigation satellite constellations include United States' GPS, Russia's Global Navigation System (GLONASS), the European Union's Galileo system, China's BeiDou Navigation Satellite System, a regional navigation system or GNSS augmentation system (e.g., Navigation with Indian Constellation (NAVIC), Japan's Quasi-Zenith Satellite System (QZSS), France's Doppler Orbitography and Radio-positioning Integrated by Satellite (DORIS), and the like), or the like. The positioning circuitry 2025 comprises various hardware elements (e.g., including hardware devices such as switches, filters, amplifiers, antenna elements, and the like to facilitate OTA communications) to communicate with components of a positioning network, such as navigation satellite constellation nodes. In some embodiments, the positioning circuitry 2025 may include a Micro-Technology for Positioning, Navigation, and Timing (Micro-PNT) IC that uses a master timing clock to perform position tracking/estimation without GNSS assistance. The positioning circuitry 2025 may also be part of, or interact with, the communication circuitry 2009 to communicate with the nodes and components of the positioning network. The positioning circuitry 2025 may also provide position data and/or time data to the application circuitry, which may use the data to synchronize operations with various infrastructure (e.g., radio base stations), for turn-by-turn navigation, or the like.

The I/O device(s) 2040 may be present within, or connected to, the system 2000. The I/O devices 2040 include input device circuitry and output device circuitry including one or more user interfaces designed to enable user interaction with the system 2000 and/or peripheral component interfaces designed to enable peripheral component interaction with the system 2000. The input device circuitry includes any physical or virtual means for accepting an input including, inter alia, one or more physical or virtual buttons, a physical or virtual keyboard, keypad, mouse, touchpad, touchscreen, microphones, scanner, headset, and/or the like. In embodiments where the input device circuitry includes a capacitive, resistive, or other like touch-surface, a touch signal may be obtained from circuitry of the touch-surface. The touch signal may include information regarding a location of the touch (e.g., one or more sets of (x,y) coordinates describing an area, shape, and/or movement of the touch), a pressure of the touch (e.g., as measured by area of contact between a user's finger or a deformable stylus and the touch-surface, or by a pressure sensor), a duration of contact, any other suitable information, or any combination of such information. In these embodiments, one or more apps operated by the processor circuitry 2002 may identify gesture(s) based on the information of the touch signal, and utilizing a gesture library that maps determined gestures with specified actions.

The output device circuitry is used to show or convey information, such as sensor readings, actuator position(s), or other like information. Data and/or graphics may be displayed on one or more user interface components of the output device circuitry. The output device circuitry may include any number and/or combinations of audio or visual display, including, inter alia, one or more simple visual outputs/indicators (e.g., binary status indicators (e.g., light emitting diodes (LEDs)) and multi-character visual outputs, or more complex outputs such as display devices or touchscreens (e.g., Liquid Chrystal Displays (LCD), LED and/or OLED displays, quantum dot displays, projectors, and the like), with the output of characters, graphics, multimedia objects, and the like being generated or produced from operation of the system 2000. The output device circuitry may also include speakers or other audio emitting devices, printer(s), and/or the like. In some embodiments, the sensor circuitry 2021 may be used as the input device circuitry (e.g., an image capture device, motion capture device, or the like) and one or more actuators 2022 may be used as the output device circuitry (e.g., an actuator to provide haptic feedback or the like). In another example, near-field communication (NFC) circuitry 2046 comprising an NFC controller coupled with an antenna element and a processing device may be included to read electronic tags and/or connect with another NFC-enabled device. Peripheral component interfaces may include, but are not limited to, a non-volatile memory port, a universal serial bus (USB) port, an audio jack, a power supply interface, and the like.

A battery 2024 may be coupled to the system 2000 to power the system 2000, which may be used in embodiments where the system 2000 is not in a fixed location, such as when the system 2000 is a mobile device or laptop. The battery 2024 may be a lithium ion battery, a lead-acid automotive battery, or a metal-air battery, such as a zinc-air battery, an aluminum-air battery, a lithium-air battery, a lithium polymer battery, and/or the like. In embodiments where the system 2000 is mounted in a fixed location, such as when the system is implemented as a server computer system, the system 2000 may have a power supply coupled to an electrical grid. In these embodiments, the system 2000 may include power tee circuitry to provide for electrical power drawn from a network cable to provide both power supply and data connectivity to the system 2000 using a single cable.

Power management integrated circuitry (PMIC) 2026 may be included in the system 2000 to track the state of charge (SoCh) of the battery 2024, and to control charging of the system 2000. The PMIC 2026 may be used to monitor other parameters of the battery 2024 to provide failure predictions, such as the state of health (SoH) and the state of function (SoF) of the battery 2024. The PMIC 2026 may include voltage regulators, surge protectors, power alarm detection circuitry. The power alarm detection circuitry may detect one or more of brown out (under-voltage) and surge (over-voltage) conditions. The PMIC 2026 may communicate the information on the battery 2024 to the processor circuitry 2002 over the IX 2006. The PMIC 2026 may also include an analog-to-digital (ADC) convertor that allows the processor circuitry 2002 to directly monitor the voltage of the battery 2024 or the current flow from the battery 2024. The battery parameters may be used to determine actions that the system 2000 may perform, such as transmission frequency, mesh network operation, sensing frequency, and the like.

A power block 2028, or other power supply coupled to an electrical grid, may be coupled with the PMIC 2026 to charge the battery 2024. In some examples, the power block 2028 may be replaced with a wireless power receiver to obtain the power wirelessly, for example, through a loop antenna in the system 2000. In these implementations, a wireless battery charging circuit may be included in the PMIC 2026. The specific charging circuits chosen depend on the size of the battery 2024 and the current required.

NFC circuitry 2046 comprises one or more hardware devices and software modules configurable or operable to read electronic tags and/or connect with another NFC-enabled device (also referred to as an “NFC touchpoint”). NFC is commonly used for contactless, short-range communications based on radio frequency identification (RFID) standards, where magnetic field induction is used to enable communication between NFC-enabled devices. The one or more hardware devices may include an NFC controller coupled with an antenna element and a processor coupled with the NFC controller. The NFC controller may be a chip providing NFC functionalities to the NFC circuitry 2046. The software modules may include NFC controller firmware and an NFC stack. The NFC stack may be executed by the processor to control the NFC controller, and the NFC controller firmware may be executed by the NFC controller to control the antenna element to emit an RF signal. The RF signal may power a passive NFC tag (e.g., a microchip embedded in a sticker or wristband) to transmit stored data to the NFC circuitry 2046, or initiate data transfer between the NFC circuitry 2046 and another active NFC device (e.g., a smartphone or an NFC-enabled point-of-sale terminal) that is proximate to the computing system 2000 (or the NFC circuitry 2046 contained therein). The NFC circuitry 2046 may include other elements, such as those discussed herein. Additionally, the NFC circuitry 2046 may interface with a secure element (e.g., TEE 2090) to obtain payment credentials and/or other sensitive/secure data to be provided to the other active NFC device. Additionally or alternatively, the NFC circuitry 2046 and/or some other element may provide Host Card Emulation (HCE), which emulates a physical secure element.

The system 2000 may include any combinations of the components shown by FIG. 20; however, some of the components shown may be omitted, additional components may be present, and different arrangement of the components shown may occur in other implementations. In one example where the system 2000 is or is part of a server computer system, the battery 2024, communication circuitry 2009, the sensors 2021, actuators 2022, and/or positioning circuitry 2025, and possibly some or all of the I/O devices 2040, may be omitted.

In some examples, the memory circuitry 2004 and/or the storage circuitry 2008 may be referred ti as “non-transitory computer-readable media” or “NTCRM”. The NTCRM is suitable for use to store instructions (or data that creates the instructions) that cause an apparatus (such as any of the devices/components/systems described with regard to FIGS. 1-20), in response to execution of the instructions by the apparatus, to practice selected aspects of the present disclosure. As shown, NTCRSM includes a number of programming instructions (e.g., instructions 2081, 2082, 2083) (or data to create the programming instructions). The programming instructions may be configured to enable a device (e.g., any of the devices/components/systems described with regard to FIGS. 1-20), in response to execution of the programming instructions, to perform various programming operations associated with operating system functions, one or more apps, and/or aspects of the present disclosure (including various programming operations associated with FIGS. 1-20). The programming instructions may correspond to any of the computational logic 2083, instructions 2082 and 2081 discussed previously with regard to FIG. 20.

Additionally or alternatively, programming instructions (or data to create the instructions) may be disposed on multiple NTCRSM. In alternate embodiments, programming instructions (or data to create the instructions) may be disposed on computer-readable transitory storage media, such as signals. The programming instructions embodied by a machine-readable medium may be transmitted or received over a communications network using a transmission medium via a network interface device (e.g., communication circuitry 2009 and/or NIC 2016 of FIG. 20) utilizing any one of a number of transfer protocols (e.g., HTTP, and/or any other suitable protocol such as any of those discussed herein).

Any combination of one or more computer usable or NTCRM may be utilized as or instead of the NTCRSM. The computer-usable or computer-readable medium may be, for example, but not limited to one or more electronic, magnetic, optical, electromagnetic, infrared, or semiconductor systems, apparatuses, devices, or propagation media. For instance, the NTCRSM may be embodied by devices described for the storage circuitry 2008 and/or memory circuitry 2004 described previously with regard to FIG. 20. More specific examples (a non-exhaustive list) of a computer-readable medium may include the following: an electrical connection having one or more wires, a portable computer diskette, a hard disk, a random access memory (RAM), a read-only memory (ROM), an erasable programmable read-only memory (EPROM, Flash memory, and the like), an optical fiber, a portable compact disc read-only memory (CD-ROM), an optical storage device and/or optical disks, a transmission media such as those supporting the Internet or an intranet, a magnetic storage device, or any number of other hardware devices. In the context of the present disclosure, a computer-usable or computer-readable medium may be any medium that can contain, store, communicate, propagate, or transport the program (or data to create the program) for use by or in connection with the instruction execution system, apparatus, or device. The computer-usable medium may include a propagated data signal with the computer-usable program code (e.g., including programming instructions) or data to create the program code embodied therewith, either in baseband or as part of a carrier wave. The computer usable program code or data to create the program may be transmitted using any appropriate medium, including but not limited to wireless, wireline, optical fiber cable, RF, and the like.

In various embodiments, the program code (or data to create the program code) described herein may be stored in one or more of a compressed format, an encrypted format, a fragmented format, a packaged format, and/or the like. Program code (e.g., programming instructions) or data to create the program code as described herein may require one or more of installation, modification, adaptation, updating, combining, supplementing, configuring, decryption, decompression, unpacking, distribution, reassignment, and the like in order to make them directly readable and/or executable by a computing device and/or other machine. For example, the program code or data to create the program code may be stored in multiple parts, which are individually compressed, encrypted, and stored on separate computing devices, wherein the parts when decrypted, decompressed, and combined form a set of executable instructions that implement the program code or the data to create the program code, such as those described herein. In another example, the program code or data to create the program code may be stored in a state in which they may be read by a computer, but require addition of a library (e.g., a dynamic link library), a software development kit (SDK), an API, and the like in order to execute the instructions on a particular computing device or other device. In another example, the program code or data to create the program code may need to be configured (e.g., settings stored, data input, network addresses recorded, and the like) before the program code or data to create the program code can be executed/used in whole or in part. In this example, the program code (or data to create the program code) may be unpacked, configured for proper execution, and stored in a first location with the configuration instructions located in a second location distinct from the first location. The configuration instructions can be initiated by an action, trigger, or instruction that is not co-located in storage or execution location with the instructions enabling the disclosed techniques. Accordingly, the disclosed program code or data to create the program code are intended to encompass such machine readable instructions and/or program(s) or data to create such machine readable instruction and/or programs regardless of the particular format or state of the machine readable instructions and/or program(s) when stored or otherwise at rest or in transit.

The computer program code for carrying out operations of the present disclosure, including, for example, programming instructions, computational logic 2083, instructions 2082, and/or instructions 2081, may be written in any combination of one or more programming languages, including an object oriented programming language such as Python, PyTorch, Ruby, Scala, Smalltalk, Java™, Kotlin, C++, C#, or the like; a procedural programming language, such as the “C” programming language, the Go (or “Golang”) programming language, or the like; a scripting language such as JavaScript, Server-Side JavaScript (SSJS), PHP, Pearl, Python, PyTorch, Ruby or Ruby on Rails, Lua, Torch/Lua with Just-In Time compiler (LuaJIT), Accelerated Mobile Pages Script (AMPscript), VBScript, and/or the like; a markup language such as HTML, XML, wiki markup or Wikitext, Wireless Markup Language (WML), and the like; a data interchange format/definition such as Java Script Object Notion (JSON), Apache® MessagePack™, and the like; a stylesheet language such as Cascading Stylesheets (CSS), extensible stylesheet language (XSL), or the like; an interface definition language (IDL) such as Apache® Thrift, Abstract Syntax Notation One (ASN.1), Google® Protocol Buffers (protobuf), and the like; or some other suitable programming languages including proprietary programming languages and/or development tools, or any other languages or tools as discussed herein. The computer program code for carrying out operations of the present disclosure may also be written in any combination of the programming languages discussed herein. The program code may execute entirely on the system 2000, partly on the system 2000 as a stand-alone software package, partly on the system 2000 and partly on a remote computer (e.g., ADPP 140), or entirely on the remote computer (e.g., ADPP server(s) 145). In the latter scenario, the remote computer may be connected to the system 2000 through any type of network (e.g., network 2001).

The network 2001 may represent the Internet, one or more cellular networks, a LAN, a wide area network (WAN), a wireless LAN (WLAN), TCP/IP-based network, or combinations thereof. In some embodiments, the network 2001 may be associated with a network operator who owns or controls equipment and other elements necessary to provide network-related services, such as one or more base stations or access points, one or more servers for routing digital data or telephone calls (e.g., a core network or backbone network), and the like. Other networks can be used instead of or in addition to the Internet, such as an intranet, an extranet, a virtual private network (VPN), a proprietary and/or enterprise network, a non-TCP/IP based network, and/or the like. The network 2001 comprises computers, network connections among various computers (e.g., between the user system(s) 105, and ADPP 140), and software routines to enable communication between the computers over respective network connections. In this regard, the network 2001 comprises one or more network elements that may include one or more processors, communications systems (e.g., including network interface controllers, one or more transmitters/receivers connected to one or more antennas, and the like), and computer readable media. Examples of such network elements may include wireless access points (WAPs), a home/business/enterprise server (with or without radio frequency (RF) communications circuitry), a router, a switch, a hub, a radio beacon, base stations, picocell or small cell base stations, and/or any other like network device. Connection to the network 2001 may be via a wired or a wireless connection using the various communication protocols discussed infra. More than one network may be involved in a communication session between the illustrated devices. Connection to the network 2001 may require that the computers execute software routines that enable, for example, the seven layers of the OSI model of computer networking or equivalent in a wireless (or cellular) phone network.

### 3. ARTIFICIAL INTELLIGENCE AND MACHINE LEARNING ASPECTS

Machine learning (ML) involves programming computing systems to optimize a performance criterion using example (training) data and/or past experience. ML refers to the use and development of computer systems that are able to learn and adapt without following explicit instructions, by using algorithms and/or statistical models to analyze and draw inferences from patterns in data. ML involves using algorithms to perform specific task(s) without using explicit instructions to perform the specific task(s), but instead relying on learnt patterns and/or inferences. ML uses statistics to build mathematical model(s) (also referred to as “ML models” or simply “models”) in order to make predictions or decisions based on sample data (e.g., training data). The model is defined to have a set of parameters, and learning is the execution of a computer program to optimize the parameters of the model using the training data or past experience. The trained model may be a predictive model that makes predictions based on an input dataset, a descriptive model that gains knowledge from an input dataset, or both predictive and descriptive. Once the model is learned (trained), it can be used to make inferences (e.g., predictions).

ML algorithms perform a training process on a training dataset to estimate an underlying ML model. An ML algorithm is a computer program that learns from experience with respect to some task(s) and some performance measure(s)/metric(s), and an ML model is an object or data structure created after an ML algorithm is trained with training data. In other words, the term “ML model” or “model” may describe the output of an ML algorithm that is trained with training data. After training, an ML model may be used to make predictions on new datasets. Additionally, separately trained AI/ML models can be chained together in a AI/ML pipeline during inference or prediction generation. Although the term “ML algorithm” refers to different concepts than the term “ML model,” these terms may be used interchangeably for the purposes of the present disclosure. Any of the ML techniques discussed herein may be utilized, in whole or in part, and variants and/or combinations thereof, for any of the example embodiments discussed herein.

ML may require, among other things, obtaining and cleaning a dataset, performing feature selection, selecting an ML algorithm, dividing the dataset into training data and testing data, training a model (e.g., using the selected ML algorithm), testing the model, optimizing or tuning the model, and determining metrics for the model. Some of these tasks may be optional or omitted depending on the use case and/or the implementation used.

ML algorithms accept model parameters (or simply “parameters”) and/or hyperparameters that can be used to control certain properties of the training process and the resulting model. Model parameters are parameters, values, characteristics, configuration variables, and/or properties that are learnt during training. Model parameters are usually required by a model when making predictions, and their values define the skill of the model on a particular problem. Hyperparameters at least in some embodiments are characteristics, properties, and/or parameters for an ML process that cannot be learnt during a training process. Hyperparameter are usually set before training takes place, and may be used in processes to help estimate model parameters.

ML techniques generally fall into the following main types of learning problem categories: supervised learning, unsupervised learning, and reinforcement learning. Supervised learning involves building models from a set of data that contains both the inputs and the desired outputs. Unsupervised learning is an ML task that aims to learn a function to describe a hidden structure from unlabeled data. Unsupervised learning involves building models from a set of data that contains only inputs and no desired output labels. Reinforcement learning (RL) is a goal-oriented learning technique where an RL agent aims to optimize a long-term objective by interacting with an environment. Some implementations of AI and ML use data and neural networks (NNs) in a way that mimics the working of a biological brain. An example of such an implementation is shown by FIG. 21.

FIG. 21 illustrates an example NN 2100, which may be suitable for use by one or more of the computing systems (or subsystems) of the various implementations discussed herein, implemented in part by a HW accelerator, and/or the like. The NN 2100 is suitable for use by the ADPP 140 and/or related services discussed previously. Additionally or alternatively, the NN 2100 is suitable for use by one or more of the subsystems and/or the various embodiments disused herein, implemented in part by a hardware accelerator of the ADPP 140 or portions thereof. In some implementations, the NN 2100 may be part of the prediction engine 402, and is configured to determine and/or generate the predicted future states 403 discussed previously.

The NN 2100 may be deep neural network (DNN) used as an artificial brain of a compute node or network of compute nodes to handle very large and complicated observation spaces. Additionally or alternatively, the NN 2100 can be some other type of topology (or combination of topologies), such as a convolution NN (CNN), deep CNN (DCN), graph convolutional network (GCN), graph NN (GNN), recurrent NN (RNN), Long Short Term Memory (LSTM) network, a Deconvolutional NN (DNN), gated recurrent unit (GRU), deep belief NN, a feed forward NN (FFN), a deep FNN (DFF), deep stacking network, Markov chain, perception NN, Bayesian Network (BN) or Bayesian NN (BNN), Dynamic BN (DBN), Linear Dynamical System (LDS), Switching LDS (SLDS), Optical NNs (ONNs), an NN for reinforcement learning (RL) and/or deep RL (DRL), and/or the like. NNs are usually used for supervised learning, but can be used for unsupervised learning and/or RL.

The NN 2100 may encompass a variety of ML techniques where a collection of connected artificial neurons 2110 that (loosely) model neurons in a biological brain that transmit signals to other neurons/nodes 2110. The neurons 2110 may also be referred to as nodes 2110, processing elements (PEs) 2110, or the like. The connections 2120 (or edges 2120) between the nodes 2110 are (loosely) modeled on synapses of a biological brain and convey the signals between nodes 2110. Note that not all neurons 2110 and edges 2120 are labeled in FIG. 21 for the sake of clarity.

Each neuron 2110 has one or more inputs and produces an output, which can be sent to one or more other neurons 2110 (the inputs and outputs may be referred to as “signals”). Inputs to the neurons 2110 of the input layer Lₓ can be feature values of a sample of external data (e.g., input variables xᵢ). The input variables xᵢ can be set as a vector containing relevant data (e.g., observations, ML features, and the like). The inputs to hidden units 2110 of the hidden layers Lₐ, L_{b}, and L_{c} may be based on the outputs of other neurons 2110. The outputs of the final output neurons 2110 of the output layer L_{y} (e.g., output variables yⱼ) include predictions, inferences, and/or accomplish a desired/configured task. The output variables yⱼ may be in the form of determinations, inferences, predictions, and/or assessments. Additionally or alternatively, the output variables yⱼ can be set as a vector containing the relevant data (e.g., determinations, inferences, predictions, assessments, and/or the like).

In the context of ML, an “ML feature” (or simply “feature”) is an individual measureable property or characteristic of a phenomenon being observed. Features are usually represented using numbers/numerals (e.g., integers), strings, variables, ordinals, real-values, categories, and/or the like. Additionally or alternatively, ML features are individual variables, which may be independent variables, based on observable phenomenon that can be quantified and recorded. ML models use one or more features to make predictions or inferences. In some implementations, new features can be derived from old features.

Neurons 2110 may have a threshold such that a signal is sent only if the aggregate signal crosses that threshold. A node 2110 may include an activation function, which defines the output of that node 2110 given an input or set of inputs. Additionally or alternatively, a node 2110 may include a propagation function that computes the input to a neuron 2110 from the outputs of its predecessor neurons 2110 and their connections 2120 as a weighted sum. A bias term can also be added to the result of the propagation function.

The NN 2100 also includes connections 2120, some of which provide the output of at least one neuron 2110 as an input to at least another neuron 2110. Each connection 2120 may be assigned a weight that represents its relative importance. The weights may also be adjusted as learning proceeds. The weight increases or decreases the strength of the signal at a connection 2120.

The neurons 2110 can be aggregated or grouped into one or more layers L where different layers L may perform different transformations on their inputs. In FIG. 21, the NN 2100 comprises an input layer Lₓ, one or more hidden layers Lₐ, L_{b}, and L_{c}, and an output layer L_{y} (where a, b, c, x, and y may be numbers), where each layer L comprises one or more neurons 2110. Signals travel from the first layer (e.g., the input layer L₁), to the last layer (e.g., the output layer L_{y}), possibly after traversing the hidden layers Lₐ, L_{b}, and L_{c} multiple times. In FIG. 21, the input layer Lₐ receives data of input variables xᵢ (where i=1, . . . , p, where p is a number). Hidden layers Lₐ, L_{b}, and L_{c} processes the inputs xᵢ, and eventually, output layer L_{y} provides output variables yⱼ (where j=1, . . . , p′, where p′ is a number that is the same or different than p). In the example of FIG. 21, for simplicity of illustration, there are only three hidden layers Lₐ, L_{b}, and L_{c} in the NN 2100, however, the NN 2100 may include many more (or fewer) hidden layers Lₐ, L_{b}, and L_{c} than are shown.

### 4. EXAMPLE IMPLEMENTATIONS

Additional examples of the presently described method, system, and device embodiments include the following, non-limiting implementations. Each of the following non-limiting examples may stand on its own or may be combined in any permutation or combination with any one or more of the other examples provided below or throughout the present disclosure.

Example A01 includes a method of understanding and implementing compliance requirements within a privacy industry and improving that process with automation via cataloging and taxonomy that allows automation with the use of an adaptive data privacy platform (ADPP), wherein the ADPP creates an ability for end users to self-serve and create their own guidance for understanding and implementing compliance requirements within a privacy industry.

Example B01 includes a method of operating a data privacy platform comprising: determining or identifying a data privacy model related to an organization (org), wherein the data privacy model includes a plurality of privacy frameworks (PFs); and translating and/or converting the PFs into organizational requirements that address various data privacy projects and programs across the org.

Example B02 includes the method of example B01 and/or some other example(s) herein, wherein each PF of the plurality of PFs is a data structure or representation of one or more of a privacy law or regulations applicable to a specific jurisdiction, org-specific privacy policy, contractual obligation, ethical consideration, customer feedback, and/or strategic goals.

Example B03 includes the method of examples B01-B02 and/or some other example(s) herein, wherein the translation/conversion of the PFs into the organizational requirements is accomplished using a combination of metadata tagging, schemas, and filtering based on a conceptual model of the org.

Example B04 includes the method of examples B01-B03 and/or some other example(s) herein, wherein the data privacy system is configurable or operable to assign one or more tasks to org personnel for execution to ensure compliance with the various PFs.

Example B05 includes the method of examples B01-B04 and/or some other example(s) herein, wherein the data privacy system is configurable or operable to execute one or more tasks without human intervention or personnel oversight/approval

Example B06 includes the method of examples B01-B05 and/or some other example(s) herein, wherein each task is based on one or more organizational requirements.

Example B07 includes the method of examples B01-B06 and/or some other example(s) herein, wherein the data privacy system is configurable or operable to align and/or filter org use case(s), org context(s), the plurality of PFs; and output one or more org requirements to achieve compliance with respect to usage of personal information.

Example B08 includes the method of examples B01-B07 and/or some other example(s) herein, wherein subscribing orgs can filter for what is applicable to their org or specific business use cases from a regulations and requirements perspective.

Example B09 includes the method of examples B01-B08 and/or some other example(s) herein, wherein the data privacy system is configurable or operable to identify and manage definitions from one or more PFs that may vary; maintain broader requirements; and present just those definitions that are relevant to the org based on the org use case(s) and/or org context(s).

Example B10 includes the method of examples B01-B09 and/or some other example(s) herein, wherein the data privacy system is configurable or operable to treat different types of requirements related to constraints on collection, usage, or management of personal information; provide an indication of overlapping sets of the org requirements; and manage the overlapping sets of the org requirements as a single privacy program.

Example B11 includes the method of examples B01-B10 and/or some other example(s) herein, wherein the data privacy system is configurable or operable to allow orgs to define custom PFs using a standardized content ingestion process so that the custom PFs can be managed along with non-custom PFs derived directly from laws, regulations, and/or contracts.

Example B12 includes the method of examples B01-B11 and/or some other example(s) herein, wherein the data privacy system is configurable or operable to compare a current state of the org's privacy program and a future privacy program state after a change to any combination PFs, data types, use cases, and jurisdictions that the org operates in.

Example C01 includes a method of managing a privacy program for an organization (org), the method comprising: determining a first set of privacy obligations based on laws and regulations of one or more jurisdictions in which the org operates; determining a second set of privacy obligations based on internal policies and strategic initiatives of the org, third-party contracts with the org, binding corporate rules (BCRs) of the org, and environmental, social and governance (ESG) policies of the org; and generating, for the org, a privacy program that aligns with a set of goals and one or more risk profiles defined by the org.

Example C02 includes the method of example C01 and/or some other example(s) herein, wherein the method includes: generating an org model based on a privacy program configuration (also referred to as a “privacy program definition” or “privacy program template”) defined by the org.

Example C03 includes the method of example C02 and/or some other example(s) herein, wherein generating the privacy program configuration includes: providing a graphical user interface (GUI) including a set of graphical control elements (GCEs), wherein the set of GCEs are configured to allow users related to the org to define respective aspects of the privacy program configuration; and receiving, from one or more client devices via the GUI, one or more messages including the privacy program configuration.

Example C04 includes the method of examples C02-C03 and/or some other example(s) herein, wherein the privacy program configuration indicates one or more locations of customers and employees of the org, types of data collected and used by the org, methods of processing the collected data, and one or more industries associated with the org.

Example C05 includes the method of example C01 and/or some other example(s) herein, wherein the method includes: obtaining an org model, wherein the org model is a representation of the org; and generating a privacy program configuration based on the org model.

Example C06 includes the method of example C05 and/or some other example(s) herein, wherein generating the privacy program configuration includes: providing a graphical user interface (GUI) including a set of graphical control elements (GCEs), wherein the set of GCEs are configured to allow users related to the org to define aspects of the org model; and receiving, from one or more client devices via the GUI, one or more messages including the org model.

Example C07 includes the method of examples C02-C06 and/or some other example(s) herein, wherein the org model indicates one or more locations of customers and employees of the org, types of data collected and used by the org, methods of processing the collected data, and one or more industries associated with the org.

Example C08 includes the method of examples C02-C07 and/or some other example(s) herein, wherein the method includes: refining the org model based on one or more conditions or criteria.

Example C09 includes the method of example C08 and/or some other example(s) herein, wherein the method includes: customizing and/or filtering content relevant to the privacy program.

Example C10 includes the method of examples C08-009 and/or some other example(s) herein, wherein the method includes: splitting out a set of sub-programs from the privacy program.

Example C11 includes the method of example C10 and/or some other example(s) herein, wherein each sub program of the set of sub-programs includes a set of requirements.

Example C12 includes the method of example C11 and/or some other example(s) herein, wherein each requirement of the set of requirements includes a set of tasks for operating aspects of the privacy program.

Example C13 includes the method of examples C10-C12 and/or some other example(s) herein, wherein the method includes: distributing each sub-program to respective computing systems for execution of respective sets of requirements and respective sets of tasks.

Example C14 includes the method of example C13 and/or some other example(s) herein, wherein individual requirements in the respective sets of requirements are customized by at least one task in at least one of the respective sets of tasks.

Example C15 includes the method of examples Cx01-C14 and/or some other example(s) herein, wherein the method includes: tracking, measuring, and reporting on a status of one or more privacy program components, compliance with one or more specific laws, and progress on engagements.

Example C16 includes the method of example C15 and/or some other example(s) herein, wherein the method includes: obtaining data from one or more third party platforms via one or more application programming interfaces (APIs); and performing the tracking, measuring, and reporting based on the obtained data.

Example C17 includes the method of examples C01-C16 and/or some other example(s) herein, wherein the method includes: determining a current state of the privacy program; determining one or more future states; and generating a predicted privacy program based on the current state and the one or more future states.

Example C18 includes the method of example C17 and/or some other example(s) herein, wherein the one or more future states are based on one or more additional frameworks.

Example C19 includes the method of example C18 and/or some other example(s) herein, wherein the one or more additional frameworks are based on a selected future date.

Example C20 includes the method of examples C17-C19 and/or some other example(s) herein, wherein the one or more future states are based on a combination of one or more org contexts.

Example C21 includes the method of examples C17-C20 and/or some other example(s) herein, wherein determining the one or more future states includes: identifying one or more data processing obligations or requirements based on one or more selected criteria.

Example C22 includes the method of examples C17-C21 and/or some other example(s) herein, wherein generating the predicted privacy program includes: comparing the current state with the one or more future states; and determining new or changed requirements based on the comparison.

Example C23 includes the method of examples C12-C22 and/or some other example(s) herein, wherein the method includes: obtaining one or more custom tasks; and updating the privacy program based on the obtained custom tasks.

Example Z00 includes a cloud computing service configured to execute a service as part of one or more cloud applications instantiated on virtualization infrastructure, the service being related to any one or more of examples A01, B01-B12, C01-C23, portions thereof, and/or some other example(s) herein.

Example Z01 includes one or more computer readable media comprising instructions, wherein execution of the instructions by processor circuitry is to cause the processor circuitry to perform the method of any one or more of examples A01, B01-B12, C01-C23, portions thereof, and/or some other example(s) herein.

Example Z02 includes a computer program comprising the instructions of example Z01.

Example Z03 includes an Application Programming Interface defining functions, methods, variables, data structures, and/or protocols for the computer program of example Z02.

Example Z04 includes an API or specification defining functions, methods, variables, data structures, protocols, and the like, defining or involving use of any of any one or more of examples A01, B01-B12, C01-C23, portions thereof, and/or some other example(s) herein.

Example Z05 includes an apparatus comprising circuitry loaded with the instructions of example Z01.

Example Z06 includes an apparatus comprising circuitry operable to run the instructions of example Z01.

Example Z07 includes an integrated circuit comprising one or more of the processor circuitry of example Z01 and the one or more computer readable media of example Z01.

Example Z08 includes a computing system comprising the one or more computer readable media and the processor circuitry of example Z01.

Example Z09 includes an apparatus comprising means for executing the instructions of example Z01.

Example Z10 includes a signal generated as a result of executing the instructions of example Z01.

Example Z11 includes a data unit generated as a result of executing the instructions of example Z01.

Example Z12 includes the data unit of example Z10 and/or some other example(s) herein, wherein the data unit is a datagram, network packet, data frame, data segment, a Protocol Data Unit (PDU), a Service Data Unit (SDU), a message, or a database object.

Example Z13 includes a signal encoded with the data unit of examples Z11 and/or Z12.

Example Z14 includes an electromagnetic signal carrying the instructions of example Z01.

Example Z15 includes an apparatus comprising means for performing the method of any one or more of examples A01, B01-B12, C01-C23, and/or some other example(s) herein.

### 5. TERMINOLOGY

As used herein, the singular forms “a,” “an” and “the” are intended to include plural forms as well, unless the context clearly indicates otherwise. It will be further understood that the terms “comprises” and/or “comprising,” when used in this specification, specific the presence of stated features, integers, steps, operations, elements, and/or components, but do not preclude the presence or addition of one or more other features, integers, steps, operation, elements, components, and/or groups thereof. The phrase “A and/or B” means (A), (B), or (A and B). For the purposes of the present disclosure, the phrase “A, B, and/or C” means (A), (B), (C), (A and B), (A and C), (B and C), or (A, B and C). The description may use the phrases “in an embodiment,” or “In some embodiments,” each of which may refer to one or more of the same or different embodiments. Furthermore, the terms “comprising,” “including,” “having,” and the like, as used with respect to the present disclosure, are synonymous.

The terms “coupled,” “communicatively coupled,” along with derivatives thereof are used herein. The term “coupled” may mean two or more elements are in direct physical or electrical contact with one another, may mean that two or more elements indirectly contact each other but still cooperate or interact with each other, and/or may mean that one or more other elements are coupled or connected between the elements that are said to be coupled with each other. The term “directly coupled” may mean that two or more elements are in direct contact with one another. The term “communicatively coupled” may mean that two or more elements may be in contact with one another by a means of communication including through a wire or other interconnect connection, through a wireless communication channel or ink, and/or the like.

The term “establish” or “establishment” at least in some embodiments refers to (partial or in full) acts, tasks, operations, and the like, related to bringing or the readying the bringing of something into existence either actively or passively (e.g., exposing a device identity or entity identity). Additionally or alternatively, the term “establish” or “establishment” at least in some embodiments refers to (partial or in full) acts, tasks, operations, and the like, related to initiating, starting, or warming communication or initiating, starting, or warming a relationship between two entities or elements (e.g., establish a session, establish a session, and the like). Additionally or alternatively, the term “establish” or “establishment” at least in some embodiments refers to initiating something to a state of working readiness. The term “established” at least in some embodiments refers to a state of being operational or ready for use (e.g., full establishment). Furthermore, any definition for the term “establish” or “establishment” defined in any specification or standard can be used for purposes of the present disclosure and such definitions are not disavowed by any of the aforementioned definitions.

The term “obtain” at least in some embodiments refers to (partial or in full) acts, tasks, operations, and the like, of intercepting, movement, copying, retrieval, or acquisition (e.g., from a memory, an interface, or a buffer), on the original packet stream or on a copy (e.g., a new instance) of the packet stream. Other aspects of obtaining or receiving may involving instantiating, enabling, or controlling the ability to obtain or receive a stream of packets (or the following parameters and templates or template values).

The term “receipt” at least in some embodiments refers to any action (or set of actions) involved with receiving or obtaining an object, data, data unit, and the like, and/or the fact of the object, data, data unit, and the like. being received. The term “receipt” at least in some embodiments refers to an object, data, data unit, and the like, being pushed to a device, system, element, and the like. (e.g., often referred to as a push model), pulled by a device, system, element, (e.g., often referred to as a pull model), and/or the like.

The term “element” at least in some embodiments refers to a unit that is indivisible at a given level of abstraction and has a clearly defined boundary, wherein an element may be any type of entity including, for example, one or more devices, systems, controllers, network elements, modules, and the like, or combinations thereof.

The term “measurement” at least in some embodiments refers to the observation and/or quantification of attributes of an object, event, or phenomenon. Additionally or alternatively, the term “measurement” at least in some embodiments refers to a set of operations having the object of determining a measured value or measurement result, and/or the actual instance or execution of operations leading to a measured value.

The term “metric” at least in some embodiments refers to a standard definition of a quantity, produced in an assessment of performance and/or reliability of the network, which has an intended utility and is carefully specified to convey the exact meaning of a measured value.

The term “signal” at least in some embodiments refers to an observable change in a quality and/or quantity. Additionally or alternatively, the term “signal” at least in some embodiments refers to a function that conveys information about of an object, event, or phenomenon. Additionally or alternatively, the term “signal” at least in some embodiments refers to any time varying voltage, current, or electromagnetic wave that may or may not carry information. The term “digital signal” at least in some embodiments refers to a signal that is constructed from a discrete set of waveforms of a physical quantity so as to represent a sequence of discrete values.

The term “identifier” at least in some embodiments refers to a value, or a set of values, that uniquely identify an identity in a certain scope. Additionally or alternatively, the term “identifier” at least in some embodiments refers to a sequence of characters that identifies or otherwise indicates the identity of a unique object, element, or entity, or a unique class of objects, elements, or entities. Additionally or alternatively, the term “identifier” at least in some embodiments refers to a sequence of characters used to identify or refer to an application, program, session, object, element, entity, variable, set of data, and/or the like. The “sequence of characters” mentioned previously at least in some embodiments refers to one or more names, labels, words, numbers, letters, symbols, and/or any combination thereof. Additionally or alternatively, the term “identifier” at least in some embodiments refers to a name, address, label, distinguishing index, and/or attribute. Additionally or alternatively, the term “identifier” at least in some embodiments refers to an instance of identification. The term “persistent identifier” at least in some embodiments refers to an identifier that is reused by a device or by another device associated with the same person or group of persons for an indefinite period.

The term “identification” at least in some embodiments refers to a process of recognizing an identity as distinct from other identities in a particular scope or context, which may involve processing identifiers to reference an identity in an identity database

The term “circuitry” at least in some embodiments refers to a circuit or system of multiple circuits configured to perform a particular function in an electronic device. The circuit or system of circuits may be part of, or include one or more hardware components, such as a logic circuit, a processor (shared, dedicated, or group) and/or memory (shared, dedicated, or group), an application-specific integrated circuit (ASIC), field-programmable gate array (FPGA), programmable logic controller (PLC), system on chip (SoC), system in package (SiP), multi-chip package (MCP), digital signal processor (DSP), and the like, that are configured to provide the described functionality. In addition, the term “circuitry” may also refer to a combination of one or more hardware elements with the program code used to carry out the functionality of that program code. Some types of circuitry may execute one or more software or firmware programs to provide at least some of the described functionality. Such a combination of hardware elements and program code may be referred to as a particular type of circuitry.

The term “processor circuitry” at least in some embodiments refers to, is part of, or includes circuitry capable of sequentially and automatically carrying out a sequence of arithmetic or logical operations, or recording, storing, and/or transferring digital data. The term “processor circuitry” at least in some embodiments refers to one or more application processors, one or more baseband processors, a physical CPU, a single-core processor, a dual-core processor, a triple-core processor, a quad-core processor, and/or any other device capable of executing or otherwise operating computer-executable instructions, such as program code, software modules, and/or functional processes. The terms “application circuitry” and/or “baseband circuitry” may be considered synonymous to, and may be referred to as, “processor circuitry.”

The term “interface circuitry” at least in some embodiments refers to, is part of, or includes circuitry that enables the exchange of information between two or more components or devices. The term “interface circuitry” at least in some embodiments refers to one or more hardware interfaces, for example, buses, I/O interfaces, peripheral component interfaces, network interface cards, and/or the like.

The term “memory” and/or “memory circuitry” at least in some embodiments refers to one or more hardware devices for storing data, including RAM, MRAM, PRAM, DRAM, and/or SDRAM, core memory, ROM, magnetic disk storage mediums, optical storage mediums, flash memory devices or other machine readable mediums for storing data. The term “computer-readable medium” may include, but is not limited to, memory, portable or fixed storage devices, optical storage devices, and various other mediums capable of storing, containing or carrying instructions or data. Example embodiments described herein may be implemented by computer hardware, software, firmware, middleware, microcode, hardware description languages, or any combination thereof. When implemented in software, firmware, middleware or microcode, the program code or code segments to perform the necessary tasks may be stored in a machine or computer readable medium. A code segment may represent a procedure, a function, a subprogram, a program, a routine, a subroutine, a module, program code, a software package, a class, or any combination of instructions, data structures, program statements, and/or any other type of computer-executable instructions or combinations thereof. The computer-executable instructions for the disclosed embodiments and implementations can be realized in any combination of one or more programming languages that can be executed on a computer system or like device such as, for example, an object oriented programming language such as Python, PyTorch, Ruby, Scala, Smalltalk, Java™, C++, C#, or the like; a procedural programming language, such as the “C” programming language, Go (or “Golang”), or the like; a scripting language such as JavaScript, Server-Side JavaScript (SSJS), PHP, Pearl, Python, PyTorch, Ruby or Ruby on Rails, Lua, Torch/Lua with Just-In Time compiler (LuaJIT), Accelerated Mobile Pages Script (AMPscript), VBScript, and/or the like; a markup language such as Hypertext Markup Language (HTML), Extensible Markup Language (XML), wiki markup or Wikitext, Wireless Markup Language (WML), and the like; a data interchange format/definition such as Java Script Object Notion (JSON), Apache® MessagePack™, and the like; a stylesheet language such as Cascading Stylesheets (CSS), extensible stylesheet language (XSL), or the like; an interface definition language (IDL) such as Apache® Thrift, Abstract Syntax Notation One (ASN.1), Google® Protocol Buffers (protobuf), and the like; or some other suitable programming languages including proprietary programming languages and/or development tools, or any other languages or tools as discussed herein.

The term “device” at least in some embodiments refers to a physical entity embedded inside, or attached to, another physical entity in its vicinity, with capabilities to convey digital information from or to that physical entity.

The term “entity” at least in some embodiments refers to a distinct component of an architecture or device, or information transferred as a payload.

The term “compute node” or “compute device” at least in some embodiments refers to an identifiable entity implementing an aspect of computing operations, whether part of a larger system, distributed collection of systems, or a standalone apparatus. In some examples, a compute node may be referred to as a “computing device”, “computing system”, or the like, whether in operation as a client, server, or intermediate entity. Specific implementations of a compute node may be incorporated into a server, base station, gateway, road side unit, on-premise unit, user equipment, end consuming device, appliance, or the like.

The term “computer system” at least in some embodiments refers to any type interconnected electronic devices, computer devices, or components thereof. Additionally, the terms “computer system” and/or “system” at least in some embodiments refer to various components of a computer that are communicatively coupled with one another. Furthermore, the term “computer system” and/or “system” at least in some embodiments refer to multiple computer devices and/or multiple computing systems that are communicatively coupled with one another and configured to share computing and/or networking resources.

Examples of “compute nodes”, “computer devices,” “computer systems,” and/or the like include cellular phones, smartphones, feature phones, tablet personal computers, wearable computing devices, an autonomous sensors, laptop computers, desktop personal computers, video game consoles, digital media players, handheld messaging devices, personal data assistants, electronic book readers, augmented reality devices, server computer devices (e.g., stand-alone, rack-mounted, blade, and the like), cloud computing services/systems, network elements, in-vehicle infotainment (IVI), in-car entertainment (ICE) devices, an Instrument Cluster (IC), head-up display (HUD) devices, onboard diagnostic (OBD) devices, dashtop mobile equipment (DME), mobile data terminals (MDTs), Electronic Engine Management System (EEMS), electronic/engine control units (ECUs), electronic/engine control modules (ECMs), embedded systems, microcontrollers, control modules, engine management systems (EMS), networked or “smart” appliances, machine-type communications (MTC) devices, machine-to-machine (M2M), Internet of Things (IoT) devices, and/or any other like electronic devices. Moreover, the term “vehicle-embedded computer device” may refer to any computer device and/or computer system physically mounted on, built in, or otherwise embedded in a vehicle.

The term “server” at least in some embodiments refers to a computing device or system, including processing hardware and/or process space(s), an associated storage medium such as a memory device or database, and, in some instances, suitable application(s) as is known in the art. The terms “server system” and “server” may be used interchangeably herein, and these terms at least in some embodiments refers to one or more computing system(s) that provide access to a pool of physical and/or virtual resources. The various servers discussed herein include computer devices with rack computing architecture component(s), tower computing architecture component(s), blade computing architecture component(s), and/or the like. The servers may represent a cluster of servers, a server farm, a cloud computing service, or other grouping or pool of servers, which may be located in one or more datacenters. The servers may also be connected to, or otherwise associated with, one or more data storage devices (not shown). Moreover, the servers may include an operating system (OS) that provides executable program instructions for the general administration and operation of the individual server computer devices, and may include a computer-readable medium storing instructions that, when executed by a processor of the servers, may allow the servers to perform their intended functions. Suitable implementations for the OS and general functionality of servers are known or commercially available, and are readily implemented by persons having ordinary skill in the art.

The term “platform” at least in some embodiments refers to an environment in which instructions, program code, software elements, and the like can be executed or otherwise operate, and examples of such an environment include an architecture (e.g., a motherboard, a computing system, and/or the like), one or more hardware elements (e.g., embedded systems, and the like), a cluster of compute nodes, a set of distributed compute nodes or network, an operating system, a virtual machine (VM), a virtualization container, a software framework, a client application (e.g., web browser or the like) and associated application programming interfaces, a cloud computing service (e.g., platform as a service (PaaS)), or other underlying software executed with instructions, program code, software elements, and the like.

The term “architecture” at least in some embodiments refers to a computer architecture or a network architecture. The term “computer architecture” at least in some embodiments refers to a physical and logical design or arrangement of software and/or hardware elements in a computing system or platform including technology standards for interacts therebetween. The term “network architecture” at least in some embodiments refers to a physical and logical design or arrangement of software and/or hardware elements in a network including communication protocols, interfaces, and media transmission.

The term “appliance,” “computer appliance,” and the like, at least in some embodiments refers to a computer device or computer system with program code (e.g., software or firmware) that is specifically designed to provide a specific computing resource. The term “virtual appliance” at least in some embodiments refers to a virtual machine image to be implemented by a hypervisor-equipped device that virtualizes or emulates a computer appliance or otherwise is dedicated to provide a specific computing resource. The term “security appliance”, “firewall”, and the like at least in some embodiments refers to a computer appliance designed to protect computer networks from unwanted traffic and/or malicious attacks. The term “policy appliance” at least in some embodiments refers to technical control and logging mechanisms to enforce or reconcile policy rules (information use rules) and to ensure accountability in information systems.

The term “gateway” at least in some embodiments refers to a network appliance that allows data to flow from one network to another network, or a computing system or application configured to perform such tasks. Examples of gateways include IP gateways, Internet-to-Orbit (I2O) gateways, IoT gateways, cloud storage gateways, and/or the like.

The term “network access node” or “NAN” at least in some embodiments refers to a network element in a radio access network (RAN) responsible for the transmission and reception of radio signals in one or more cells or coverage areas to or from a UE or station. A “network access node” or “NAN” can have an integrated antenna or may be connected to an antenna array by feeder cables. Additionally or alternatively, a “network access node” or “NAN” may include specialized digital signal processing, network function hardware, and/or compute hardware to operate as a compute node. In some examples, a “network access node” or “NAN” may be split into multiple functional blocks operating in software for flexibility, cost, and performance. In some examples, a “network access node” or “NAN” may be a base station (e.g., an evolved Node B (eNB) or a next generation Node B (gNB)), an access point and/or wireless network access point, router, switch, hub, radio unit or remote radio head, Transmission Reception Point (TRxP), a gateway device (e.g., Residential Gateway, Wireline 5G Access Network, Wireline 5G Cable Access Network, Wireline BBF Access Network, and the like), network appliance, and/or some other network access hardware. The term “cell” at least in some embodiments refers to a radio network object that can be uniquely identified by a UE from an identifier (e.g., cell ID) that is broadcasted over a geographical area from a network access node (NAN). Additionally or alternatively, the term “cell” at least in some embodiments refers to a geographic area covered by a NAN.

The term “cloud computing” or “cloud” at least in some embodiments refers to a paradigm for enabling network access to a scalable and elastic pool of shareable computing resources with self-service provisioning and administration on-demand and without active management by users. Cloud computing provides cloud computing services (or cloud services), which are one or more capabilities offered via cloud computing that are invoked using a defined interface (e.g., an API or the like). The term “cloud service provider” (or CSP) indicates an organization which operates typically large-scale “cloud” resources comprised of centralized, regional, and Edge data centers (e.g., as used in the context of the public cloud). In other examples, a CSP may also be referred to as a Cloud Service Operator (CSO). References to “cloud computing” generally refer to computing resources and services offered by a CSP or a CSO, at remote locations with at least some increased latency, distance, or constraints relative to Edge computing. The term “compute resource” or simply “resource” at least in some embodiments refers to any physical or virtual component, or usage of such components, of limited availability within a computer system or network. Examples of computing resources include usage/access to, for a period of time, servers, processor(s), storage equipment, memory devices, memory areas, networks, electrical power, input/output (peripheral) devices, mechanical devices, network connections (e.g., channels/links, ports, network sockets, and the like), operating systems, virtual machines (VMs), software/applications, computer files, and/or the like. A “hardware resource” at least in some embodiments refers to compute, storage, and/or network resources provided by physical hardware element(s). A “virtualized resource” at least in some embodiments refers to compute, storage, and/or network resources provided by virtualization infrastructure to an application, device, system, and the like. The term “network resource” or “communication resource” at least in some embodiments refers to resources that are accessible by computer devices/systems via a communications network. The term “system resources” at least in some embodiments refers to any kind of shared entities to provide services, and may include computing and/or network resources. System resources may be considered as a set of coherent functions, network data objects or services, accessible through a server where such system resources reside on a single host or multiple hosts and are clearly identifiable.

The term “virtualization container”, “execution container”, or “container” at least in some embodiments refers to a partition of a compute node that provides an isolated virtualized computation environment. The term “OS container” at least in some embodiments refers to a virtualization container utilizing a shared Operating System (OS) kernel of its host, where the host providing the shared OS kernel can be a physical compute node or another virtualization container. Additionally or alternatively, the term “container” at least in some embodiments refers to a standard unit of software (or a package) including code and its relevant dependencies, and/or an abstraction at the application layer that packages code and dependencies together. Additionally or alternatively, the term “container” or “container image” at least in some embodiments refers to a lightweight, standalone, executable software package that includes everything needed to run an application such as, for example, code, runtime environment, system tools, system libraries, and settings. The term “virtual machine” or “VM” at least in some embodiments refers to a virtualized computation environment that behaves in a same or similar manner as a physical computer and/or a server. The term “hypervisor” at least in some embodiments refers to a software element that partitions the underlying physical resources of a compute node, creates VMs, manages resources for VMs, and isolates individual VMs from each other.

The term “protocol” at least in some embodiments refers to a predefined procedure or method of performing one or more operations. Additionally or alternatively, the term “protocol” at least in some embodiments refers to a common means for unrelated objects to communicate with each other (sometimes also called interfaces). The term “communication protocol” at least in some embodiments refers to a set of standardized rules or instructions implemented by a communication device and/or system to communicate with other devices and/or systems, including instructions for packetizing/depacketizing data, modulating/demodulating signals, implementation of protocols stacks, and/or the like. In various implementations, a “protocol” and/or a “communication protocol” may be represented using a protocol stack, a finite state machine (FSM), and/or any other suitable data structure.

The term “application layer” at least in some embodiments refers to an abstraction layer that specifies shared communications protocols and interfaces used by hosts in a communications network. Additionally or alternatively, the term “application layer” at least in some embodiments refers to an abstraction layer that interacts with software applications that implement a communicating component, and may include identifying communication partners, determining resource availability, and synchronizing communication. Examples of application layer protocols include Hypertext Transfer Protocol (HTTP), HTTP secure (HTTPs), File Transfer Protocol (FTP), Dynamic Host Configuration Protocol (DHCP), Internet Message Access Protocol (IMAP), Lightweight Directory Access Protocol (LDAP), MQTT, Remote Authentication Dial-In User Service (RADIUS), Diameter protocol, Extensible Authentication Protocol (EAP), RDMA over Converged Ethernet version 2 (RoCEv2), Real-time Transport Protocol (RTP), RTP Control Protocol (RTCP), Real Time Streaming Protocol (RTSP), Small Computer System Interface (SCSI), Skinny Client Control Protocol (SCCP), Session Initiation Protocol (SIP), Session Description Protocol (SDP), Simple Mail Transfer Protocol (SMTP), Simple Network Management Protocol (SNMP), Simple Service Discovery Protocol (SSDP), Secure Shell (SSH), Secure RTP (SRTP), Internet SCSI (iSCSI), iSCSI Extensions for RDMA (iSER), Transport Layer Security (TLS), voice over IP (VoIP), Virtual Private Network (VPN), Extensible Messaging and Presence Protocol (XMPP), WebSocket, Wireless Application Messaging Protocol (WAMP), and/or the like.

The term “transport layer” at least in some embodiments refers to a protocol layer that provides end-to-end (e2e) communication services such as, for example, connection-oriented communication, reliability, flow control, and multiplexing. Examples of transport layer protocols include datagram congestion control protocol (DCCP), fibre channel protocol (FBC), Generic Routing Encapsulation (GRE), GPRS Tunneling (GTP), Micro Transport Protocol (μTP), Multipath TCP (MPTCP), MultiPath QUIC (MPQUIC), Multipath UDP (MPUDP), Quick UDP Internet Connections (QUIC), Remote Direct Memory Access (RDMA), Resource Reservation Protocol (RSVP), Stream Control Transmission Protocol (SCTP), transmission control protocol (TCP), user datagram protocol (UDP), and/or the like.

The term “network layer” at least in some embodiments refers to a protocol layer that includes means for transferring network packets from a source to a destination via one or more networks. Additionally or alternatively, the term “network layer” at least in some embodiments refers to a protocol layer that is responsible for packet forwarding and/or routing through intermediary nodes. Additionally or alternatively, the term “network layer” or “internet layer” at least in some embodiments refers to a protocol layer that includes interworking methods, protocols, and specifications that are used to transport network packets across a network. As examples, the network layer protocols include internet protocol (IP), IP security (IPsec), Internet Control Message Protocol (ICMP), Internet Group Management Protocol (IGMP), Open Shortest Path First protocol (OSPF), Routing Information Protocol (RIP), RDMA over Converged Ethernet version 2 (RoCEv2), Subnetwork Access Protocol (SNAP), and/or some other internet or network protocol layer.

The term “link layer” or “data link layer” at least in some embodiments refers to a protocol layer that transfers data between nodes on a network segment across a physical layer. Examples of link layer protocols include logical link control (LLC), medium access control (MAC), Ethernet, RDMA over Converged Ethernet version 1 (RoCEv1), and/or the like.

The term “medium access control protocol”, “MAC protocol”, or “MAC” at least in some embodiments refers to a protocol that governs access to the transmission medium in a network, to enable the exchange of data between stations in a network. Additionally or alternatively, the term “medium access control layer”, “MAC layer”, or “MAC” at least in some embodiments refers to a protocol layer or sublayer that performs functions to provide frame-based, connectionless-mode (e.g., datagram style) data transfer between stations or devices.

The term “radio technology” at least in some embodiments refers to technology for wireless transmission and/or reception of electromagnetic radiation for information transfer. The term “radio access technology” or “RAT” at least in some embodiments refers to the technology used for the underlying physical connection to a radio based communication network.

The term “RAT type” at least in some embodiments may identify a transmission technology and/or communication protocol used in an access network, for example, new radio (NR), Long Term Evolution (LTE), narrowband IoT (NB-IOT), untrusted non-3GPP, trusted non-3GPP, trusted Institute of Electrical and Electronics Engineers (IEEE) 802 (e.g., [IEEE80211]; see also IEEE Standard for Local and Metropolitan Area Networks: Overview and Architecture, IEEE Std 802-2014, pp. 1-74 (30 Jun. 2014) (“REEE8021”), the contents of which is hereby incorporated by reference in its entirety), non-3GPP access, MuLTEfire, WiMAX, wireline, wireline-cable, wireline broadband forum (wireline-BBF), and the like. Examples of RATs and/or wireless communications protocols include Advanced Mobile Phone System (AMPS) technologies such as Digital AMPS (D-AMPS), Total Access Communication System (TACS) (and variants thereof such as Extended TACS (ETACS), and the like); Global System for Mobile Communications (GSM) technologies such as Circuit Switched Data (CSD), High-Speed CSD (HSCSD), General Packet Radio Service (GPRS), and Enhanced Data Rates for GSM Evolution (EDGE); Third Generation Partnership Project (3GPP) technologies including, for example, Universal Mobile Telecommunications System (UMTS) (and variants thereof such as UMTS Terrestrial Radio Access (UTRA), Wideband Code Division Multiple Access (W-CDMA), Freedom of Multimedia Access (FOMA), Time Division-Code Division Multiple Access (TD-CDMA), Time Division-Synchronous Code Division Multiple Access (TD-SCDMA), and the like), Generic Access Network (GAN)/Unlicensed Mobile Access (UMA), High Speed Packet Access (HSPA) (and variants thereof such as HSPA Plus (HSPA+), and the like), Long Term Evolution (LTE) (and variants thereof such as LTE-Advanced (LTE-A), Evolved UTRA (E-UTRA), LTE Extra, LTE-A Pro, LTE LAA, MuLTEfire, and the like), Fifth Generation (5G) or New Radio (NR), and the like; ETSI technologies such as High Performance Radio Metropolitan Area Network (HiperMAN) and the like; IEEE technologies such as [IEEE802] and/or WiFi (e.g., IEEE Standard for Information Technology—Telecommunications and Information Exchange between Systems—Local and Metropolitan Area Networks—Specific Requirements—Part 11: Wireless LAN Medium Access Control (MAC) and Physical Layer (PHY) Specifications, IEEE Std 802.11-2020, pp. 1-4379 (26 Feb. 2021) (“REEE802111”) and variants thereof), WiMAX (e.g., IEEE Standard for Air Interface for Broadband Wireless Access Systems, IEEE Std 802.16-2017, pp. 1-2726 (2 Mar. 2018) (“[WiMAX]”) and variants thereof), Mobile Broadband Wireless Access (MBWA)/iBurst (e.g., IEEE 802.20 and variants thereof), and the like; Integrated Digital Enhanced Network (iDEN) (and variants thereof such as Wideband Integrated Digital Enhanced Network (WiDEN); millimeter wave (mmWave) technologies/standards (e.g., wireless systems operating at 10-300 GHz and above such as 3GPP 5G, Wireless Gigabit Alliance (WiGig) standards (e.g., IEEE 802.11ad, IEEE 802.11ay, and the like); short-range and/or wireless personal area network (WPAN) technologies/standards such as Bluetooth (and variants thereof such as Bluetooth 5.3, Bluetooth Low Energy (BLE), and the like), IEEE 802.15 technologies/standards (e.g., IEEE Standard for Low-Rate Wireless Networks, IEEE Std 802.15.4-2020, pp. 1-800 (23 Jul. 2020) (“[IEEE802154]”), ZigBee, Thread, IPv6 over Low power WPAN (6LoWPAN), WirelessHART, MiWi, ISA100.11a, IEEE Standard for Local and metropolitan area networks—Part 15.6: Wireless Body Area Networks, IEEE Std 802.15.6-2012, pp. 1-271 (29 Feb. 2012), WiFi-direct, ANT/ANT+, Z-Wave, 3GPP Proximity Services (ProSe), Universal Plug and Play (UPnP), low power Wide Area Networks (LPWANs), Long Range Wide Area Network (LoRA or LoRaWAN™), and the like; optical and/or visible light communication (VLC) technologies/standards such as IEEE Standard for Local and metropolitan area networks—Part 15.7: Short-Range Optical Wireless Communications, IEEE Std 802.15.7-2018, pp. 1-407 (23 Apr. 2019), and the like; V2X communication including 3GPP cellular V2X (C-V2X), Wireless Access in Vehicular Environments (WAVE) (IEEE Standard for Information technology—Local and metropolitan area networks—Specific requirements—Part 11: Wireless LAN Medium Access Control (MAC) and Physical Layer (PHY) Specifications Amendment 6: Wireless Access in Vehicular Environments, IEEE Std 802.11p-2010, pp. 1-51 (15 Jul. 2010) (“[IEEE80211p]”), which is now part of [IEEE80211]), IEEE 802.11bd (e.g., for vehicular ad-hoc environments), Dedicated Short Range Communications (DSRC), Intelligent-Transport-Systems (ITS) (including the European ITS-G5, ITS-GSB, ITS-GSC, and the like); Sigfox; Mobitex; 3GPP2 technologies such as cdmaOne (2G), Code Division Multiple Access 2000 (CDMA 2000), and Evolution-Data Optimized or Evolution-Data Only (EV-DO); Push-to-talk (PTT), Mobile Telephone System (MTS) (and variants thereof such as Improved MTS (IMTS), Advanced MTS (AMTS), and the like); Personal Digital Cellular (PDC); Personal Handy-phone System (PHS), Cellular Digital Packet Data (CDPD); Cellular Digital Packet Data (CDPD); DataTAC; Digital Enhanced Cordless Telecommunications (DECT) (and variants thereof such as DECT Ultra Low Energy (DECT ULE), DECT-2020, DECT-5G, and the like); Ultra High Frequency (UHF) communication; Very High Frequency (VHF) communication; and/or any other suitable RAT or protocol. In addition to the aforementioned RATs/standards, any number of satellite uplink technologies may be used for purposes of the present disclosure including, for example, radios compliant with standards issued by the International Telecommunication Union (ITU), or the ETSI, among others. The examples provided herein are thus understood as being applicable to various other communication technologies, both existing and not yet formulated.

The term “flow” at least in some embodiments refers to a sequence of data and/or data units (e.g., datagrams, packets, or the like) from a source entity/element to a destination entity/element. Additionally or alternatively, the terms “flow” or “traffic flow” at least in some embodiments refer to an artificial and/or logical equivalent to a call, connection, or link. Additionally or alternatively, the terms “flow” or “traffic flow” at least in some embodiments refer to a sequence of packets sent from a particular source to a particular unicast, anycast, or multicast destination that the source desires to label as a flow; from an upper-layer viewpoint, a flow may include of all packets in a specific transport connection or a media stream, however, a flow is not necessarily 1:1 mapped to a transport connection. Additionally or alternatively, the terms “flow” or “traffic flow” at least in some embodiments refer to a set of data and/or data units (e.g., datagrams, packets, or the like) passing an observation point in a network during a certain time interval. Additionally or alternatively, the term “flow” at least in some embodiments refers to a user plane data link that is attached to an association. Examples are circuit switched phone call, voice over IP call, reception of an SMS, sending of a contact card, PDP context for internet access, demultiplexing a TV channel from a channel multiplex, calculation of position coordinates from geopositioning satellite signals, and the like. For purposes of the present disclosure, the terms “traffic flow”, “data flow”, “dataflow”, “packet flow”, “network flow”, and/or “flow” may be used interchangeably even though these terms at least in some embodiments refers to different concepts. The term “dataflow” or “data flow” at least in some embodiments refers to the movement of data through a system including software elements, hardware elements, or a combination of both software and hardware elements. Additionally or alternatively, the term “dataflow” or “data flow” at least in some embodiments refers to a path taken by a set of data from an origination or source to destination that includes all nodes through which the set of data travels.

The term “stream” at least in some embodiments refers to a sequence of data elements made available over time. At least in some embodiments, functions that operate on a stream, which may produce another stream, are referred to as “filters,” and can be connected in pipelines, analogously to function composition; filters may operate on one item of a stream at a time, or may base an item of output on multiple items of input, such as a moving average. Additionally or alternatively, the term “stream” or “streaming” at least in some embodiments refers to a manner of processing in which an object is not represented by a complete logical data structure of nodes occupying memory proportional to a size of that object, but are processed “on the fly” as a sequence of events.

The term “service” at least in some embodiments refers to the provision of a discrete function within a system and/or environment. Additionally or alternatively, the term “service” at least in some embodiments refers to a functionality or a set of functionalities that can be reused. Additionally or alternatively, the term “service” at least in some embodiments includes or involves the retrieval of specified information or the execution of a set of operations.

The term “session” at least in some embodiments refers to a temporary and interactive information interchange between two or more communicating devices, two or more application instances, between a computer and user, and/or between any two or more entities or elements. Additionally or alternatively, the term “session” at least in some embodiments refers to a connectivity service or other service that provides or enables the exchange of data between two entities or elements. The term “network session” at least in some embodiments refers to a session between two or more communicating devices over a network. The term “web session” at least in some embodiments refers to session between two or more communicating devices over the Internet or some other network. The term “session identifier,” “session ID,” or “session token” at least in some embodiments refers to a piece of data that is used in network communications to identify a session and/or a series of message exchanges.

The term “network address” at least in some embodiments refers to an identifier for a node or host in a computer network, and may be a unique identifier across a network and/or may be unique to a locally administered portion of the network. Examples of network addresses include a Closed Access Group Identifier (CAG-ID), Bluetooth hardware device address (BD_ADDR), a cellular network address (e.g., Access Point Name (APN), AMF identifier (ID), AF-Service-Identifier, Edge Application Server (EAS) ID, Data Network Access Identifier (DNAI), Data Network Name (DNN), EPS Bearer Identity (EBI), Equipment Identity Register (EIR) and/or 5G-EIR, Extended Unique Identifier (EUI), Group ID for Network Selection (GIN), Generic Public Subscription Identifier (GPSI), Globally Unique AMF Identifier (GUAMI), Globally Unique Temporary Identifier (GUTI) and/or 5G-GUTI, Radio Network Temporary Identifier (RNTI) (and/or variants thereof), International Mobile Equipment Identity (IMEI), IMEI Type Allocation Code (IMEA/TAC), International Mobile Subscriber Identity (IMSI), IMSI software version (IMSISV), permanent equipment identifier (PEI), Local Area Data Network (LADN) DNN, Mobile Subscriber Identification Number (MSIN), Mobile Subscriber/Station ISDN Number (MSISDN), Network identifier (NID), Network Slice Instance (NSI) ID, Permanent Equipment Identifier (PEI), Public Land Mobile Network (PLMN) ID, QoS Flow ID (QFI) and/or 5G QoS Identifier (5QI), RAN ID, Routing Indicator, SMS Function (SMSF) ID, Stand-alone Non-Public Network (SNPN) ID, Subscription Concealed Identifier (SUCI), Subscription Permanent Identifier (SUPI), Temporary Mobile Subscriber Identity (TMSI) and variants thereof, UE Access Category and Identity, and/or other cellular network related identifiers), an email address, Enterprise Application Server (EAS) ID, an endpoint address, an Electronic Product Code (EPC) as defined by the EPCglobal Tag Data Standard, a Fully Qualified Domain Name (FQDN), an internet protocol (IP) address in an IP network (e.g., IP version 4 (Ipv4), IP version 6 (IPv6), and the like), an internet packet exchange (IPX) address, Local Area Network (LAN) ID, a media access control (MAC) address, personal area network (PAN) ID, a port number (e.g., Transmission Control Protocol (TCP) port number, User Datagram Protocol (UDP) port number), QUIC connection ID, RFID tag, service set identifier (SSID) and variants thereof, telephone numbers in a public switched telephone network (PTSN), a socket address, a tag, universally unique identifier (UUID) (e.g., as specified in ISO/IEC 11578:1996), a Universal Resource Locator (URL), Universal Resource Identifier (URI), Virtual LAN (VLAN) ID, an X.21 address, an X.25 address, Zigbee® ID, Zigbee® Device Network ID, and/or any other suitable network address and components thereof. The term “application identifier”, “application ID”, or “app ID” at least in some embodiments refers to an identifier that can be mapped to a specific application or application instance.

The term “universally unique identifier” or “UUID” refers to a number used to identify information in computer systems. Usually, UUIDs are 128-bit numbers. UUIDs are generally represented as 32 hexadecimal digits displayed in five groups separated by hyphens in the following format: “xxxxxxxx-xxxx-Mxxx-Nxxx-xxxxxxxxxxxx” where the four-bit M and the 1 to 3 bit N fields code the format of the UUID itself. The term “universally unique identifier” or “UUID” may alternatively be referred to a “globally unique identifier” or “GUID”.

The term “analytics” at least in some embodiments refers to the discovery, interpretation, and communication of meaningful patterns in data.

The term “application” at least in some embodiments refers to a computer program designed to carry out a specific task other than one relating to the operation of the computer itself. Additionally or alternatively, term “application” at least in some embodiments refers to a complete and deployable package, environment to achieve a certain function in an operational environment.

The term “process” at least in some embodiments refers to an instance of a computer program that is being executed by one or more threads. In some implementations, a process may be made up of multiple threads of execution that execute instructions concurrently.

The term “thread of execution” or “thread” at least in some embodiments refers to the smallest sequence of programmed instructions that can be managed independently by a scheduler. The term “lightweight thread” or “light-weight thread” at least in some embodiments refers to a computer program process and/or a thread that can share address space and resources with one or more other threads, reducing context switching time during execution. In some implementations, term “lightweight thread” or “light-weight thread” can be referred to or used interchangeably with the terms “picothread”, “strand”, “tasklet”, “fiber”, “task”, or “work item” even though these terms may refer to difference concepts. The term “fiber” at least in some embodiments refers to a lightweight thread that shares address space with other fibers, and uses cooperative multitasking (whereas threads typically use preemptive multitasking).

The term “instantiate” or “instantiation” at least in some embodiments refers to the creation of an instance. The term “instance” at least in some embodiments refers to a concrete occurrence of an object, which may occur, for example, during execution of program code.

The term “application programming interface” or “API” at least in some embodiments refers to a set of subroutine definitions, communication protocols, and tools for building software. Additionally or alternatively, the term “application programming interface” or “API” at least in some embodiments refers to a set of clearly defined methods of communication among various components. An API may be for a web-based system, operating system, database system, computer hardware, or software library.

The term “reference” at least in some embodiments refers to data useable to locate other data and may be implemented a variety of ways (e.g., a pointer, an index, a handle, a key, an identifier, a hyperlink, and/or the like).

The term “context” at least in some embodiments refers to a set of data used by a task, process, thread, or the like. Additionally or alternatively, the term “context”, “scope”, or “environment” at least in some embodiments refers to a set of all name bindings that are valid within a part of a program and/or at a given point in a program. Additionally or alternatively, the term “context” at least in some embodiments refers to a block or set of data that includes information about a user, application, device, session, task, entity, element, and/or the like. Additionally or alternatively the term “context” at least in some embodiments refers to a network-specific and/or application-specific runtime data maintained by an application or service, which is associated with a user of the application or service, a corresponding user app or client app, or a device or system that operates and/or consumes the application or service. Additionally or alternatively, the term “context” at least in some embodiments refers to any relevant information used to maintain a session and/or services towards an individual user, device, system, or service consumer. The term “context switch” at least in some embodiments refers to the process of storing the state of a process, thread, session, or the like, so that it can be restored to resume execution at a later point.

The term “algorithm” at least in some embodiments refers to an unambiguous specification of how to solve a problem or a class of problems by performing calculations, input/output operations, data processing, automated reasoning tasks, and/or the like.

The term “abstract data type” at least in some embodiments refers to a mathematical model for data types, where a data type is defined by its behavior (semantics) from the point of view of a user of the data, specifically in terms of possible values, possible operations on data of this type, and the behavior of these operations.

The term “metadata” at least in some embodiments refers to data that provides or indicates information about other data. The term “descriptive metadata” at least in some embodiments refers to descriptive information about a resource (e.g., title, abstract, author, keywords, and the like), which may be used for discovery and identification. The term “structural metadata” at least in some embodiments refers to information or data about containers of data and indicates how compound objects are put together, for example, how pages are ordered to form chapters; examples include descriptions of the types, versions, relationships and other characteristics of digital materials. The term “administrative metadata” at least in some embodiments refers to information to help manage a resource such as, for example, resource type, permissions, and when and how the resource was created. The term “reference metadata” at least in some embodiments refers to information about the contents and quality of statistical data and/or statistical metadata. The term “statistical metadata” or “process data” at least in some embodiments refers to information about processes that collect, process, and/or produce statistical data. The term “legal metadata” at least in some embodiments refers to information about a creator of content or data item, copyright holder, licensing information, and/or other legalistic information.

The term “metadata scheme”, “metadata schema”, and/or “metadata schemata” at least in some embodiments refers to the vocabularies, data structures, and/or other standardized concepts used to assemble metadata and/or metacontent statements. Additionally, an individual metadata scheme may be expressed in a number of different markup or programming languages (e.g., HTML, XML, RDF, JSON, and/or other languages such as those discussed herein), each of which requires a different syntax. Metadata schemata can be hierarchical in nature where relationships exist between metadata elements, and/or elements can be nested so that parent-child relationships exist between the elements. The term “metadata syntax” or “metacontent syntax” at least in some embodiments refers to the rules created to structure the fields or elements of metadata and/or metacontent.

The term “tag” at least in some embodiments refers to a keyword, a term, or any other type of data assigned to a piece of information/data or a content item. Additionally or alternatively, the term “tag” at least in some embodiments refers to a character or data item used to delimit the start and end of elements in a markup language document. The term “tagging” at least in some embodiments refers to any means of assigning or adding a tag to a data item, element, or content.

The term “knowledge tag” at least in some embodiments refers to a type of metadata that describes, defines, or otherwise captures some aspect of a piece of information such as an information object (e.g., document, digital image, database table, web page, file, and/or the like). Additionally or alternatively, the term “knowledge tag” at least in some embodiments refers to a type of metadata that captures knowledge in the form of descriptions, categorizations, classifications, semantics, comments, notes, annotations, hyperdata, hyperlinks, or references that are collected in tag profiles or some other type of ontology.

The term “ontology” at least in some embodiments refers to a representation, formal naming, and/or definition of categories, properties, and relations between concepts, data, and/or entities. Additionally or alternatively, the term “ontology” at least in some embodiments refers to properties or semantics such as relationships or attributes of tags or taxonomies.

The term “requirements” at least in some embodiments refers to a condition or capability needed to solve a problem or achieve an objective, a condition or capability that must be met or possessed by a solution or solution component to satisfy a contract, standard, specification, or other formally imposed documents, or an information object representing one or more of the aforementioned conditions or capabilities.

The term “data processing” or “processing” at least in some embodiments refers to any operation or set of operations which is performed on data or on sets of data, whether or not by automated means, such as collection, recording, writing, organization, structuring, storing, adaptation, alteration, retrieval, consultation, use, disclosure by transmission, dissemination or otherwise making available, alignment or combination, restriction, erasure and/or destruction.

The term “data pipeline” or “pipeline” at least in some embodiments refers to a set of data processing elements (or data processors) connected in series and/or in parallel, where the output of one data processing element is the input of one or more other data processing elements in the pipeline; the elements of a pipeline may be executed in parallel or in time-sliced fashion and/or some amount of buffer storage can be inserted between elements.

The term “filter” at least in some embodiments refers to computer program, subroutine, or other software element capable of processing a stream, data flow, or other collection of data, and producing another stream. In some implementations, multiple filters can be strung together or otherwise connected to form a pipeline.

The term “information object” or “InOb” at least in some embodiments refers to a data structure or piece of information, definition, or specification that includes a name to identify its use in an instance of communication. Additionally or alternatively, the term “information object” or “InOb” at least in some embodiments refers to a configuration item that displays information in an organized form. Additionally or alternatively, the term “information object” or “InOb” at least in some embodiments refers to an abstraction of a real information entity and/or a representation and/or an occurrence of a real-world entity. Additionally or alternatively, the term “information object” or “InOb” at least in some embodiments refers to a data structure that contains and/or conveys information or data. Examples of InObs include electronic documents, database objects, data files, resources, webpages, web forms, applications (e.g., web apps), services, web services, media, or content, and/or the like. InObs may be stored and/or processed according to a data format. Data formats define the content/data and/or the arrangement of data elements for storing and/or communicating the InObs. Each of the data formats may also define the language, syntax, vocabulary, and/or protocols that govern information storage and/or exchange. Examples of the data formats that may be used for any of the InObs discussed herein may include Accelerated Mobile Pages Script (AMPscript), Abstract Syntax Notation One (ASN.1), Backus-Naur Form (BNF), extended BNF, Bencode, BSON, ColdFusion Markup Language (CFML), comma-separated values (CSV), Control Information Exchange Data Model (C2IEDM), Cascading Stylesheets (CSS), DARPA Agent Markup Language (DAML), Document Type Definition (DTD), Electronic Data Interchange (EDI), Extensible Data Notation (EDN), Extensible Markup Language (XML), Efficient XML Interchange (EXI), Extensible Stylesheet Language (XSL), Free Text (FT), Fixed Word Format (FWF), Cisco® Etch, Franca, Geography Markup Language (GML), Guide Template Language (GTL), Handlebars template language, Hypertext Markup Language (HTML), Interactive Financial Exchange (IFX), Keyhole Markup Language (KML), JAMscript, Java Script Object Notion (JSON), JSON Schema Language, Apache® MessagePack™, Mustache template language, Ontology Interchange Language (OIL), Open Service Interface Definition, Open Financial Exchange (OFX), Precision Graphics Markup Language (PGML), Google® Protocol Buffers (protobuf), Quicken® Financial Exchange (QFX), Regular Language for XML Next Generation (RelaxNG) schema language, regular expressions, Resource Description Framework (RDF) schema language, RESTful Service Description Language (RSDL), Scalable Vector Graphics (SVG), Schematron, Tactical Data Link (TDL) format (e.g., J-series message format for Link 16; JREAP messages; Multifuction Advanced Data Link (MADL), Integrated Broadcast Service/Common Message Format (IBS/CMF), Over-the-Horizon Targeting Gold (OTH-T Gold), Variable Message Format (VMF), United States Message Text Format (USMTF), and any future advanced TDL formats), VBScript, Web Application Description Language (WADL), Web Ontology Language (OWL), Web Services Description Language (WSDL), wiki markup or Wikitext, Wireless Markup Language (WML), extensible HTML (XHTML), XPath, XQuery, XML DTD language, XML Schema Definition (XSD), XML Schema Language, XSL Transformations (XSLT), YAML (“Yet Another Markup Language” or “YANL Ain′t Markup Language”), Apache® Thrift, and/or any other data format and/or language discussed elsewhere herein. Additionally or alternatively, an InObs can include electronic document and/or plain text, spreadsheet, graphics, and/or presentation formats including, for example, American National Standards Institute (ANSI) text, a Computer-Aided Design (CAD) application file format (e.g., “.c3d”, “.dwg”, “.dft”, “.iam”, “.iaw”, “.tct”, and/or other like file extensions), Google® Drive® formats (including associated formats for Google Docs®, Google Forms®, Google Sheets®, Google Slides®, and the like), Microsoft® Office® formats (e.g., “.doc”, “.ppt”, “.xls”, “.vsd”, and/or other like file extension), OpenDocument Format (including associated document, graphics, presentation, and spreadsheet formats), Open Office XML (OOXML) format (including associated document, graphics, presentation, and spreadsheet formats), Apple® Pages®, Portable Document Format (PDF), Question Object File Format (QUOX), Rich Text File (RTF), TeX and/or LaTeX (“.tex” file extension), text file (TXT), TurboTax® file (“.tax” file extension), You Need a Budget (YNAB) file, and/or any other like document or plain text file format. Additionally or alternatively, the data format for the InObs may be archive file formats that store metadata and concatenate files, and may or may not compress the files for storage. As used herein, the term “archive file” refers to a file having a file format or data format that combines or concatenates one or more files into a single file or InOb. Archive files often store directory structures, error detection and correction information, arbitrary comments, and sometimes use built-in encryption. The term “archive format” refers to the data format or file format of an archive file, and may include, for example, archive-only formats that store metadata and concatenate files, for example, including directory or path information; compression-only formats that only compress a collection of files; software package formats that are used to create software packages (including self-installing files), disk image formats that are used to create disk images for mass storage, system recovery, and/or other like purposes; and multi-function archive formats that can store metadata, concatenate, compress, encrypt, create error detection and recovery information, and package the archive into self-extracting and self-expanding files. For the purposes of the present disclosure, the term “archive file” may refer to an archive file having any of the aforementioned archive format types. Examples of archive file formats may include Android® Package (APK); Microsoft® Application Package (APPX); Genie Timeline Backup Index File (GBP); Graphics Interchange Format (GIF); gzip (.gz) provided by the GNU Project™; Java® Archive (JAR); Mike O'Brien Pack (MPQ) archives; Open Packaging Conventions (OPC) packages including OOXML files, OpenXPS files, and the like; Rar Archive (RAR); Red Hat® package/installer (RPM); Google® SketchUp backup File (SKB); TAR archive (“.tar”); XPInstall or XPI installer modules; ZIP (.zip or .zipx); and/or the like.

The term “content” at least in some embodiments refers to visual or audible information to be conveyed to a particular audience or end-user, and may include or convey information pertaining to specific subjects or topics. Content or content items may be different content types (e.g., text, image, audio, video, and the like), and/or may have different formats (e.g., text files including Microsoft® Word® documents, Portable Document Format (PDF) documents, HTML documents; audio files such as MPEG-4 audio files and WebM audio and/or video files; and the like). The term “document” may refer to a computer file or resource used to record data, and includes various file types or formats such as word processing, spreadsheet, slide presentation, multimedia items, and the like. The terms “content” and “document” may be used interchangeably with the terms “information object” or “InOb”.

The term “data element” at least in some embodiments refers to an atomic state of a particular object with at least one specific property at a certain point in time, and may include one or more of a data element name or identifier, a data element definition, one or more representation terms, enumerated values or codes (e.g., metadata), and/or a list of synonyms to data elements in other metadata registries. Additionally or alternatively, a “data element” at least in some embodiments refers to a data type that contains one single data. Data elements may store data, which may be referred to as the data element's content (or “content items”). Content items may include text content, attributes, properties, and/or other elements referred to as “child elements.” Additionally or alternatively, data elements may include zero or more properties and/or zero or more attributes, each of which may be defined as database objects (e.g., fields, records, and the like), object instances, and/or other data elements. An “attribute” at least in some embodiments refers to a markup construct including a name—value pair that exists within a start tag or empty element tag. Attributes contain data related to its element and/or control the element's behavior.

The term “reference” at least in some embodiments refers to data useable to locate other data and may be implemented a variety of ways (e.g., a pointer, an index, a handle, a key, an identifier, a hyperlink, and/or the like).

The term “translation” at least in some embodiments refers to the process of converting or otherwise changing data from a first form, shape, configuration, structure, arrangement, embodiment, description, or the like into a second form, shape, configuration, structure, arrangement, embodiment, description, or the like; at least in some embodiments there may be two different types of translation: transcoding and transformation.

The term “transcoding” at least in some embodiments refers to taking information/data in one format (e.g., a packed binary format) and translating the same information/data into another format in the same sequence. Additionally or alternatively, the term “transcoding” at least in some embodiments refers to taking the same information, in the same sequence, and packaging the information (e.g., bits or bytes) differently.

The term “transformation” at least in some embodiments refers to changing data from one format and writing it in another format, keeping the same order, sequence, and/or nesting of data items. Additionally or alternatively, the term “transformation” at least in some embodiments involves the process of converting data from a first format or structure into a second format or structure, and involves reshaping the data into the second format to conform with a schema or other like specification. Transformation may include rearranging data items or data objects, which may involve changing the order, sequence, and/or nesting of the data items/objects. Additionally or alternatively, the term “transformation” at least in some embodiments refers to changing the schema of a data object to another schema.

The term “database” at least in some embodiments refers to an organized collection of data stored and accessed electronically. Databases at least in some embodiments can be implemented according to a variety of different database models, such as relational, non-relational (also referred to as “schema-less” and “NoSQL”), graph, columnar (also referred to as extensible record), object, tabular, tuple store, and multi-model. Examples of non-relational database models include key-value store and document store (also referred to as document-oriented as they store document-oriented information, which is also known as semi-structured data). A database may comprise one or more database objects that are managed by a database management system (DBMS).

The term “database object” at least in some embodiments refers to any representation of information that is in the form of an object, attribute-value pair (AVP), key-value pair (KVP), tuple, and/or the like, and may include variables, data structures, functions, methods, classes, database records, database fields, database entities, associations between data and/or database entities (also referred to as a “relation”), blocks in block chain implementations, and links between blocks in block chain implementations. Furthermore, a database object may include a number of records, and each record may include a set of fields. A database object can be unstructured or have a structure defined by a DBMS (a standard database object) and/or defined by a user (a custom database object). In some implementations, a record may take different forms based on the database model being used and/or the specific database object to which it belongs. For example, a record may be: 1) a row in a table of a relational database; 2) a JavaScript Object Notation (JSON) object; 3) an Extensible Markup Language (XML) document; 4) a KVP; and the like.

The term “cryptographic mechanism” at least in some embodiments refers to any cryptographic protocol and/or cryptographic algorithm. Additionally or alternatively, the term “cryptographic protocol” at least in some embodiments refers to a sequence of steps precisely specifying the actions required of two or more entities to achieve specific security objectives (e.g., cryptographic protocol for key agreement). Additionally or alternatively, the term “cryptographic algorithm” at least in some embodiments refers to an algorithm specifying the steps followed by a single entity to achieve specific security objectives (e.g., cryptographic algorithm for symmetric key encryption).

The term “cryptographic hash function”, “hash function”, or “hash”) at least in some embodiments refers to a mathematical algorithm that maps data of arbitrary size (sometimes referred to as a “message”) to a bit array of a fixed size (sometimes referred to as a “hash value”, “hash”, or “message digest”). A cryptographic hash function is usually a one-way function, which is a function that is practically infeasible to invert.

The term “integrity” at least in some embodiments refers to a mechanism that assures that data has not been altered in an unapproved way. Examples of cryptographic mechanisms that can be used for integrity protection include digital signatures, message authentication codes (MAC), and secure hashes.

The term “information security” or “InfoSec” at least in some embodiments refers to any practice, technique, and technology for protecting information by mitigating information risks and typically involves preventing or reducing the probability of unauthorized/inappropriate access to data, or the unlawful use, disclosure, disruption, deletion, corruption, modification, inspection, recording, or devaluation of information; and the information to be protected may take any form including electronic information, physical or tangible (e.g., computer-readable media storing information, paperwork, and the like), or intangible (e.g., knowledge, intellectual property assets, and the like).

The term “data subject” at least in some embodiments refers to a natural or legal person, an org, a device, a system, and any type of entity or element about whom a controller holds data (personal or otherwise) and who can be identified, directly or indirectly, by reference to that data. The term “data subject” may also be referred to as a “consumer”.

The term “identifiable natural person” at least in some embodiments refers to an individual who can be identified, directly or indirectly, in particular by reference to an identifier such as a name, an identification number, location data, an online identifier or to one or more factors specific to the physical, physiological, genetic, mental, economic, cultural or social identity of that natural person.

The term “personal data,” “personally identifiable information,” “PII,” at least in some embodiments refers to information that relates to an identified or identifiable individual (referred to as a “data subject”). Additionally or alternatively, “personal data,” “personally identifiable information,” “PH,” at least in some embodiments refers to information that can be used on its own or in combination with other information to identify, contact, or locate a data subject, or to identify a data subject in context.

The term “sensitive data” at least in some embodiments refers to data related to racial or ethnic origin, political opinions, religious or philosophical beliefs, or trade union membership, genetic data, biometric data, data concerning health, and/or data concerning a natural person's sex life or sexual orientation.

The term “confidential data” at least in some embodiments refers to any form of information that a person or entity is obligated, by law or contract, to protect from unauthorized access, use, disclosure, modification, or destruction. Additionally or alternatively, “confidential data” at least in some embodiments refers to any data owned or licensed by a person or entity that is not intentionally shared with the general public or that is classified by the person or entity with a designation that precludes sharing with the general public.

The terms “pseudonymization”, “pseudonymisation”, and “pseudonymize” at least in some embodiments refers to any means of processing personal data or sensitive data in such a manner that the personal/sensitive data can no longer be attributed to a specific data subject or consumer without the use of additional information. The additional information may be kept separately from the personal/sensitive data and may be subject to technical and organizational measures to ensure that the personal/sensitive data are not attributed to an identified or identifiable natural person.

The term “deidentification” or “deidentified” at least in some embodiments refers to information that cannot reasonably identify, relate to, describe, be capable of being associated with, or be linked, directly or indirectly, to a particular data subject or consumer, and may include the implementation of technical safeguards, business processes, and/or other means that prohibit reidentification of a data subject or consumer to whom the information may pertain.

The term “processor”, in the context of data privacy protection and/or InfoSec, at least in some embodiments refers to a natural or legal person, public authority, agency or other body that processes personal data on behalf of a controller.

The term “controller”, in the context of data privacy protection and/or InfoSec, at least in some embodiments refers to a natural or legal person, public authority, agency or other body which, alone or jointly with others, determines the purposes and means of processing personal data.

The terms “data collection” and “data collecting” at least in some embodiments refers to any means of buying, renting, gathering, obtaining, receiving, or accessing any information (personal or otherwise) pertaining to a consumer, and may include receiving information from the consumer, either directly or indirectly, actively or passively, and/or by observing the consumer's behavior.

The term “profiling” at least in some embodiments refers to any form of automated processing of personal data consisting of the use of personal data to evaluate certain personal aspects relating to a natural person, in particular to analyses or predict aspects concerning that natural person's performance at work, economic situation, health, personal preferences, interests, reliability, behavior, location or movements.

The terms “infer” and “inference” at least in some embodiments refer to any means for deriving or determining information, data, assumptions, and/or conclusions from facts, evidence, or another source(s) of information or data.

The term “use case” at least in some embodiments refers to a description of a system from a user's perspective. Use cases sometimes treat a system as a black box, and the interactions with the system, including system responses, are perceived as from outside the system. Use cases typically avoid technical jargon, preferring instead the language of the end user or domain expert.

The term “user” at least in some embodiments refers to an abstract representation of any entity issuing commands, requests, and/or data to a compute node or system, and/or otherwise consumes or uses services.

The term “user profile” or “consumer profile” at least in some embodiments refer to a collection of settings and information associated with a user, consumer, or data subject, which contains information that can be used to identify the user, consumer, or data subject such as demographic information, audio or visual media/content, and individual characteristics such as knowledge or expertise. Inferences drawn from collected data/information can also be used to create a profile about a consumer reflecting the consumer's preferences, characteristics, psychological trends, predispositions, behavior, attitudes, intelligence, abilities, and aptitudes.

The term “binding corporate rules” or “BCRs” at least in some embodiments refers to one or more data protection policies adhered to by orgs established in a jurisdiction for transfers of personal data outside the jurisdiction within a group of undertakings or enterprises, wherein such rules may include all general data protection principles and enforceable rights to ensure appropriate safeguards for data transfers. Additionally or alternatively, the term “binding corporate rules” or “BCRs” at least in some embodiments refers to a framework for having different elements (internal legal agreements, policies, trainings, audits, and the like) that allow for compliance with one or more data protection regulations and privacy protection obligations. In some implementations, BCRs may form stringent, intra-org and/or global privacy policies, set of practices, processes, and guidelines that satisfy one or more regulations or standards, and may be available as an alternative means of authorizing transfers of personal data (e.g., customer databases, human resources (HR) information, and the like) inside and/or outside of the relevant jurisdiction.

The term “environmental, social, and governance” or “ESG” at least in some embodiments refers to an approach to evaluating the extent to which an org works on behalf of social goals that go beyond the role of maximizing profits on behalf of the orgs shareholders and/or stakeholders.

The term “master service agreement” or “MSA” at least in some embodiments refers to a contract or other agreement reached between two or more parties or entities whose terms govern future transactions and/or future agreements between the two or more parties or entities. In some cases, the term “master service agreement” or “MSA” can be referred to as a “statement of work”.

The term “service level agreement” or “SLA” at least in some embodiments refers to a level of service expected from a service provider. At least in some embodiments, an SLA may represent an entire agreement between a service provider and a service consumer that specifies one or more services is to be provided, how the one or more services are to be provided or otherwise supported, times, locations, costs, performance, priorities for different traffic classes and/or QoS classes (e.g., highest priority for first responders, lower priorities for non-critical data flows, etc.), and responsibilities of the parties involved.

The term “service level objective” or “SLO” at least in some embodiments refers to one or more measurable characteristics, metrics, or other aspects of an SLA such as, for example, availability, throughput, frequency, response time, latency, QoS, QoE, and/or other like performance metrics/measurements. At least in some embodiments, a set of SLOs may define an expected service (or an service level expectation (SLE)) between the service provider and the service consumer and may vary depending on the service's urgency, resources, and/or budget.

The term “service level indicator” or “SLI” at least in some embodiments refers to a measure of a service level provided by a service provider to a service consumer. At least in some embodiments, SLIs form the basis of SLOs, which in turn, form the basis of SLAs. Examples of SLIs include latency (including end-to-end latency), throughout, availability, error rate, durability, correctness, and/or other like performance metrics/measurements. At least in some embodiments, term “service level indicator” or “SLI” can be referred to as “SLA metrics” or the like.

The term “service level expectation” or “SLE” at least in some embodiments refers to an unmeasurable service-related request, but may still be explicitly or implicitly provided in an SLA even if there is little or no way of determining whether the SLE is being met. At least in some embodiments, an SLO may include a set of SLIs that produce, define, or specify an SLO achievement value. As an example, an availability SLO may depend on multiple components, each of which may have a QoS availability measurement. The combination of QoS measures into an SLO achievement value may depend on the nature and/or architecture of the service.

The term “organization” or “org” at least in some embodiments refers to an entity comprising one or more people and/or users and having a particular purpose, such as, for example, a company, an enterprise, an institution, an association, a regulatory body, a government agency, a standards body, and the like. Additionally, or alternatively, an “org” may refer to an identifier that represents an entity/organization and associated data within an instance and/or data structure.

The terms “data privacy law”, “data protection law”, “data privacy regulation”, and the like at least in some embodiments refer to a legal framework on how to obtain, use and store data of natural persons. Examples of data privacy laws and/or regulations include Bahrain's Personal Data Protection Law (PDPL); Brazil's Lei Geral de Proteção de Dados Pessoais (LGPD); California Consumer Privacy Act (CCPA); California Privacy Rights Act of 2020 (“CPRA”); Canada's Privacy Act; Australia's Privacy Act 1988; India's Personal Data Protection Bill 2019; Cybersecurity Law of the People's Republic of China (also referred to as the “Chinese Cybersecurity Law”); General Data Protection Regulation (GDPR), Regulation (EU) 269/2014; Ghana's Data Protection Act, 2012; Massachusetts' “Standards for the protection of personal information of residents of the Commonwealth” (201 CMR 17); Philippines' Republic Act No. 10173; New York's SHIELD Act; the Russian Federal Law on Personal Data (No. 152-FZ); Singapore's Personal Data Protection Act 2012 (“PDPA”); and the United Kingdom's Data Protection Act 2018; the United States' Health Insurance Portability and Accountability Act of 1996 (HIPAA), Driver's Privacy Protection Act of 1994 (DPPA), Children's Online Privacy Protection Act (COPPA), Video Privacy Protection Act (VPPA), Cable Communications Policy Act of 1994, Fair Credit Reporting Act (FCRA), and Fair and Accurate Credit Transactions Act of 2003 (FACTA).

The term “artificial intelligence” or “AI” at least in some embodiments refers to any intelligence demonstrated by machines, in contrast to the natural intelligence displayed by humans and other animals. Additionally or alternatively, the term “artificial intelligence” or “AI” at least in some embodiments refers to the study of “intelligent agents” and/or any device that perceives its environment and takes actions that maximize its chance of successfully achieving a goal.

The terms “artificial neural network”, “neural network”, or “NN” refer to an ML technique comprising a collection of connected artificial neurons or nodes that (loosely) model neurons in a biological brain that can transmit signals to other arterial neurons or nodes, where connections (or edges) between the artificial neurons or nodes are (loosely) modeled on synapses of a biological brain. The artificial neurons and edges typically have a weight that adjusts as learning proceeds. The weight increases or decreases the strength of the signal at a connection. Neurons may have a threshold such that a signal is sent only if the aggregate signal crosses that threshold. The artificial neurons can be aggregated or grouped into one or more layers where different layers may perform different transformations on their inputs. Signals travel from the first layer (the input layer), to the last layer (the output layer), possibly after traversing the layers multiple times. NNs are usually used for supervised learning, but can be used for unsupervised learning as well. Examples of NNs include deep NN (DNN), feed forward NN (FFN), deep FNN (DFF), convolutional NN (CNN), deep CNN (DCN), deconvolutional NN (DNN), a deep belief NN, a perception NN, recurrent NN (RNN) (e.g., including Long Short Term Memory (LSTM) algorithm, gated recurrent unit (GRU), echo state network (ESN), etc.), spiking NN (SNN), deep stacking network (DSN), Markov chain, perception NN, generative adversarial network (GAN), transformers, stochastic NNs (e.g., Bayesian Network (BN), Bayesian belief network (BBN), a Bayesian NN (BNN), Deep BNN (DBNN), Dynamic BN (DBN), probabilistic graphical model (PGM), Boltzmann machine, restricted Boltzmann machine (RBM), Hopfield network or Hopfield NN, convolutional deep belief network (CDBN), etc.), Linear Dynamical System (LDS), Switching LDS (SLDS), Optical NNs (ONNs), an NN for reinforcement learning (RL) and/or deep RL (DRL), and/or the like.

The term “feature” at least in some embodiments refers to an individual measureable property, quantifiable property, or characteristic of a phenomenon being observed. Additionally or alternatively, the term “feature” at least in some embodiments refers to an input variable used in making predictions. At least in some embodiments, features may be represented using numbers/numerals (e.g., integers), strings, variables, ordinals, real-values, categories, and/or the like.

The term “inference engine” at least in some embodiments refers to a component of a computing system that applies logical rules to a knowledge base to deduce new information.

The term “intelligent agent” at least in some embodiments refers to an a software agent or other autonomous entity which acts, directing its activity towards achieving goals upon an environment using observation through sensors and consequent actuators (i.e. it is intelligent). Intelligent agents may also learn or use knowledge to achieve their goals.

The term “loss function” or “cost function” at least in some embodiments refers to an event or values of one or more variables onto a real number that represents some “cost” associated with the event. A value calculated by a loss function may be referred to as a “loss” or “error”. Additionally or alternatively, the term “loss function” or “cost function” at least in some embodiments refers to a function used to determine the error or loss between the output of an algorithm and a target value. Additionally or alternatively, the term “loss function” or “cost function” at least in some embodiments refers to a function are used in optimization problems with the goal of minimizing a loss or error.

The term “machine learning” or “ML” at least in some embodiments refers to the use of computer systems to optimize a performance criterion using example (training) data and/or past experience. ML involves using algorithms to perform specific task(s) without using explicit instructions to perform the specific task(s), and/or relying on patterns, predictions, and/or inferences. ML uses statistics to build mathematical model(s) (also referred to as “ML models” or simply “models”) in order to make predictions or decisions based on sample data (e.g., training data). The model is defined to have a set of parameters, and learning is the execution of a computer program to optimize the parameters of the model using the training data or past experience. The trained model may be a predictive model that makes predictions based on an input dataset, a descriptive model that gains knowledge from an input dataset, or both predictive and descriptive. Once the model is learned (trained), it can be used to make inferences (e.g., predictions). ML algorithms perform a training process on a training dataset to estimate an underlying ML model. An ML algorithm is a computer program that learns from experience with respect to some task(s) and some performance measure(s)/metric(s), and an ML model is an object or data structure created after an ML algorithm is trained with training data. The term “ML model” or “model” may describe the output of an ML algorithm that is trained with training data. After training, an ML model may be used to make predictions on new datasets. Additionally, separately trained AI/ML models can be chained together in a AI/ML pipeline during inference or prediction generation. Although the term “ML algorithm at least in some embodiments refers to different concepts than the term “ML model,” these terms may be used interchangeably for the purposes of the present disclosure. Furthermore, the term “AI/ML application” or the like at least in some embodiments refers to an application that contains some AI/ML models and application-level descriptions. ML techniques generally fall into the following main types of learning problem categories: supervised learning, unsupervised learning, and reinforcement learning.

The term “objective function” at least in some embodiments refers to a function to be maximized or minimized for a specific optimization problem. In some cases, an objective function is defined by its decision variables and an objective. The objective is the value, target, or goal to be optimized, such as maximizing profit or minimizing usage of a particular resource. The specific objective function chosen depends on the specific problem to be solved and the objectives to be optimized. Constraints may also be defined to restrict the values the decision variables can assume thereby influencing the objective value (output) that can be achieved. During an optimization process, an objective function's decision variables are often changed or manipulated within the bounds of the constraints to improve the objective function's values. In general, the difficulty in solving an objective function increases as the number of decision variables included in that objective function increases. The term “decision variable” refers to a variable that represents a decision to be made.

The term “optimization” at least in some embodiments refers to an act, process, or methodology of making something (e.g., a design, system, or decision) as fully perfect, functional, or effective as possible. Optimization usually includes mathematical procedures such as finding the maximum or minimum of a function. The term “optimal” at least in some embodiments refers to a most desirable or satisfactory end, outcome, or output. The term “optimum” at least in some embodiments refers to an amount or degree of something that is most favorable to some end. The term “optima” at least in some embodiments refers to a condition, degree, amount, or compromise that produces a best possible result. Additionally or alternatively, the term “optima” at least in some embodiments refers to a most favorable or advantageous outcome or result.

The term “tensor” at least in some embodiments refers to an object or other data structure represented by an array of components that describe functions relevant to coordinates of a space. Additionally or alternatively, the term “tensor” at least in some embodiments refers to a generalization of vectors and matrices and/or may be understood to be a multidimensional array. Additionally or alternatively, the term “tensor” at least in some embodiments refers to an array of numbers arranged on a regular grid with a variable number of axes. The term “vector” at least in some embodiments refers to a one-dimensional array data structure. Additionally or alternatively, the term “vector” at least in some embodiments refers to a tuple of one or more values and/or scalars.

The configurations, arrangements, implementations, and processes described herein can be used in various combinations and/or in parallel. The accompanying drawings that form a part hereof show, by way of illustration, and not of limitation, specific implementations in which the subject matter may be practiced. The illustrated implementations are described in sufficient detail to enable those skilled in the art to practice the teachings disclosed herein. Other implementations and arrangements may be utilized and derived therefrom, such that structural and logical substitutions and changes may be made without departing from the scope of this disclosure. The scope of the invention is set out in the appended set of claims, along with the full range of equivalents to which such claims are entitled.

1. One or more non-transitory computer-readable media (NTCRM) comprising instructions, wherein execution of the instructions by one or more processors of an adaptive data privacy platform (ADPP) is to cause the ADPP to:
obtain a model of an organization (org), wherein the model includes data processing activity of the org, data types processed by the org, use cases related to the org, and geographic regions in which the org operates;
determine a set of org contexts based on the model, wherein each org context in the set of org contexts represents how a component of the org processes data;
assign one or more first scoped tags to corresponding org contexts in the set of org contexts;
determine a set of privacy frameworks (PFs) applicable to the org;
determine a set of requirements for each PF in the set of PFs;
assign one or more second scoped tags to corresponding requirements in the set of requirements; and
generate a privacy program for the org by filtering out requirements in the set of requirements having assigned second scoped tags not matching the assigned first scoped tags.

2. The one or more NTCRM of claim 1, wherein, to determine the set of PFs, execution of the instructions is to cause the ADPP to:
determine the set of PFs based on the model.

3. The one or more NTCRM of claim 1, wherein each PF is a data structure representing one or more of a privacy law, a privacy regulation, an org-specific privacy policy, a contractual obligation, a set of binding corporate rules (BCR), an environmental social and governance policy (ESG), a master service agreement (MSA), a service level agreements (SLA), a set of service level objectives (SLOs), a set of service level expectations (SLEs), a set of ethics rules, a set of customer feedback, or an org-defined strategic goal.

4. The one or more NTCRM of claim 1, wherein execution of the instructions is to cause the ADPP to:
generate the privacy program for the org including only those requirements from the set of requirements having assigned second scoped tags matching the assigned first scoped tags.

5. The one or more NTCRM of claim 4, wherein execution of the instructions is to cause the ADPP to:
determine a set of tasks for each requirement in the privacy program; and
assign individual tasks in the set of tasks to one or more components of the org without human intervention.

6. The one or more NTCRM of claim 5, wherein execution of the instructions is to cause the ADPP to:
obtain one or more custom tasks from one or more user devices; and
add or update the set of tasks to include the one or more custom tasks.

7. The one or more NTCRM of claim 5, wherein, to assign the individual tasks, execution of the instructions is to cause the ADPP to:
provision or deploy instructions of the individual tasks to one or more compute nodes of the one or more components for execution by the one or more compute nodes.

8. The one or more NTCRM of claim 5, wherein execution of the instructions is to cause the ADPP to:
obtain, from a user device, a request for a report related to at least one PF in the set of PFs;
identify completed tasks among the set of tasks for each requirement in the at least one PF;
generate the report to include identifies for the completed tasks; and
send the report to the user device.

9. The one or more NTCRM of claim 1, wherein execution of the instructions is to cause the ADPP to:
determine a current state of the privacy program;
determine one or more future states for the privacy program based on one or more user inputs; and
generate a predicted privacy program based on the current state and the one or more future states.

10. The one or more NTCRM of claim 9, wherein the one or more future states are based on one or more of:
one or more additional PFs indicated by the one or more user inputs,
a future date indicated by the one or more user inputs, and
a combination of one or more org contexts.

11. The one or more NTCRM of claim 9, wherein, to determine the one or more future states, execution of the instructions is to cause the ADPP to:
identify one or more data processing requirements based on the one or more user inputs.

12. The one or more NTCRM of claim 9, wherein, to generate the predicted privacy program, execution of the instructions is to cause the ADPP to:
compare the current state with the one or more future states; and
determine new or changed requirements based on the comparison.

13. An apparatus employed as an adaptive data privacy platform (ADPP), comprising:
memory circuitry to store instructions; and
processor circuitry connected to the memory circuitry, the processor circuitry is to execute the instructions to perform operations including:
obtain a model of an organization (org), wherein the model includes data processing activity of the org, data types processed by the org, use cases related to the org, and geographic regions in which the org operates;
determine a set of org contexts based on the model, wherein each org context in the set of org contexts represents how a component of the org processes data;
assign one or more first scoped tags to corresponding org contexts in the set of org contexts;
determine a set of privacy frameworks (PFs) applicable to the org based on the model;
determine a set of requirements for each PF in the set of PFs;
assign one or more second scoped tags to corresponding requirements in the set of requirements; and
generate a privacy program for the org including only those requirements from the set of requirements having assigned second scoped tags matching the assigned first scoped tags

14. The apparatus of claim 13, wherein each PF is a data structure representing one or more of a privacy law, a privacy regulation, an org-specific privacy policy, a contractual obligation, a set of binding corporate rules (BCR), an environmental social and governance policy (ESG), a master service agreement (MSA), a service level agreements (SLA), a set of service level objectives (SLOs), a set of service level expectations (SLEs), a set of ethics rules, a set of customer feedback, or an org-defined strategic goal.

15. The apparatus of claim 13, wherein the processor circuitry is to execute the instructions to perform operations including:
generate the privacy program for the org by filtering out requirements in the set of requirements having assigned second scoped tags not matching the assigned first scoped tags.

16. The apparatus of claim 15, wherein the processor circuitry is to execute the instructions to perform operations including:
determine a set of tasks for each requirement in the privacy program; and
assign individual tasks in the set of tasks to one or more components of the org without human intervention.

17. The apparatus of claim 16, wherein the processor circuitry is to execute the instructions to perform operations including:
obtain one or more custom tasks from one or more user devices; and
add or update the set of tasks to include the one or more custom tasks.

18. The apparatus of claim 16, wherein, to assign the individual tasks, the processor circuitry is to execute the instructions to perform operations including:
provision or deploy instructions of the individual tasks to one or more compute nodes of the one or more components for execution by the one or more compute nodes.

19. The apparatus of claim 13, wherein the processor circuitry is to execute the instructions to perform operations including:
determine a current state of the privacy program;
determine one or more future states for the privacy program based on one or more user inputs, wherein the one or more future states are based on one or more of one or more additional PFs indicated by the one or more user inputs, a future date indicated by the one or more user inputs, and a combination of one or more org contexts; and
generate a predicted privacy program based on a comparison of the current state and the one or more future states.

20. The apparatus of claim 19, wherein the apparatus is a compute node that is part of a cloud computing service.
